(19) United States
(12) Patent Application Publication
(10) Pub. No.: US 2018/0375841 A1
(43) Pub. Date: Dec. 27, 2018

(54) SYSTEMS AND METHODS FOR ENTERPRISE COMMUNICATIONS

(71) Applicant: SMART SECURITY SYSTEMS LLC, Boulder, CO (US)

(72) Inventor: Kenneth C. TOLA, Boulder, CO (US)

(21) Appl. No.: 16/052,068

(22) Filed: Aug. 1, 2018

Related U.S. Application Data
(63) Continuation-in-part of application No. 15/992,634, filed on May 30, 2018.
Application No. 15/992,634 is a continuation-in-part of application No. 15/136,641, filed on Apr. 22, 2016, now Pat. No. 9,992,180.
Application No. 15/136,641 is a continuation of application No. 13/480,057, filed on May 24, 2012, now Pat. No. 9,325,676.
Application No. 15/992,634 is a continuation-in-part of application No. 15/115,209, filed on Jul. 28, 2016.
(60) Provisional application No. 62/022,540, filed on Jul. 9, 2014.
(60) Provisional application No. 61/932,936, filed on Jan. 29, 2014.

(51) Int. Cl. H04L 29/06; H04L 12/26; H04L 29/08

(52) U.S. Cl. CPC H04L 63/0478; H04L 2209/16; H04L 43/08; H04L 67/1095; H04L 63/0421; H04L 69/323; H04L 63/166; H04L 67/2833; H04L 63/0823

(57) ABSTRACT

This disclosure relates to systems and methods for protecting enterprise communications and data associated therewith. According to embodiments, systems and methods are disclosed for protecting communications between at least two nodes to protect the identity of a node requesting information, provide content of communications being sent and/or obscuring a type of communications being sent. Varying degrees of protection options, including encryption, intermediate node termination and direct node communications, are provided.

### CROSS-REFERENCE TO RELATED APPLICATIONS

The present application is a continuation-in-part of U.S. patent application Ser. No. 15/992,634, filed on May 30, 2018, which is a continuation-in-part of U.S. patent application Ser. No. 15/136,641 filed Apr. 22, 2016, now U.S. Pat. No. 9,992,180 issued Jun. 5, 2018, which is a continuation of U.S. patent application Ser. No. 13/480,057 filed May 24, 2012, now U.S. Pat. No. 9,325,676 issued Apr. 26, 2016. The present application is also a continuation-in-part of U.S. patent application Ser. No. 15/115,209, filed on Jul. 28, 2016, resulting from the national stage entry of PCT/US15/13433, filed on Jan. 29, 2015, which in turn claims the benefit of U.S. provisional Patent Application Ser. No. 62/022,540, filed Jul. 9, 2014, entitled “Secured Invisible Private Network.” and U.S. provisional Patent Application Ser. No. 61/932,936, filed Jan. 29, 2014, entitled “Secured Invisible Private Network”. Each of the aforementioned patents and patent applications are incorporated herein by reference in their entireties for all purposes.

### BACKGROUND OF THE INVENTION

### Field of the Disclosure

Example embodiments of the present disclosure relate to the use of various techniques to protect and enhance enterprise communications and associated data.

### Description of Related Art

Enterprises frequently collect data from consumers and other users of enterprise communication systems, including data obtained from Internet-enabled communications. This data includes personal data and is at risk of loss and potential exploitation. As a result of recent breaches of enterprise data protection schemes, consumers have low confidence in sharing data with various enterprises. In turn, the enterprises impacted by the breach or risk of breach have incurred great expense in an attempt to address these concerns.

Various countries, corporations and Internet Service Providers block, censor or filter communications transmitted between two or more nodes. These communications can occur via the Internet, an Extranet, an Intranet or any other communication path that allows two nodes to communicate with one another. The mode of communication between the nodes is independent of the communication path and includes, for example, client/server, peer-to-peer and mainframe communication architectures. All types of communications, including, for example, wireless, cellular, wired, optical and satellite communications may be subject to filtering.

In embodiments, nodes may be configured to send and receive requests for Target Content. An Intermediate Node 200 is configured to send and receive requests for Target Content 300. Intermediate Nodes 200 may have a variety of configurations, capabilities, uses and placements, but need only be configured to respond to a request for Target Content 300 from a Requesting Node 100. Caching aside, a Node Request 400 sent from a Requesting Node 100 for Target Content 300 is not targeted at information typically stored locally by the Intermediate Node 200. Rather, the Node Request 400 is directed to information typically stored on yet another logical node, referred to herein as a Responding Node 600, which is physically or logically separate from the Intermediate Node 200. The Target Content 300 can be any content, for example, a service, a file, a connection, a web page, multimedia content or any other resource available over a network.

As another example, a user living in Los Angeles, Calif., representing a Requesting Node 100 may normally be blocked from obtaining Target Content 300, e.g., online TV, from a particular web site which represents a Responding Node 600, because the website is configured to serve content only to users in the state of New York. Referring to FIG. 1, the user (at Requesting Node 100) may find an Intermediate Node 200 which requests the content from the Responding Node 600 from within the state of New York. The user sends a request for the content on the target web site to the Intermediate Node 200, and the Intermediate Node 200 obtains the content, unrestricted in this example, from the target website and returns the content to the user in Los Angeles.

An Intermediate Node 200 may cache Target Content 300 obtained from the Responding Node 600 and still be considered an Intermediate Node 200 as long as the Requesting Node 100 is attempting to obtain the content data from the Responding Node 600. The data may be as simple as a low level communications request to check if a target server exists, or the data may be as complex as is supported on the communication path used and by the type of communications selected.

Nodes, as referred to herein in varying embodiments, are logical constructs that can be physically implemented as discrete nodes, as part of other logical nodes or as a system. Requesting Nodes 100, Intermediate Nodes 200 and Responding Nodes 600 may exist at the same physical location, at completely disparate physical locations or at any combination thereof. Logical nodes may be comprised of different parts of a larger system, be themselves independent systems or be combined together in any combination. For example, a group of networked computers may each utilize a shared access point that is, itself, acting on behalf of a single logical node.

Many Intermediate Nodes 200 do not provide visibility to their data retrieval activities, and this lack of visibility causes difficulties with respect to the conventional use of Intermediate Nodes 200. Many Intermediate Nodes 200 do not provide the services that they purport to offer and, in fact, many nefarious Intermediate Nodes 200 cause more harm than any benefit they may provide. Harmful Intermediate Nodes 200 may download malicious content onto a Requesting Node 100, infiltrate the Requesting Node 100 by utilizing an array of techniques or promote the location of the Requesting Node 100 to dangerous third party groups. The Requesting Node 100 has almost no inherent protection from harmful Intermediate Nodes 200.

Moreover, using an Intermediate Node 200 through any sort of manual effort can be both technically challenging and time consuming for a typical end user. Intermediate Node 200 usage may require entries to be made in special sections of a Requesting Node's 100 operating system, file directory or some other configuration option, either directly or indirectly, and the only manner in which to determine if an Intermediate Node 200 is a viable and functional option is typically to use the Intermediate Node 200 and hope that nothing harmful occurs to the Requesting Node 100. Given the large number of Intermediate Nodes 200 providing intermittent connectivity, an end user may have to attempt to use hundreds or more of Intermediate Nodes 200 prior to finding a somewhat viable option.

Compounding these problems with the conventional use of Intermediate Nodes 200 is that an apparently functional Intermediate Node 200 may hide additional data within the Target Content 300 or perform actions beyond the scope of the Responding Node 600 that directly or indirectly affect the Requesting Node 100. While an end user may find an apparently functional Intermediate Node 200, through which requests for Target Content 300 are fulfilled, the end user may have no idea if the Intermediate Node 200 is also downloading malicious content or performing other potentially harmful operations. Furthermore, the end user has no way of knowing from which geographic region a given Intermediate Node 200 is sending out Content Requests 500 to the Responding Node 600. Overcoming censorship may rely on being perceived as requesting information from a distinct and safe geographic region but, given the conventional options in the market, choosing a specific location for an Intermediate Node 200 is not possible.

It should be noted that an end user is not required. Automated machine-to-machine communications, routing between systems, networking devices and other communication-related efforts may utilize an Intermediate Node 200 in place of an end user. An end user can, therefore, be a human, a computer, a program or some portion of code that produces a Node Request 400. Node Requests 400 may be generated directly or indirectly and with or without knowledge of the Intermediate Node 200. Content Requests 500 need not be defined as distinct or separate from the Node Requests 400, because the Content Request 500 can be a routed Node Request 400 or a context-based new message.

Utilizing an Intermediate Node 200 may aid in overcoming geography-based restrictions, and Intermediate Nodes 200 may provide additional benefits including, for example, cookie blocking, encryption, information compression and virus protection. However, communications between two or more nodes can be infiltrated, blocked, transformed or altered through some unwanted action by various mechanisms.

One known issue with communications between two nodes is referred to as “eavesdropping”, which includes any activity that somehow intercepts and reads, processes, stores or interacts with communication not intended for the node perpetuating the activity. A conventional solution to protect against eavesdropping is to utilize some form of encryption, for example, Virtual Private Networks (VPN) or Secure Socket Layer (SSL). As programming capabilities increase in power, these conventional technologies can be overcome and no longer provide the level of protection that they once offered. Furthermore, VPN typically requires static, specialized nodes, referred to as VPN Servers, and such a static approach may preclude dynamic communications by an increasingly mobile audience.

Another common communications issue is one of discovery, which can lead to inadvertent loss of privacy. Even if a technology such as VPN is successful is protecting the data within a given communication, potentially unwanted observers can still determine a significant amount of information about the given communication by examining the nodes involved in the communication. For example, if a factious site is providing music downloads for a popular music group and a node obtains content from that site, an observer could determine that the node likely downloaded music from the music group without ever needing to decrypt the protected data in the communication.

Furthermore, a potentially unwanted observer may observe the communication protocol used for the communication to gain another level of insight into a communication between two nodes. In the previous example, the potentially unwanted observer may determine, for example, that an FTP protocol was used between the known music site and the Requesting Node 100, thereby providing more evidence to the observer that music was downloaded. There is no available option for protecting the Responding Node 600 and the communication protocol from unwanted observation.

There is a range of conventional options for virtualizing application interfaces over a network. However, one of the main issues with these conventional approaches is the use of specialized ports, known protocols, and the high bandwidth required to port across entire operating system environments. These types of communications are highly visible and are typically targeted for eavesdropping purposes.

Conventional web tracking solutions are typically separated into solutions loaded in a customer's server, for example, packet “sniffing” and Internet Information Services (IIS) log file analysis software, and solutions that attempt to track page level activity and which take the form of code inserted in a web page, third party Web “cookies” or software applications. These conventional solutions have significant drawbacks and shortcomings, including their scale and cost of implementation, lack of transparency, failure to adapt to evolving security needs, and other issues.

Accordingly, there is a long-felt a need for more comprehensive communications protection between nodes and in particular amongst enterprise communications.

### SUMMARY OF THE INVENTION

It is an objective of example embodiments of the present disclosure to provide a more comprehensive suite of protective options for enterprise communications, including but not limited to communications between two or more nodes within an enterprise system.

Example embodiments comprise systems and methods that are configured to interact with communications down to the individual packet level, or the lowest level of data supported by a given communication protocol if packets are not used by the protocol. These systems and methods may interact with higher levels of the communication protocol, without limitation, and may utilize intermediate nodes to obtain content from responding nodes. In embodiments, a Packet Level Program may be provided to facilitate communications down to the individual packet level, and may further communicate directly with Packet Level Programs on other nodes in a unidirectional or a bidirectional manner. The Packet Level Program may communicate directly with nodes, including by way of example (but not limitation) cryption nodes. The Packet Level Program may alter communication data including, for example, data compression, encryption, obfuscation or data splitting. Communication data is, for example, any text data, binary data or some combination thereof that can travel over a communication protocol, either between two nodes or within a logical node between two or more physical processes. A process is a specific object within a given node that obtains resources for some period of time including, for example, memory, processor time or file system access. In an example embodiment, a process may be a routine, application, script, service, computer, server, set of servers, program, code snippet, or some other object that utilizes resources on a given node.

In embodiments, the systems and methods described herein further provide an enterprise communication platform that is transparent across the enterprise, and that may be reconfigured to accommodate evolving network security concerns. The enterprise communication platform permits security measures across all devices and is invisible to applications and users accessing the platform. Further, the systems and methods described herein may be implemented with minimal business interruption and without the significant capital expense that is associated with prior art solutions to enterprise data security issues.

While numerous prior solutions have attempted to improve upon enterprise communications, device, and data security, deficiencies still persist. Further, prior solutions have failed to address “Triple A” (Authentication, Authorization and Accounting) and legacy issues, as noted above. These prior solutions generally relate to point-to-point communications protection, communication management, and network defense. As the Summary and Detailed Description describe, the present disclosure overcomes these deficiencies and other problems associated with the prior art.

### BRIEF DESCRIPTION OF THE DRAWINGS

These and other objects, features and advantages of the present disclosure will be apparent from a consideration of the following Detailed Description considered in conjunction with the drawing Figures, in which:

FIG. 1 shows examples of packet types in accordance with various embodiments;

FIG. 2 shows a block diagram of a system and device in accordance with various embodiments;

FIG. 3 shows a block diagram of a system in accordance with various embodiments;

FIG. 4 shows a block diagram of an exemplary packet pointer implementation in accordance with various embodiments;

FIGS. 5-7 show exemplary encryption schemes in accordance with various embodiments;

FIGS. 8-10 show exemplary encryption modulation schemes in accordance with various embodiments;

FIGS. 11-15 show exemplary block diagrams of a virtual communications kernel in accordance with various embodiments;

FIG. 16 shows a block diagram of an operation manager in accordance with various embodiments;

FIGS. 17-19 show exemplary user devices in accordance with various embodiments;

FIGS. 20a and 20b demonstrate in-band versus out-of-band session initiation in accordance with various embodiments;

FIGS. 21-24 show various exemplary device authentication schemes in accordance with various embodiments;

FIG. 25 shows a block diagram of an authentication client in accordance with various embodiments;

FIG. 26 demonstrates an example communication control list in accordance with various embodiments;

FIGS. 27a and 27b show examples of out-of-band session initiation in accordance with various embodiments;

FIG. 28 shows a block diagram of a multi-level authentication scheme in accordance with various embodiments;

FIG. 29 shows an exemplary block diagram of out-of-band session initiation in accordance with various embodiments;

FIGS. 30a and 30b show exemplary open and partially open systems in accordance with various embodiments;

FIG. 31 is a diagram illustrating a virtualization layer according to an exemplary embodiment;

FIG. 32 is a diagram illustrating the virtualization layer according to another exemplary embodiment;

FIG. 33 is a diagram illustrating the virtualization layer according to yet another exemplary embodiment;

FIG. 34 is a diagram illustrating an enterprise-wide security platform and application layer according to an exemplary embodiment;

FIG. 35 is a diagram illustrating the enterprise-wide security platform of FIG. 34 implemented as a service;

FIG. 36 is a concept diagram illustrating the activation sequence for applications;

FIG. 37 is a diagram comparing current security platforms to the security platform according to embodiments of the present disclosure;

FIG. 38 is another diagram comparing current security platforms to the security platform according to embodiments of the present disclosure;

FIG. 39 is a concept diagram illustrating various options to the security platforms depicted in FIGS. 34-38;

FIG. 40 is a diagram comparing current firewall and packet protection schema to protection schema according to embodiments of the present disclosure;

FIG. 41 is a diagram illustrating an out-of-band registration process;

FIG. 42 is a diagram illustrating various mappings in relation to an authentication server according to embodiments of the present disclosure;

FIG. 43 is a diagram illustrating semantic mappings according to embodiments of the present disclosure;

FIG. 44 is a concept diagram illustrating integration with legacy systems; and

FIG. 45 is another concept diagram illustrating integration with legacy systems.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following disclosure and in the claims, the terms “including” and “comprising” are used in an open-ended fashion, and thus should be interpreted to mean “including, but not limited to . . . .” Also, the term “couple” or “couples” is intended to mean either an indirect or direct connection. When used in a mechanical context, if a first component couples or is coupled to a second component, the connection between the components may be through a direct engagement of the two components, or through an indirect connection that is accomplished via other intermediate components, devices and/or connections. In addition, when used in an electrical context, if a first device couples to a second device, that connection may be through a direct electrical connection, or through an indirect electrical connection via other devices and connections. Connections can occur in a unidirectional, bidirectional or variable directional manner over all known means of network connectivity.

As used herein, the term “user” refers to a uniquely identifiable construct within a system that is able to perform an action within the system. This action is not limited in scope and can include such things as create, read, update, delete (CRUD) options, transport, transformation, communications and so forth. For example, a “user” is not limited to a human being, but also includes processes, services, and other such subsystems and code that can be assigned unique identifiers. Thus, a user differs from a unique option such as a row identifier in a database table, which is unable to take any action on the system. In some instances, a user refers to a logical construct such as a user of a virtual machine running within the context of a physical device. In this instance, the virtual user is a version of the user mapping of the application hosting the virtual machine.

As used herein, the general term “device” refers to either a physical device (or group of physical devices) or a virtual machine or device. A physical device generally refers to the physical and software resources required to run an operating system and supporting software. A virtual machine generally refers to an emulation of a computer system, which may be carried out by a physical device or a collection of physical devices acting towards one logical purpose. Grid computing and clustered servers are examples of multiple devices working towards one logical purpose.

As used herein, the terms “user device” and “active user device” refer to the logical intersection of a device and a user. Users and devices may have a many-to-many relationship and thus multiple user devices may exist within a given device or for a given user at any one time.

As used herein, the term “platform” refers to a grouping of similar devices. Devices may be grouped based on the type of operating system used, the type of device itself (e.g., secured/unsecure; desktop/laptop/mobile; client/server; peer/super peer; or old/new), or another distinction that identifies devices in a given system either by its presence and variability among devices or by it lack of presence in some subset of devices. Thus, as used herein, the term “cross-platform” as in “cross-platform communication” refers to devices of two different platforms that communicate with one another; such a cross-platform system may be referred to as a hybrid system.

Finally, as used herein, the term “operation” or “performing an operation” refers to a packet-modifying operation such as encrypting the packet, replacing the packet with an alternate packet, deleting the packet, cloning the packet, replacing the packet with a packet pointer, and the like. Performing an operation on a packet may be restricted to a base datagram and may exclude to the modification of header fields.

### DETAILED DESCRIPTION

The following disclosure is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the disclosure of any embodiment is meant only to be exemplary of that embodiment, and not intended to intimate that the scope of the disclosure, including the claims, is limited to that embodiment.

Internet Protocol Security (IPsec) is a protocol suite for securing Internet Protocol (IP) communications by authenticating and encrypting each IP packet of a communication session. There are two main modes for IPsec: tunneling mode, which is used for virtual private network (VPN) support and transport mode, which is used for point-to-point communications. However, as a result of differences in header formatting among IPsec proponents, cross-platform, point-to-point security is not possible. This lack of cross-platform support renders IPsec-unable to protect communications in a. hybrid environment such as over the Internet.

Due to the dependence and location of IPsec within the IP communication layer of an operating system, IPsec suffers limitations. First, IPsec cannot encrypt data from a given port and then place the encrypted packets back on the same port. Rather, IPsec uses a standard set of well-known ports, which provides assailants with predetermined communications routes to monitor. The use of static ports also opens widely-recognized ports in firewalls and operating systems when optional-on IPsec security is not running.

Further, because IPsec is tightly coupled to the operating system, broad reaching updates to its functionality are also overly burdensome. IPsec uses a security algorithm that is provided by a given operating system and this is not an option that can be easily updated. As such, cross-system compatibility forces IPsec communications to rely on security features for numerous years or even decades at a time. The rate at which security algorithms become vulnerable is much faster, and thus the protection afforded by IPsec cannot keep up with that pace.

IPsec also encrypts an entire packet of data, which can introduce issues when dealing with maximum transmission unit (MTU) limitations. For this reason, most multimedia transmissions are unable to use IPsec to secure UDP packets with very large datagrams. IPsec is further restricted by what is considered acceptable by lower communication layers such as TCP and UDP. These limitations restrict the flexibility of IPsec as far as what encryption options can be applied and how those options can be varied. That is, with IPsec, only one algorithm can be used, which is determined by the operating system, and that algorithm has to be applied to all packets across all secured communication streams.

IPsec also suffers limitations given its location in the communications stack such that many types of communication result in a failure for IPsec to process data properly. As one example, certain communications, such as WiFi, satellite, BlueTooth and microwave do not guarantee the proper order of lower level, Ethernet, packets to the upper level IP layer. As such, lower level packets are normally cached in the IP layer by an operating system and then re-assembled once all of the lower level packets arrive. For IPsec, however, this reconfiguration is not possible due to the whole packet encryption approach and, therefore, IPsec fails to run over these types of communications.

What is needed, and is provided by various embodiments of the present disclosure, is an adaptable framework that removes operating system restrictions from network communications. Such a system should provide encryption options, isolate the network from the operating system, and yet simultaneously be transparent to the operating system in order to avoid any interaction issues, for example with applications executing in the operating system environment.

Although IPsec transport mode was intended to secure point-to-point communications, it was never intended to manage communications. This area is largely defined by what are termed “Triple A Services” or authentication, authorization, and accounting. Authentication refers to the concept of taking a first class entity and verifying the identity of the entity. In some systems, such as Lightweight Directory Access Protocol (LDAP), the first class entity is a user. In other systems, such. as a Unified Computing System (UCS), a user device is a first-class member. Authorization is dependent on an authentication entity establishing what resources an entity can access and, optionally, what interactions an entity is allowed to have with each resource. Finally, accounting refers to the process of measuring resource access from the perspective of the resource provider. For example a mobile gateway might record the amount of time it allows a mobile user device to access a given VOIP connection.

In modern environments, shortcomings in each of these systems cause significant issues. For example, there is no method employed in these systems to authenticate a second class member or even add a new type of first class member option. This results in situations where a first class member requiring more restricted access is unable to be properly restricted. As one example, an executive may be given the same access rights to sensitive data regardless of whether that executive logs in from a central work computer or from an insecure phone at some remote location, which creates a higher likelihood of a security breach.

In accordance with certain embodiments, an adaptable, variable first class membership authentication solution is provided that allows for n number of first class members to be combined together as required to accomplish the level of granularity required. This system is able to extend current LDAP/UCS solutions at differing levels and provide control of such authentication to a given network as needed. To this end, an authentication system disclosed herein is able to include first class members from an existing LDAP system and extend its functionality by adding first class members from either its own system or from another LDAP system, and thus utilize a different type of first class member. While authorization schemes are limited given their dependence on authentication, a larger issue is a lack of communications control. In modern paradigms, even if a user on a given user device has no access to any resources on another user device, the two user devices can freely communicate with one another. This uncontrolled communication can create conduits for malicious activity such as, for example, the spread of malware within a network.

In addition to providing authorization by the first class member combinations described previously, various embodiments of the present disclosure allow authorization systems to be expanded to include communications control. For example, such systems differentially control with whom members interact, how they interact, when they interact and, amongst other things, how much and/or type of data is exchanged. Given the flexibility in first class membership, these interactions may occur through any number of entities including users, user devices, applications, or some combination thereof. Prior solutions do not address these needs for either authentication or authorization.

Turning now to accounting, prior solutions are largely one-sided with little ability to guarantee delivery. In accounting systems, a resource provider commonly reports to an accounting server that the provider is providing a given resource and subsequently the resource provider reports when that resource access is terminated. While there may be optional intermediate updating, information is not provided by the resource consumer sufficient to validate the use of a given resource. One example of this issue relates to Quality of Service (QoS), for example, in relation to multimedia streaming. QoS is generally equated with bandwidth; thus a given user who desires improved QoS may request a better QoS, which results in an indirect request for increased bandwidth. A gateway may approve such a request and thus provide this additional bandwidth, along with reporting this increase in bandwidth to an accounting server. However, in certain situations an increase in bandwidth may not actually improve the user's QoS. Problems such as network saturation, multimedia provider limitations, or even user device processing speeds may serve as a bottleneck that is not solved by simply providing more bandwidth.

In these cases, the user has requested a better QoS and the accounting server will bill the user for the increased QoS based on the gateway reporting, however the user never actually receives the requested enhanced QoS experience. Without resource consumer-side account reporting, there is no way to verify the actual user QoS; this deficiency in reporting can lead to ongoing issues. In accordance with certain embodiments of the present disclosure, consumer-side accounting is provided where the resource consumer provides reporting to the accounting server based on what is actually received at the consumer, rather than what a gateway assumes is the case at the consumer.

In modern computing, networks focus on defending themselves as much as possible, but rarely attempt to directly respond to ongoing attacks in real time. Limitations in the prior art prevent networks from turning attacks on the attackers, distributing resource overload attempts (for example countering distributed denial of service (“DDoS”) attacks) across sufficient on demand resources to overcome a challenge and so forth. One challenge facing networks is that any attempted solution is bound to the operating system and that operating system's associated communication layers. These layers provide readable indicators, for example a network hop and/or forwarding address, or use an exploitable initiation process such as a TCP handshake that prevents many types of counter-intrusion responses.

Considering these limitations, most network defense systems focus instead on intrusion detection response efforts. For example, these efforts attempt to minimize lag between an initial intrusion and a subsequent response and adaptation to that network's defense. One issue with this approach is that an attack always gets in and does some level of damage before it is blocked. The attackers are never directly confronted, although subsequent identification efforts may be taken, and these attacker's efforts are always successful to some degree. Response times to a given intrusion are often measured in weeks and months, which can exacerbate the damage.

In accordance with various embodiments of the present disclosure, network defense is provided that is proactive and prevents intrusion, as much as possible, before an attack occurs. For example, if a given member of a network is compromised, network defense mitigates the damage by isolating the infected member and preventing the dissemination of a given attack vector. If an active intrusion effort is detected, network defense responds to this attack in a manner that is transparent to the would-be intruders. Thus, in certain embodiments the response to an attack effort is beyond the purview of the host operating system while still residing within the targeted device.

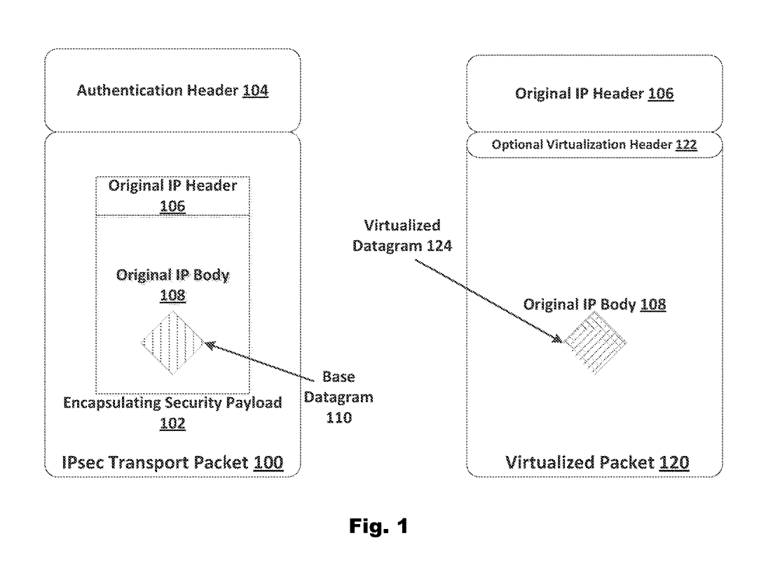

As explained above, and as will be appreciated by one of ordinary skill in the art, point-to-point communications security suffers from significant issues. The main option available today, IPsec, suffers numerous limitations due to its reliance and location within an operating system. One such limitation is an inability to unravel a given packet, encrypt the core datagram and then rewind the packet back to its original format, aside from any descriptive field changes such as data length. Rather, as shown in FIG. 1, IPsec encapsulates the entire packet (i.e., original IP header 106 and IP body 108, which includes a base datagram 110) and adds its own Authentication Header 104 onto the top of the IP packet 106, 108, 110. This results in both a highly visible header and one that, despite a standard to the contrary, can be implemented in multiple manners.

The IPsec standard has at least two main supporters that have created incompatible versions of IPsec. As a result, implementing security in a cross-platform manner is not possible. As yet another issue, IPsec fails to enable routing for current version of IP traffic. In order to protect sensitive data within the visible headers noted above, IPsec transport mode generates a hash of the entire message, which prevents any changes. Although secure, this feature precludes the use of Network Address Translation (NAT) options, which relegates IPsec transport mode to private LANs as opposed to open WANs such as the Internet. This is similar to other approaches, such as the 802.11x standard, wherein entire packets are encrypted and devices, such as routers, have to be specially configured to handle this malformed traffic.

In accordance with various embodiments of the present disclosure, a virtual embedded security kernel or virtual communications kernel is provided on a user device that allows packets to be encrypted, modified, or otherwise operated on in a way that is not readily apparent to an operating system of that user device. As such, no modification of the operating system or any applications executing on the user device is needed to take advantage of the capabilities of the virtual communications kernel. Further, modifications to the virtual communications kernel itself, or to operations carried out by the virtual communications kernel (e.g., modifying an encryption scheme implemented by the virtual communications kernel) may be performed through a simple update procedure, and may be tailored to a user's desires on a case-by-case basis.

As shown in FIG. 1, a virtualized packet 120 includes the same IP packet 106, 108 that would be subsumed using IPsec. However, unlike the IPSec transport packet 100, the virtualized packet 120 includes only a modified base datagram, referred to as a virtualized datagram 124. Further, it should be understood that certain pre-existing field values in the IP header 106, for example, may be updated as long as the original packet header structure remains intact. This figure is exemplary and should not be construed as limiting the scope of the present disclosure to IP traffic. In fact, any form of communications that provides a core datagram, or even just a datagram, is within the scope of the present disclosure. In the example of FIG. 1, the original IP header 106 includes fields such as time to live and packet length, which can be optionally updated but, outside of those fields, the IP packet itself remains structurally intact.

In accordance with various embodiments, the virtual communications kernel is logically situated above a physical layer (e.g., a physical layer of the Open Systems Interconnect (OSI) stack) but below all other layers. As a data packet travels from an application through the higher layers, the data packet can be inspected and, optionally, intercepted by the virtual communications kernel prior to reaching the physical layer, for example the miniport driver of a network interface card (NIC). The virtual communications kernel may then perform one or more operations on the data packet, the details of which will be explained further below, while any processing of the header of the data packet can be separate and distinct from the operations performed on the data packet. By leaving the header in its original format (aside from modifying standard fields such as data length, for example), the present disclosure overcomes routing and addressing challenges.

A header can be any part of a packet of data that is available for general inspection. For certain protocols such as TCP, UDP, and IP, a header is typically considered to be a prefix that contains overall information about the packet such as, but not limited to, addressing information, time to live, and IP version. Addressing information can include source address, destination address, and intermediate addresses such as those used for proxy or static routing efforts. Different protocols, for example IPv6, allow headers to be nested within one another in order to enable a richer feature set. All such options are within the scope of the present invention.

In some embodiments, the virtual communications kernel is placed directed above a NIC card, in other embodiments, the virtual communications kernel runs within a separate process space defined by options such as a BIOS pre-boot operation or a designated processor option akin to a GPU space. Certain embodiments might implement the virtual communications kernel as an application with access to packets at a low level of communications. In these embodiments, such an application might use options such as Microsoft's Network Driver Interface Specification (NDIS) or Linux Netfilter to access lower level packets. These placements enable the virtual communication layer to overcome limitations with the type of protocol by working at the lowest level of packets guaranteed to be complete by the lower levels of a device. Therefore, in the cases of lower level operations, at times referred to as communication drivers, the packets from communication types such as Bluetooth, WiFi, microwave and so forth, are always provided to the virtual communication kernel completely constructed. This enables the virtual communication layer to operate across types of communications without restriction.

In certain embodiments, the virtual communication kernel might be forced to cache subparts of the lower level packets until these packets are fully-constructed. This embodiment, for example, might occur in a security kernel implementation on a chip residing outside of a given operating system. In these embodiments, the lower level layers need to provide a header value denoting the original order and embed those values into the lower level packets. The virtual communications kernel is then able to cache the subparts, request missing subparts from the lower level layers from the sending device, and reconstruct the packets as needed.

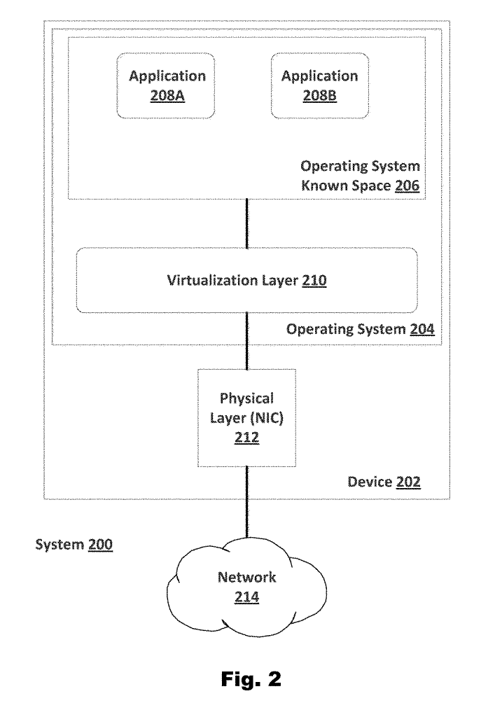

Turning now to FIG. 2, a system 200 is shown in accordance with various embodiments of the present disclosure. The system 200 includes a device 202 coupled to a network 214. The device 202 may include any one of a variety of computing devices, such as a desktop, a laptop, a smartphone, and the like, which is configured to communicate with one or more other devices over the network 214. The system 200 may include many such devices 202 in communication with one another over the network 214. The network 214 may be a wired network or a wireless network and may comprise networks such as a local area network (LAN), a wide area network (WAN), the Internet, and the like.

The device 202 includes an operating system 204 within which their existing a logical known space 206. For simplicity, components of the device 202 are not shown, but it should be understood that the device 202 may include various components such as memory, hardware storage, a user input device 202, a display device 202, a file system, various communication and device 202 drivers, and the like. The operating system 204 and various applications 208a, 208b may be executed within the operating system known space 206. Known space 206 refers to the region of the operating system where processes are controlled, either directly or indirectly, by operating system rules and limitations. This known space 206 is a logical construct that related most directly to the rules and restrictions of the OSI model and how that model is implemented within a given operating system 204. The virtual communications kernel 210, which may be instantiated as part of the operating system 204 is not part of the operating system known space 206. The applications 208a, 208b may generate data or serve as a conduit for data (e.g., that received from an end user device 202) to be transmitted over the network 214.

In accordance with various embodiments, a virtual communications kernel 210 is logically positioned between the higher layers where the operating system 204 and associated applications 208a, 208b are executed and a physical layer 212. The higher layers may comprise layers of the OSI model including the application layer, the presentation layer, the session layer, the transport layer, and the network layer. Below the virtual communications kernel 210, the physical layers 212 may comprise the data link and physical layers for example the miniport driver for a network interface card (NIC). Other embodiments might not use OSI, such as a Real Time Operating System (RTOS), or an operating system at all, such as in lower level IoT sensors. In these latter embodiments, the upper levels are generally defined as any applications, processes or functions collecting or performing operations on data to be transmitted. Lower level layers are generally defined as those physical or virtual processes involved in the transmission and reception of information over a network. The virtual communications kernel can, itself, comprise the totality of the lower levels in certain embodiments, the upper levels in other embodiments or both.

The virtual communications kernel 210 may be initialized as an additional layer within the confines of the operating system 204 or this layer may be initialized outside the scope of the operating system 204. In the latter scenario, a BIOS pre-boot loading sequence may initialize the virtual communications kernel 210 after the physical layers 212 have been established but independent of the activation of the operating system 204.

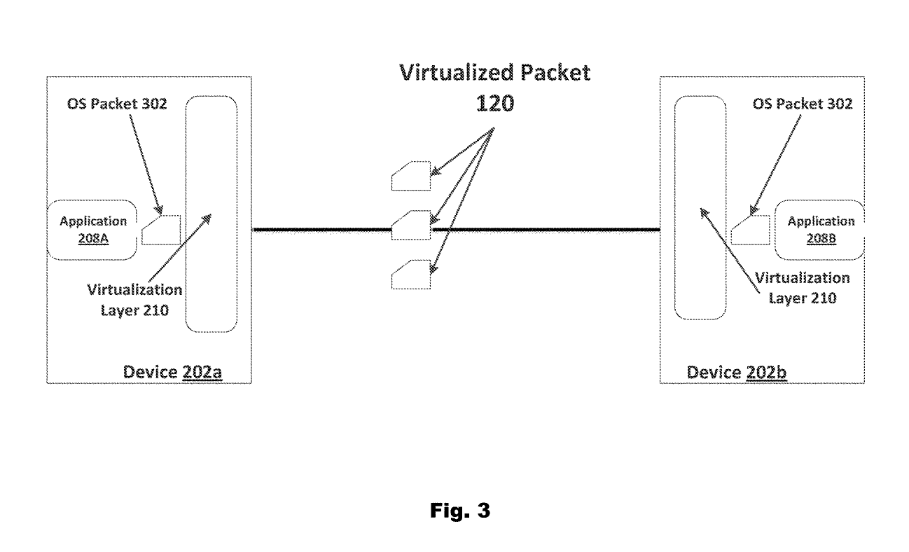

The virtual communications kernel 210 intercepts communications packets 302, shown in FIG. 3, which the upper levels, in this case the Operating System, 204 and/or the applications 208 send to the network 214, which are then processed in accordance with various embodiments. After processing, depending on the embodiment, the virtual communications kernel 210 places the virtualized packet 120 back into the original data stream where the packet 120 is then sent to the physical layers 212 and to the network 214.

Referring to the logical location of the disclosed virtual communications kernel 210, it is noted that IPv4 and IPv6 are constructed at a level logically situated above the virtual communications kernel 210. Therefore, in embodiments where a packet is deconstructed, the base datagram 110 can be altered or operated on and then the packet can be rebuilt and the original header structure reapplied. That header construct may be a simple IPv4 or a more complex, possibly nested, IPv6 header structure, or some other packet header. Header fields that may be updated are existing fields within the general header construct such as time to live, addressing information, and/or packet size. Considering the commonality of the outer header fields for IPv6 and the IPv4 header fields, for example, the same header operations can be applied to packets regardless of the version of IP. Differential operations might also be utilized and this IP version-agnostic capability is presented for sake of clarity on the logical position of the virtual communications kernel. IPv4 and IPv6 are presented as common examples of communications packets and are not restrictive in any manner. Other embodiments, as one example, can process Internetwork Packet Exchange/Sequence Packet Exchange (IPX/SPX) packets most commonly found in Novell Netware operating systems.

To the external world, the packet operated upon in accordance with the present disclosure has the same structure as the original packet. As explained above, the virtual communications kernel 210 resides below the non-physical OSI layers, and, as such, the same ports originally used can be used to send the encrypted or otherwise operated-on packets to the physical layers 212. Subsequently, the virtual communications kernel 210 transmits the modified data packet to the physical layer 212, at which point the data packet may be transmitted across a network 214. As will be explained in further detail below, when a data packet is received from the network 214 via the physical layer 212, the virtual communications kernel 210 may operate similarly to “undo” any operation that has been performed on the data packet before transmitting the packet to the upper level layers 204.

In this way, the existence of the virtual communications kernel 210 is transparent to the upper level layers 204 of the device 202. Further, the virtual communications kernel 210 serves to isolate the upper level layers 204 from a network 214 over which communications may be sent. The present disclosure also addresses synchronization of packets between two devices 202 in a communication stream where each device 202 implements various embodiments of the present disclosure.

Separately, the present disclosure addresses synchronization of packets being sent to and from the upper level layers 204. Referring to FIGS. 2 and 3, as one non-limiting example, assume Computer A (e.g., device 202a) sends a communications packet 302 with a sequence number of 15 to its local virtual communications kernel 210. Further, assume that the operation process carried out by the virtual communications kernel 210 comprises an encryption process that creates an odd number of packets, such that the packet number expected by a virtual communications kernel 210 on another device (e.g., device 202b) was 22. An embodiment of the present disclosure maps the communications packet 302 (with sequence number 15) and the virtualized packet 120 (sequence number starting at #22) on both sides of the communication stream. This mapping feature results in the ability to combine multiple OS packets 302 into one virtualized packet 120 or, conversely as shown in FIG. 3, to extrapolate one communications packet 302 to numerous virtualized packets 120. The communication between two virtual communications kernels 210 over a network 214 is independent of the communications between an upper level layers 204 and a virtual communications kernel 210. By synchronizing packets, the virtual communications kernels 210 are able to achieve transparent isolation and remain invisible to the upper level layers 204 and any applications executing on a device 202. The operating systems 204 are effectively communicating directly with one another while the virtual communications kernel 210 is able to make any modifications without impact to that upper level layers 204 level communication session.

Many embodiments will incur negative consequences to the splitting of upper level communications packets 302 into numerous packets 302 at a given level such as described in the example above. To this end, many protocols, such as UDP, enable “over-stuffing” packets in order to avoid this issue. The virtual communication kernel 210, in certain embodiments may interact with the upper level layers 204 to configure options in a communications stack to avoid such issues. As one example, the virtual communications kernel 210 might configure the TCP Window Size in the upper level layers 204 to enable a buffer for modifying the base datagram 110. In such an embodiment, the window size might be decreased by a certain amount such that modifying the base datagram 110 does not result in one communications packet 302 being divided into two or more packets.

In some embodiments, the virtual communications kernel 210 intercepts a communications packet 302 and modifies the base datagram 110 within that communications packet 302. In order to accomplish this process, the virtual communications kernel 210 breaks the communications packet 302 down to its core datagram 110. This datagram 110 may exist at an application layer, at a transport layer, or any layer in between. At the virtual communications kernel 210, the packet breakdown (also referred to herein as “unwinding” the packet) continues until the core datagram 110 has been uncovered. It should be noted that “breakdown” or “unwinding” can be equated to extraction or replace functions in certain embodiments such that a previously known, configurable, set of offsets can be leveraged to remove or isolate the payload from a serial string of data found within a packet. In these cases, the packet is not unwound as much as a part of the serialized data, text or binary, is modified either in the serialized data or by removing the subset, performing none or more of a possible number of operations and then re-inserting the subset into the serialized data.

At that point an operation on the core datagram 110 may be performed, resulting in a virtualized datagram 124. As one example, an embodiment may encrypt the datagram 110 using one or more algorithms according to a range of rules, described in detail below. Another example operation is replacing all or part of the core datagram 110 with a pointer to data shared across devices 202, for example to reduce the size of duplicate packets being transmitted between devices 202. In other embodiments, the core datagram 110 might be captured and redirected—either individually or as a stream—to a separate location from the intended destination for that communications packet 302. In any case, an encryption operation may be layered on top of other operations. That is, in the latter described copying embodiments, a related or independent single or set of encryption approaches may be applied as compared to the OS data packet 302. Streams might be comprised of entire communications packets 302 or core datagrams 110 along with optional header values or both.

Once the operation on the core datagram 110 is complete, the virtual communications kernel 210 optionally builds the virtualized packet 120 such that it again resembles the original communications packet 302. For example, the initial header or addressing information for the data packet may be re-used with only standard fields, such as CRC values and data lengths, being modified. The operation performed on the core datagram 110 is not also performed on the data packet's initial header. In some embodiments, other standard fields such as proxy server or even source and destination IP address fields are utilized to make additional modifications, but the overall structure of the header remains unchanged after the virtualized packet 120 has been rebuilt. Depending on rules, such as intercepting malformed or suspicious packets, found in a number of optional locations not restricted to policies, embedded logic of configuration files, some embodiments may not reconstruct the packet and, instead, remove the communication packet 302 from the overall communications stack.

Other operations may be performed on the communications packet 302 that do not require a directly interacting with the base datagram 110 of the communications packet 302. Examples of such operations include cloning the packet, redirecting a packet, filtering packets, and the like. The present disclosure is not limited to a particular type of operation that is ultimately performed on the communications packet 302 or the core datagram 110; rather, any operation performed within the functionality of the disclosed virtual communications kernel 210 is within the scope of the present disclosure.

Certain exemplary embodiments are directed to packet pointer security. These embodiments include an optional operation that may be performed by itself or as part of a large series of operations to be described more fully below. The premise of packet pointer security is that, at the level of a base datagram 110, there exist common sequences of bytes across all packets of information. It is not guaranteed that a given sequence exists in all packets, although that may be the case in certain instances; however, common patterns of bytes or bits of data exist within a network of communication streams. Based on that premise, extracting common patterns would allow those patterns to be replaced with pointers, which both reduces communications size and further secures data being transmitted.

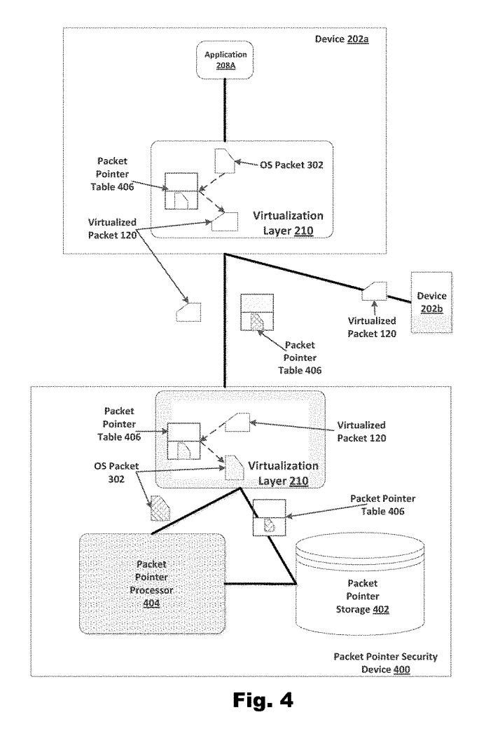

FIG. 4 demonstrates a packet pointer system in accordance with various embodiments. As described previously, an application 208A transmits a communications packet 302 to another device 202. The packet is intercepted by the virtual communications kernel 210, which may compare the base datagram 110, either in whole or in part, with entries in a packet pointer table 406 to determine the existence of matching patterns. The packet pointer table 406 represents a logical construct that might be, for example, implemented as a hash table, queue, memory map file, text file, in memory database, or any other such construct that enables a lookup process. The lookup process may consist of rows in a table, a series of name-value pairs, or other similar constructs such as a seed or key value to place into an algorithm. In this latter case, the key or seed value is utilized on the other end of the communications stream, in this case by device 202b, to recreate the original pattern based on the seed or key value.

The virtual communications kernel 210 compares the contents of the base datagram 110 to the entries in the packet pointer table 406 and, if a match is found, the pattern in the base datagram is replaced with the lookup value's corresponding pointer. This process may continue according to optional business rules and/or until all of the entries are inspected. In some cases, the entries are organized by the size of the patterns, the date a pattern was added to the packet pointer table 406, the popularity of a given pattern, and so forth. Business rules, for example, could force successive iterations through all entries again to create nested groups of replaced patterns such that the newly inserted pointers/name values themselves are replaced by other pointers, keys, or name values. Different types of patterns may be used to denote various levels of nesting depending on the embodiment. Thus a logical level 1 set of matches might be applied to the base datagram 110, the next logical level to the datagram 110 after a first pass, and so forth. This enables control over the nesting and un-nesting features.

Once completed, the altered base datagram 110 can then be optionally encrypted by the virtual communications kernel 210 to create a virtualized datagram 124, as explained above, and the packet itself is rebuilt to create a virtualized packet 120. In some embodiments, any such encryption occurs first and then pattern matching is carried out. In these cases, there might be additional embodiments in which encryption occurs after the pattern matching process. This sequence of encryption, pattern matching, and optionally more encryption can be modified in subsequent embodiments and controlled through static or dynamic rules to create an additional layer of security. All such variations are within the scope of the present disclosure.

This virtualized packet 120, outside of updating fields such as the data length, time to live, and CRC fields, is structurally the same as the original communications packet 302. It should be noted that any field can have its value modified as long as the original integrity of the packet remains intact. In certain embodiments, this process can include the transparent use of intermediate, proxy servers. To accomplish this task, the virtual communications kernel 210 can modify the standard header fields, for example the Destination IP field in a TCP packet, to direct a packet to an intermediate server or node. In these embodiments dealing with TCP or UDP packets, provided as an example and not in any way restricting to those protocols, the intended IP address can be moved to another standard header field called X-Forwarded-For. This process is a standard approach, does not change the structure of the communications packet 302 and is considered to be part of this invention.

During processes that focus on the packet pointer system, either by cloning the base datagram 110 or by cloning the resultant virtualized packet 120, the virtual communications kernel 210 is able to create a copy of the virtualized packet 120. This copy would have its destination IP address field, and optionally its port and source IP fields, altered such that the packet is sent to a packet pointer security device 400 instead of the device 202b.

Thus one virtualized packet 120 is sent to the device 202b and the other virtualized packet 120 is sent to the packet pointer security device 400. In alternative embodiments, the receiving device 202b may create the clone and forward that clone to the packet pointer security device 400. This embodiment is particularly useful when adding in resource consumer-side accounting, as this conduit could support both functions. Yet another embodiment places the packet pointer security device 400 in between the devices 202, which mitigates the need for cloned packets.

The virtualized datagram 124 is optionally decrypted on the receiving devices 400 and 202b, and then pattern matching is performed in reverse, with the name or pointer used to revert the entire or partial section of the virtualized datagram 124 back to the original set of bits or bytes. If the inserted value is a key or seed value, then a hosted algorithm is used to generate the missing data. This process continues in the reverse order of the processing for the outgoing packet described above, until the original base datagram 110 is reconstructed. In certain embodiments, this includes completely reverting all nested replacements and/or performing any subsequent decryption efforts. Once complete, the original communications packet 302 is rebuilt with all original field values replaced as needed, including expected synchronization values and correct CRC calculations.

Referring to the packet pointer security device 400, the communications packet 302 is sent to a logical construct referred to as a packet pointer processor 404. This construct may be implemented using an application, a system of hardware devices and/or applications, or another similar implementation that supports the described processes. In one embodiment, this construct consists of software that receives the incoming OS packets 302 and stores them in a storage device. The packet pointer security processor 404 includes a map reduce capability that continuously determines the best patterns to utilize before storing the results of this effort in the packet pointer storage 402. The packet pointer storage 402 may comprise a physical database, a document repository, an in memory datagram, an XML map memory file, or any other such medium capable of storing data.

The packet pointer processor 404 compares the bits or bytes of data across numerous packets and obtains common patterns found within these packets. Thus, the base datagrams 110 are unwound to form conceptual lines of bits or bytes, which are then compared to one another using any combination of matching methods. For example, some embodiments might take a string in the first position and compare that string to the other strings in a set, first as a whole and then as a substring. This latter substring can be generated by taking one bit or byte of either or both ends of the first string, by creating a crawling subset, or by starting with a central minimum subset and expanding outwards. A crawling subset may be created by starting at one end with a substring of finite length that is smaller than the whole string with a position of 0. As pattern matching progresses, the length of the substring stays the same, but the starting position of the substring increases until the entire string has been processed. Some embodiments might continue through to the end of the first string, thus producing smaller and smaller substring lengths, whereas other embodiments might stop when the substring includes the last bit or byte of the first string or some minimum substring size is reached. Other embodiments may crawl in reverse order and even others may start at both ends and create combinations off of the two resultant substrings.

Some embodiments might utilize a generational approach which supports different levels of matching patterns as described previously. Thus a given map reduce effort might be utilized to generate a logical first level of patterns. Then, the resultant datagrams, modified with the pattern-matched modifications, can be processed again to generate a logical second level of patterns and so forth.

In more complex cases, matching process instructions in the virtual communications kernel 210 may be included in the packet pointer table 406. By including instructions, which can be a simple sequence number to denote the type of matching or a complex series of steps akin to BPEL commands, the matching paradigm can become more sophisticated. As one possible example, different matching techniques may be strung together such that a given pattern is only used if certain other matches occur ahead of time, or whether a certain type of encryption algorithm was used. These additional features are useful in avoiding data corruption issues, which can occur when encrypting certain patterns of data as one example.

Regardless of the operation performed on the base datagram 110, after the virtual communications kernel 210 performs the operation(s), the virtual communications kernel 210 assembles the virtualized packet 120. After the virtualized packet 120 has been assembled, the virtual communications kernel 210 forwards the virtualized packet 120 to the lower level layer 212, which transmits the virtualized packet 120 across the network 214. Unlike other packet security schemes, the header of the data packet remains structurally unmodified (although, as described above, certain field values, such as a data length field or CRC field, may be altered or recalculated to account for other changes to the data packet) by the virtual communications kernel 210. That is, the original header format is maintained such that a receiving entity coupled to the network 214 recognizes the format of the packet. In certain circumstances, header fields, such as a packet length field or a cyclic redundancy check (CRC) field, are modified to reflect changes to other portions of the data packet, but the header structure itself is not otherwise operated on. In some embodiments, where the operation performed is an encryption operation, the virtual communications kernel 210 would not encrypt the header itself.

The virtual communications kernel 210 also may be configured to operate on certain packets while allowing other packets to pass through to the physical layer 212 without first being operated upon. For example, the virtual communications kernel 210 may perform operations on packets directed to a certain port, but does not perform operations on packets directed to ports other than the certain port. It should be appreciated that the same differentiation scheme may apply to a grouping of ports and that any field, attribute or field/offset can be utilize in any matching or filtering paradigms described in this invention. Further, in other embodiments, the virtual communications kernel 210 may perform operations on all packets to be transmitted over the network 214. Other embodiments may apply an optional filter on any characteristic that can be attributed to a packet including, but not limited to, source/destination IP address, protocol, packet size, sending application, and so forth. This filter can be used to differentiate packets and subject certain packets to no operations or a varying set of operations based on any number of characteristics.

The ability to inspect, filter, and apply variable operations at the packet level therefore leads to the ability to enforce a distributed packet level firewall capability. Dynamic firewall features are covered later in this disclosure and this feature is similar to deep packet inspection firewalls, although with numerous differentiating features. Prior art deep packet inspection firewalls are most commonly implemented as separate appliances or intermediary servers situated between a possibly large number of devices on one side and a protected variable set of resources on the other side. While effective in handling packet level inspection and supporting rules to that end, deep packet inspection firewalls are limited in terms of speed and throughput. In accordance with various embodiments, packet inspection requirements are distributed to a larger number of devices, thus mitigating the speed and throughput concerns of prior art designs. Further, as will be explained, more intricate rules can be created based on a distributed enforcement model as opposed to a centralized system.

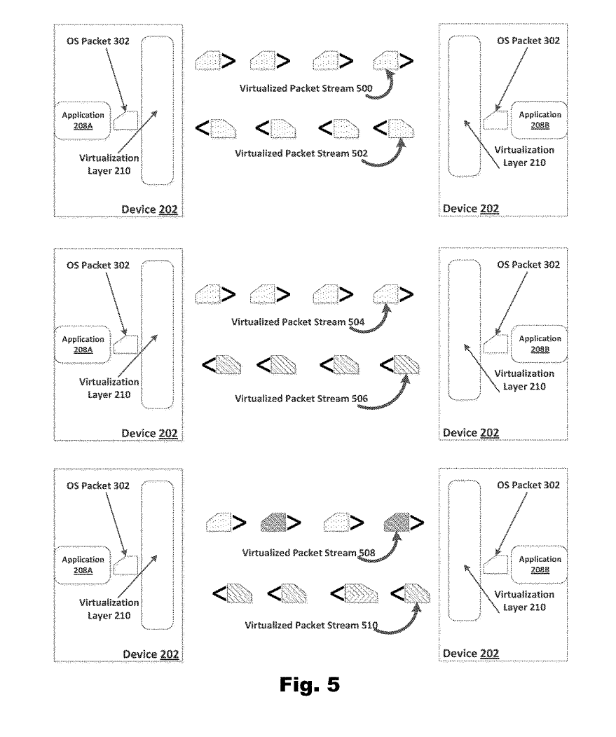

In accordance with various embodiments, the ability to differentially operate on packets based on various packet characteristics provides a new approach to performing encryption or other operations. Certain embodiments of the present disclosure take advantage of this feature to provide enforcement rules that apply different types of encryption at different times based on a static or dynamic series of characteristics. As shown in FIG. 5, the use of multiple types of encryption may be applied within the same communications channel. As shown in virtualized packet streams 500, 502, the same encryption may be applied for packets flowing in either direction. Virtualized packet stream 504 demonstrates a first encryption used for packets going one way, whereas virtualized packet stream 506 demonstrates a second, different encryption used for packets going the other direction.

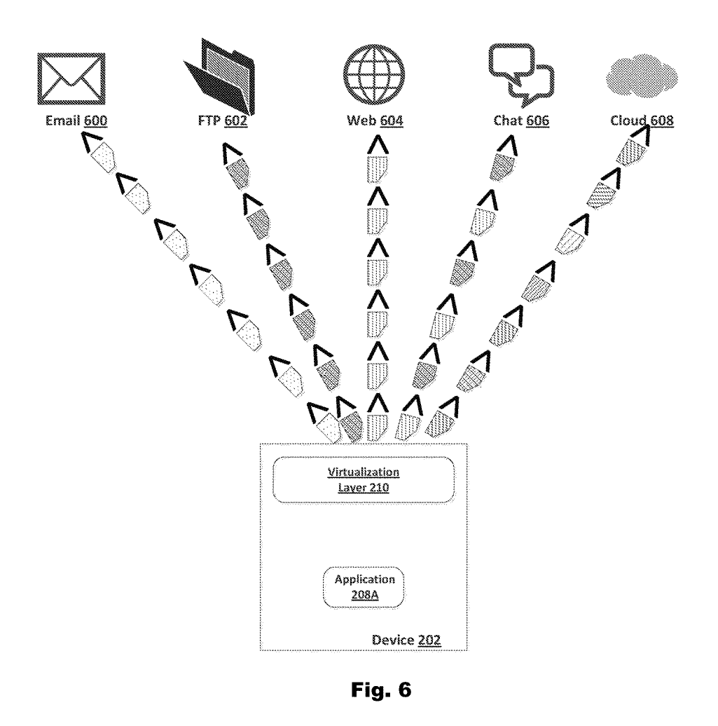

Encryption can be further changed within a given stream over time for a potential range of reasons. As one example, virtualized packet stream 508 shows a different encryption being applied on every other packet. As another example, virtualized packet stream 510 shows no encryption being applied on a random packet, namely the third packet from the left. In still other embodiments, multiple encryption schemes are applied on a single packet. The application of one of more encryption algorithms, pattern-based bit/byte swapping, encoding, or other data altering/conservation techniques to a given packet is referred to generally as an “encryption approach.” In addition to controlling encryption based on remote destination, the present disclosure enables altering encryption based on other options such as the protocol or application involved in a given communication session. For example, as shown in FIG. 6, disparate encryption approaches are applied to different communication streams by protocol such as email 600, FTP 602, or web 604 and/or by application such as chat 606 or cloud-based applications 608.

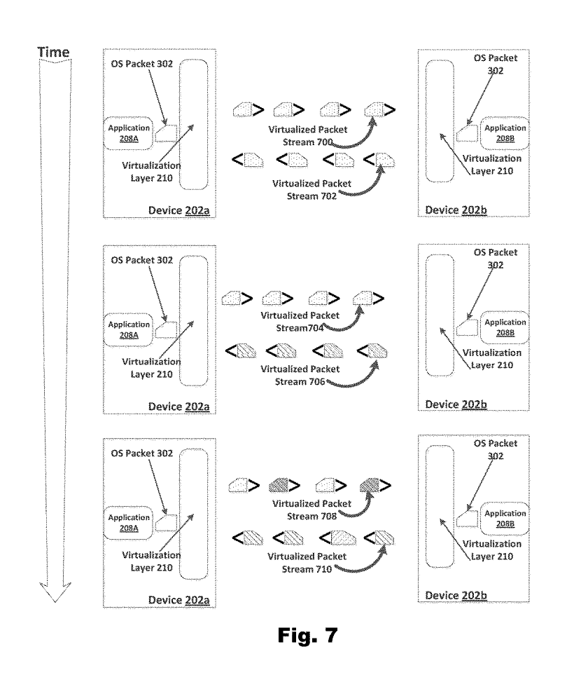

Embedded rules, a configuration file, or more complex options such as BPEL may be used to determine which packets to apply which encryption approach. This capability provides for additional embodiments to support complex encryption management requirements for securing communications. While some embodiments utilize the same encryption regardless of duration, other embodiments alter the encryption approach over time, for example as time progresses in the downward direction as shown in FIG. 7 or by amount of data processed, time of day or any other option available on the device including application and/or operating system changes, user login or other process interactions. The process of changing encryption approaches over time, or in response to changes in other factors or variables, is referred as an “encryption modulation.”

Some embodiments statically include such modulations as part of embedded code or a configuration file, whereas other embodiments utilize a concept referred herein as a connector pattern. Connector patterns are constructed of modulation charts, which are combinations of modulation packages, each of which contain a series of modulation sequences. These embodiments are described more fully below, beginning with a modulation sequence.

A modulation sequence is an instruction or command that tells the virtual communications kernel 210 to perform a given encryption approach on a packet. Packets are selected based on any characteristic of that packet or, in the case of no applied filter, the encryption approach is applied to all packets. A modulation sequence may include, as part of its encryption approach, a single operation to be applied to a matching packet or a series of operations joined together using a logical join operator such as Next, Or, And, or other operators common in process flow approaches. These operators enable primitive process flow applications at the packet level to provide optional additional levels of operations for more advanced requirements such as cloning and nested encryption

A modulation package is a series of modulation sequences sufficient to cover all applicable packets for a given device 202. A modulation package may vary from one embodiment to the next, but could be required, for example, to provide at least one modulation sequence for every type of packet passing through a device 202; in some instances, a catchall modulation sequence may be used to ensure such compliance. Certain embodiments allow for modulation sequence overlap, such that a given packet might be processed more than once (i.e., be subject to multiple modulation sequences). In these instances, the order of modulation sequence processing can be determined in a variety of manners, such as newest/oldest modulation first, a manually entered priority number, based on type of operation, and so forth. Dynamic components such as time of day, device type, device location, and the like may be applied to turn on or off the availability of certain modulation sequences within a modulation package as well as to change priorities of those modulation sequences. This latter set of instructions may be stored as metadata with the modulation sequences within the logical modulation chart construct. Other embodiments prevent overlapping modulation sequences, but may still utilize dynamic data to determine the availability of specific sequences.

A modulation chart is a logical level above the modulation package. The modulation chart contains a variable number of modulation packages along with a connector pattern, which is explained in further detail below. Some embodiments include a series of modulation charts and rely on virtual communications kernel 210 processing to determine which chart to utilize. In these embodiments, determination logic may be included as embedded code in the virtual communications kernel 210, as separate instructions sent to the virtual communications kernel 210, as a configuration file, or some other similar data input. In all of these cases, the determination code may be static, such that the determination of a given modulation sequence or use of modulation packages can be fixed; in other embodiments, the determination code may utilize dynamic information. In the static instances, variability may still be introduced based on placement of the modulation packages within the modulation chart. As one example, a static determination code may generally state that the virtual communications kernel 210 should use the modulation package in position 1, then the modulation package in position 2, and so forth. The process of creating the modulation chart could therefore distribute, either randomly or according to some set of rules, the modulation packages into various logical positions for different iterations of the modulation chart.

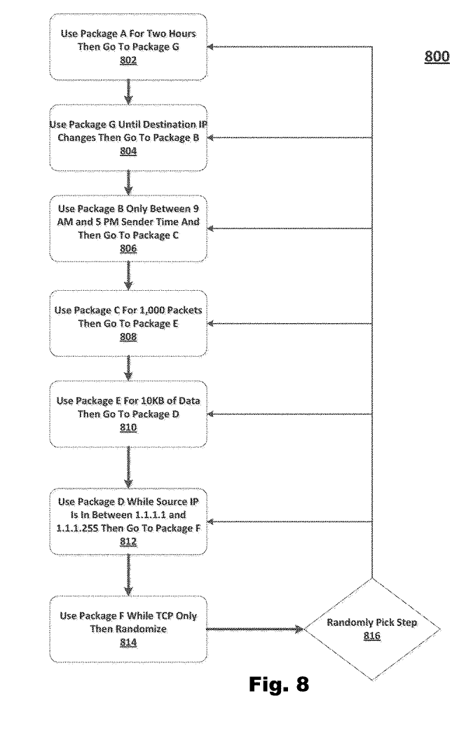

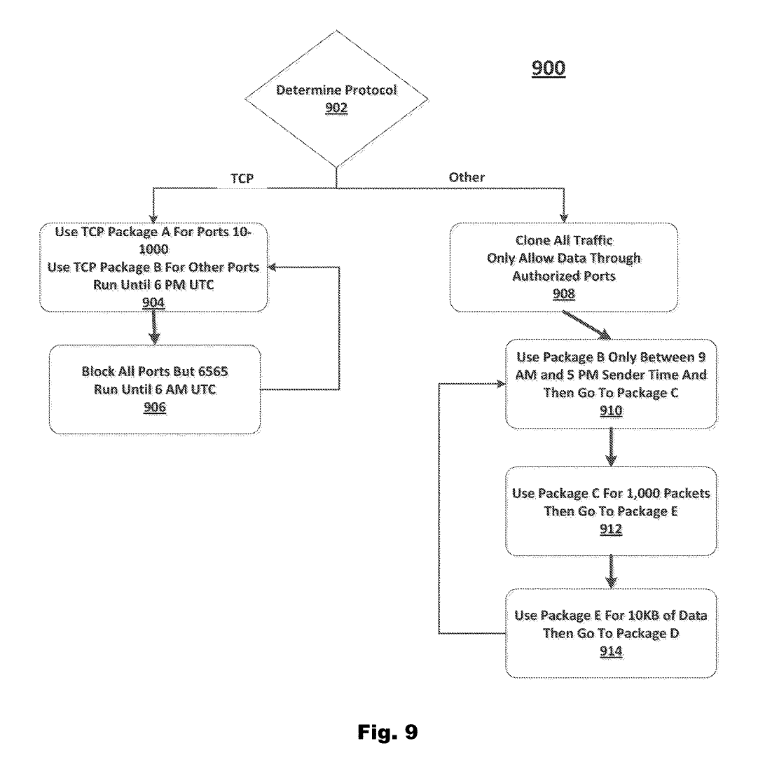

In other embodiments, a connector pattern is created in which the order of transitioning from one modulation package to another is determined ahead of time. FIG. 8 demonstrates one such conceptual example of a connector pattern. In this example, options such as duration (block 802), source/destination IP addresses (blocks 804, 812), time (block 806), amount of data (blocks 808, 810), and protocol (block 814) are used to determine when to switch from one modulation package to another. While the variety of factors in FIG. 8 is demonstrative, it should not be interpreted on a limitation on the scope of the present disclosure. That is, these options are a sample of a larger set of characteristics that may be used to create a connector pattern. In this example, the modulation packages are referred to in a generic sense (e.g., Package A, B, C . . . ). However, FIG. 9 shows another connector pattern in which a determination (block 902) separates packets by protocol, after which different modulation packages are applied to these packets. The modulation packages may be built based on protocol, with some communications control components added. The concept of communications control will be explained further below.

Connector patterns can be generated manually, for example by using prebuilt software and/or business rules, or through a larger system output such as machine learning. In the latter case, a big data analytical system may be setup to model data and predict possibilities such as network saturation, vulnerability times, and usability windows. A usability window, as one possible example, may be defined as a time during the workday when administrators need direct access to a backend data store through their client side tools. A learning system receives packets from the target backend data store over time to determine this window dynamically and to alert users when an outlier access attempt is created. In this hypothetical example, such tools may require certain ports to be opened for a small range of protocols. Outside of that usability window, the ports can be closed. Additional data inputs such as past successful intrusions, user behavior, and network load can be input to enhance the predictive model until a point where the model is capable of generating connector patterns that leverage the strength of a given network and reduce an increasing level of exploitable weaknesses. This latter feature again enforces the strength of a distributed deep packet inspection firewall approach.

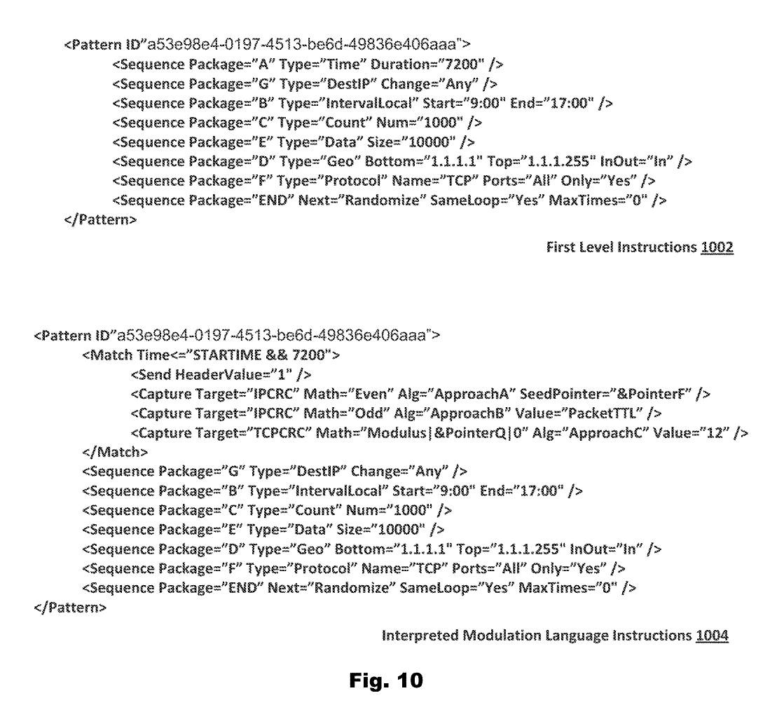

A modulation chart can therefore contain a range of specific modulation packages and an optional connector pattern. This information is optionally stored and transmitted to devices 202 throughout a given network 214. This information can be conveyed to devices 202 as a text or binary configuration/policy file, a library, an embeddable module such as a COM+ component, a loosely coupled precompiled component such as a DLL, as a new client application or other similar option. In some embodiments, the conceptual steps outlined in FIG. 8 are reduced to XML-like first level instructions 1002 as shown in FIG. 10. It should be appreciated that the instructions 1002 (and 1004 discussed below) demonstrated in FIG. 10 are conceptual and such a concept may be implemented in myriad ways. These instructions generally reduce the conceptual design into interpretable instructions based on localized resources. In these embodiments, the virtual communications kernel 210 translates semantic items such as Time, DestIP and location into local methods/subroutines and/or programs and passes in the rest of the instructions in turn. The local virtual communications kernel 210 also has access to modulation packages A through G.

Further embodiments may utilize an interpreted modulation language to further reduce semantic level instructions 1002 into more actionable interpreted modulation language instructions 1004. For example, as shown in FIG. 10, the semantic level instruction 1002 is broken down into a packet characteristic, or characteristics depending on the filtering complexity/embodiment, a match type, the encryption approach to apply, and the location of any input values required. For sake of explanation, the filtering criteria, match type, approach, and seed values in this example are all singular. It should be noted that each of these can be optionally expanded to contain more options as needed. For example, the first capture line in this example instructs the virtual communications kernel 210 to match on any packet where the IP level CRC value is even. This filter could be expanded to include such options as protocol, sending application, and/or destination IP address. Match values can be statically included as provided in the first capture line or the match can include a dynamic value as provided in the last capture line, which conceptually states that the TCP CRC value modulus the value found at the location identified by the pointer & PointerQ needs to equal 0.

The next part of the capture line determines the encryption approach to be applied to the captured packet. The actual approaches may be hard-coded into software, part of an initialization configuration file, or be pulled dynamically through a static pointer. More than one approach may be applied, which could be applied in the order included—for example, right to left or left to right. Finally an optional series of either statically-included values, pointers to dynamic values, or a characteristic of the packet can be included for the algorithms as needed. Note that the last capture line can result in the application of multiple operations to the same packet. In this case, the IP CRC match occurs first and the TCP CRC match occurs second for outgoing packets, whereas the opposite is true for incoming packets, along with the reverse application of an encryption approach (e.g. decryption rather than encryption) applied for matched packets. In cases where values such as CRC or packet size are utilized, the original CRC, TTL, packet size, or other alterable values, may be included in an optional virtualization header 122 to enable subsequent decryption.

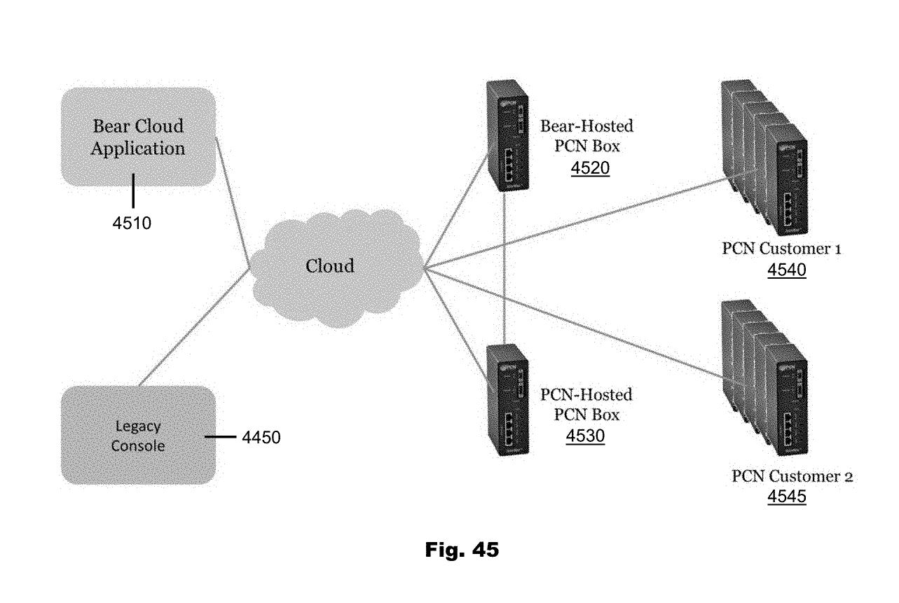

The interpreted modulation language instructions may be partially compiled in a central location and then transmitted to a device 202, depending on the embodiment, or completely compiled prior to any transmission. Optionally, the instructions may be Blockchain-encrypted prior to any transmission, as described in detail below in reference to FIGS. 45-47. In the case of partial compilation transmission, the ability to complete the full translation may rely in part on code embedded in the virtual communications kernel 210 on the device 202, physical characteristics of the device 202, and/or decryption of subsequently transmitted data. In one embodiment, a partially completed modulation chart is encrypted in one manner using a specific user device public key, signed with a central/network private key, and then transmitted to that device 202. In this instance, a separate set of data sufficient to complete the modulation chart may be encrypted using a standard algorithm along with the current IP address of the device 202 and sent to that device 202. The device 202 may then use the network public key to verify the authenticity of the incoming data and then use its IP address and private key to decrypt the data prior to finishing the compilation of the modulation chart.

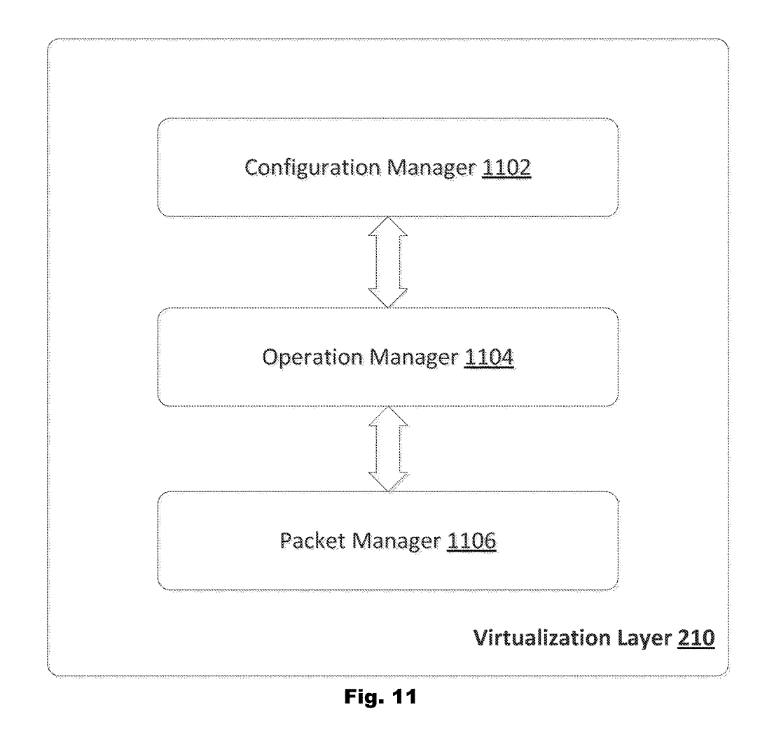

By using modulation charts that are sent separately to all devices 202 ahead of time, devices can engage in long-running communications that modulate encryption over time. These modulations provide enhanced security relative to a static, non-changing encryption system. To better understand the implementation of modulation charts in virtual communications kernel 210, FIG. 11 shows an embodiment of virtual communications kernel 210 in further detail. The virtual communications kernel 210 includes a configuration manager 1102, an operation manager 1104, and a packet manager 1106. These managers represent logical constructs and thus may or may not be implemented discretely. Some embodiments may combine all or some of these constructs together, whereas others might re-organize the functional areas. All such embodiments are within the scope of the present disclosure, and these managers are delimited as such for explanatory purposes.

The packet manager 1106 is generally responsible for capturing packets of data as those packets leave the last layer within the operating system known space 206 on their way the physical layer 212. The operation manager 1104 is responsible for applying a given encryption approach onto a given captured packet according to one of the various embodiments described in this disclosure. The configuration manager 1102 is responsible for setting up any variable data such as encryption keys, modulation charts, and so forth. These subsystems can be organized in a variety of ways including in kernel mode only, in user mode only, or across user and kernel modes.

Kernel mode is generally defined as a part of an upper level layers 204 where enhanced access to a kernel is provided. Some operating systems 204 do not provide a strict partition, but rather utilize another method for restricting access such as security, authorized access, or even special types of internal protocols. Thus, the concept of kernel mode is used to describe the concept of enhanced kernel access as opposed to restricted kernel access. The region, logical or not, of the upper level layers 204 where access to the kernel is restricted is generally referred to as user mode. Again, different operating systems 204 delineate parts of their system in different ways. User mode may be used to describe a logical or physical part of an upper level layers 204 where access to the kernel is more controlled and/or restricted relative to another region of the upper level layers 204 (i.e., the kernel mode).

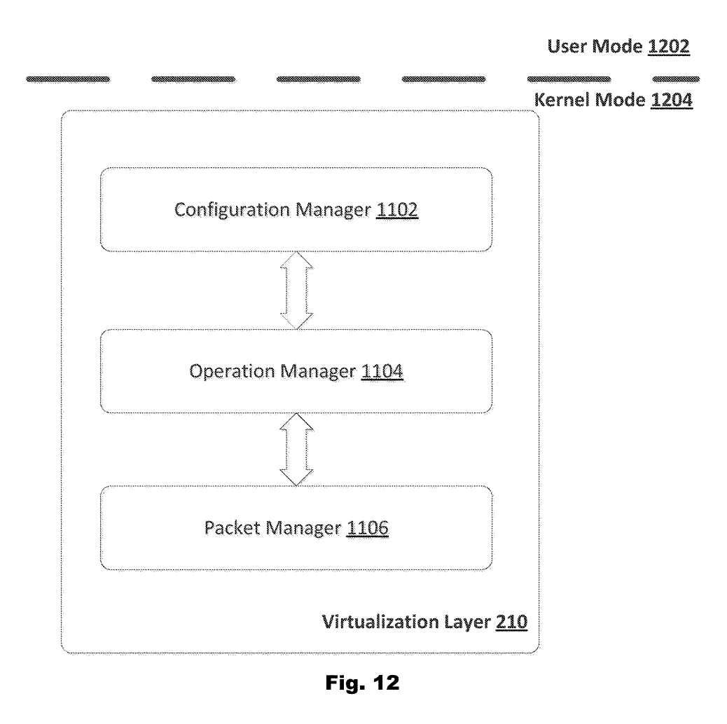

In general, processes running in kernel mode have less access to other resources such as memory, I/O, and so forth compared to processes running in user mode. User mode processes tend to interact with the kernel at a slower pace and often have a lower processor priority, which may result in slower processing times. In some embodiments, the entire virtual communications kernel 210 may reside in kernel mode to optimize speed. One such embodiment is shown in FIG. 12. Here, the virtual communications kernel 210 resides completely in kernel mode 1204. The packet manager 1106 intercepts outbound data packets and passes those packets to the operation manager 1104, which performs an operation as described above based on values defined by the configuration manager 1102. Once the operation or operations are complete, the operation manager 1104 passes the packets back to the packet manager 1106, which optionally places the packets on the same communication line for transport to the physical layer 212. One of the limitations imposed by many operating systems 204 on processes residing in kernel mode 1204 is limited access to resources such as memory, which often forces configuration information to be defined during process initiation. As a result, embodiments in which the virtual communications kernel 210 resides completely in kernel mode 1204 may collapse the configuration manager 1102 into the operation manager 1104 and not allow for continuously updated configuration information. Upon launch of the virtual communications kernel 210, in other embodiments, options such as the applied encryption algorithm, dynamic values such as SALT, and any required key-value pairs are read and may be, for example, contained in locations accessible through static pointers. One enhancement to this base example comprises a two-driver system in which one driver is responsible for executing the packet manager 1106 and the other driver is responsible for executing both the operation 1104 and configuration 1102 managers.

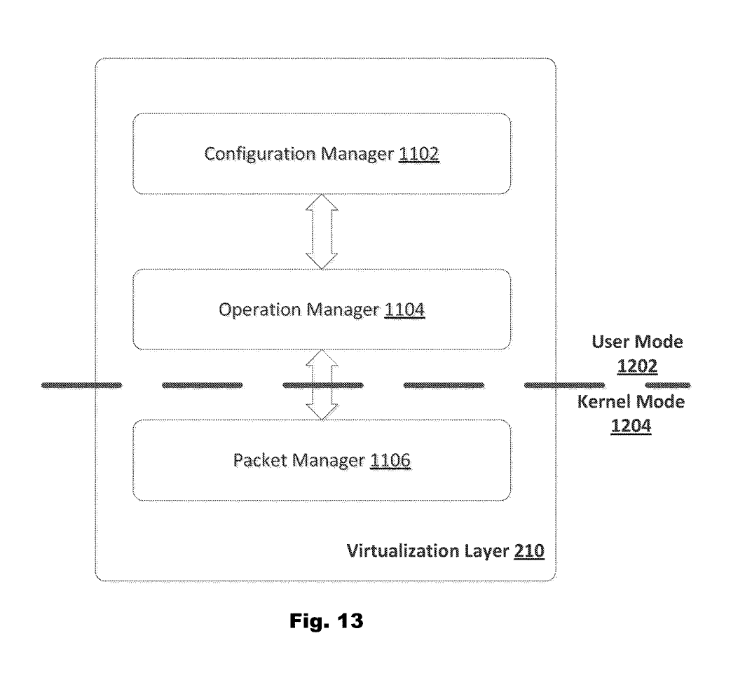

FIG. 13 demonstrates an embodiment that leverages a more robust set of resources available in user mode 1202. In FIG. 13, both the operation 1104 and configuration 1102 managers reside in the user mode 1202, leaving only the packet manager 1106 in kernel mode 1204. The packet manager 1106 typically remains in kernel mode 1204 due to restrictions on packet access at the level required for implementation of the above-described functionality of the virtual communications kernel 210. However, in alternate embodiments where the virtual communications kernel 210 is implemented as a separate process outside of the upper level layers 204, such restrictions are not applicable. In those cases, the virtual communications kernel 210 may maintain the various described manager constructs, but no restrictions exist due to the functional distinctions between user mode 1202 and kernel mode 1204. Further, in such cases, resources are defined during a process such as the BIOS pre-boot process and are typically based on overall device 202 resource limitations.

Referring to the specific embodiment of FIG. 13, the operation manager 1104 retains a significantly larger amount of resources, including the ability to retain stateful information about virtualized packets 120 when compared to kernel mode-only embodiments. It should be noted that kernel mode-only embodiments may also maintain stateful information, as some operating systems 204 do provide sufficient resources. However, it is a challenge in many operating systems 204, particularly those on mobile platforms, to obtain sufficient access to memory in kernel mode 1204. Thus, embodiments placing the operation manager 1104 in user mode 1202 are able to store virtualized packets 120 for a variable duration. As one example, a given embodiment may store a sent virtualized packet 120 for a duration equal to the time to live value found in the header of that packet 120. By storing these packets, the operation manager 1104 can respond to retransmission requests from a remote device 202 without having to first send a request back to the upper level layers 204. This is particularly useful in cases where dropped packets are common, for example in mobile or microwave communications.

The operation manager 1104 can also store dynamically generated values such as encryption keys, computed seed values, and similar data for optimized encryption processing by the virtual communications kernel 210. Although an encryption key could be computed for each packet, it is more efficient to compute a key once and then reuse that key for the duration of the encryption approach. Similarly, a seed value may be a static value or it may be computed by an algorithm such as a time series, location-based, or other such approach. Even in the case of a time series algorithm, storing a computed key or seed value for milliseconds can result in performance improvements through enhanced efficiency. Longer lasting values may also be stored, such as the location of various encryption libraries, session keys to support different communication efforts, time sync values between two devices 202, and so forth. Running the operation manager 1104 in user mode enables a manner in which to store this information.

By locating the configuration manager 1102 in user mode 1202, configuration information can be dynamically updated in a much wider range of ways. For example, some embodiments may utilize configuration files, whereas other embodiments read remote locations, obtain push updates, or use some combination thereof. As one example, a configuration manager 1102 makes a remote service call to retrieve all or part of the configuration information that it needs, including such items as modulation charts, key generating algorithms, seed values, and other dynamic information. This data is sent to the configuration manager 1102 as part of an authentication process, or an administrative channel may push updates through according to a range of criteria from time intervals to attack responses. In all of these cases, placing the configuration manager 1102 in user mode enables a wider range of possibilities and interactions, including interactions with a logged in user, when compared to running the configuration manager 1102 in kernel mode 1204

In many operating systems 204 the movement of a packet of data from kernel mode 1204 to user mode 1202 results the generation of a copy of the packet. Many operating systems 204 retain the original copy while the copied packet is in user mode 1202. Thus, moving a packet between kernel mode 1204 and user mode 1202 can result in numerous copies of the packet being maintained for some amount of time. Heavy system loads exacerbate the impact of such issues that result from internally cloning the packet. Depending on the embodiment, the device 202 resources, and system allowances, these performance impacts may not be tolerable.

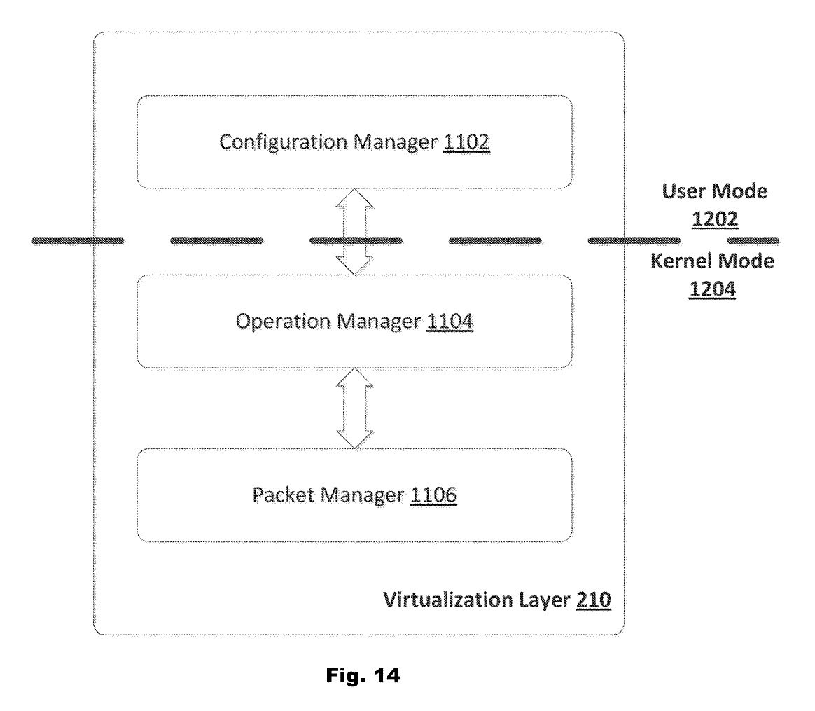

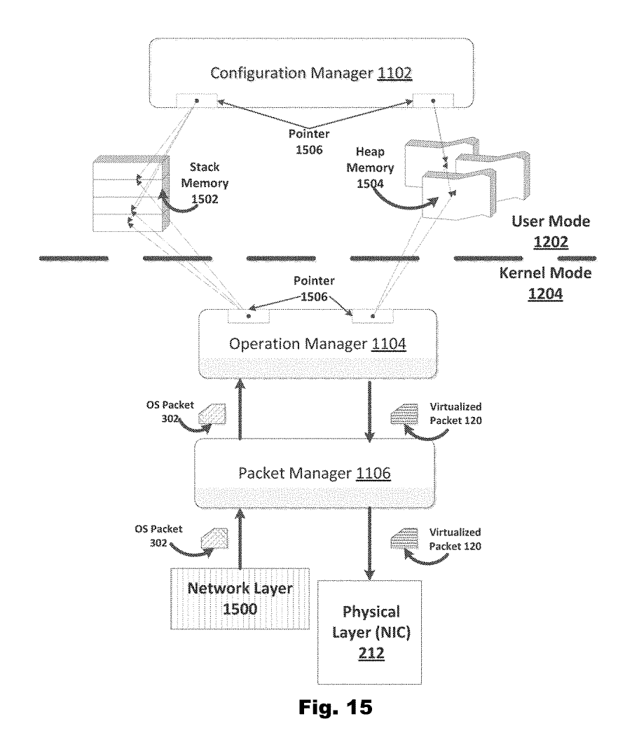

For higher-demand embodiments, or in the cases of more restricted devices 202, such as mobile device, the operation 1104 and packet 1106 managers are placed in kernel mode 1204 while the configuration manager 1102 is in user mode 1202 as shown in FIGS. 14 and 15. These embodiments have the benefit of improved speed of kernel mode 1204 processing without the configuration limitations of the solely kernel mode 1204 implementation. In order to access configuration information, the packet manager 1106 could utilize a static pointer 1506, a mapped memory file, or utilize a protocol such as named pipes to obtain data stored in user mode 1202 amongst other similar options.

FIG. 15 demonstrates one such embodiment, in which the operation manager 1104 and the configuration manager 1102 access shared locations in stack 1502 and/or heap 1504 memory. Each manager 1102, 1104 accesses these locations using a pointer 1506, which will be a static pointer for the operation manager 1104, but may or may not be static for the configuration manager 1102. In some embodiments, the operation manager 1104 establishes static pointer locations in the heap 1504 and/or stack 1502 that the configuration manager 1102 scans and finds upon either its initiation or during processing. Leveraging shared memory locations allows the configuration manager 1102 to utilize a range of simple values or complex objects, while permitting those objects to be statically read by the operation manager 1104. Thus, as one example, interpreted modulation language instructions can be further reduced to a series of if-then loop instructions that are written to a shared location in memory 1502, 1504 by the configuration manager 1102 based on a new modulation chart. The operation manager 1104 can then compare an incoming communications packet 302 to the current filtering statements and match statically on an updated series of statements. This technique enables fluctuations over time in encryption approaches even while maintaining static kernel mode 1204 processing.

As described previously, an encryption approach is a process or method where a given type of encryption is applied to a packet. FIG. 10 provided one conceptualization of how an approach might be implemented. It is important to note that these instructions can include an algorithm and, as described, moving algorithms to different positions can alter the overall application of approaches or operations even when the modulation sequences are hard coded in a given embodiment. Approaches using encryption are not restricted to just performing encryption and can include other operations in conjunction with encryption such as packet pointer security, communication wrapping, and so forth.

The above approach is algorithm-agnostic, since various encryption algorithms may be easily interchanged, and thus gives rise to an open encryption platform concept where any encryption algorithm can be used without requiring higher-level direct knowledge of that algorithm. To accomplish this, various embodiments of the present disclosure support a common interface across algorithms. This interface is one to which all algorithms are written, which is the case for example with class factory adaptations. Alternatively, the open encryption platform could be encapsulated in a common wrapper that still supports a class factory approach, but more similar to a distributed library technique such as those found in dynamic link libraries. In all such cases, the use of static pointers, large object constructs such as arrays, and other such input options provides a layer of abstraction at the interface level. Other embodiments might utilize encryption-on-a-chip wherein a chip manufacturer provides a standard interface and the actual algorithm is not disclosed. Subsets of these embodiments might switch out the encryption on the chips, accordingly to the same range of possible rules described previously, thus changing encryption without modifying the interface with the chip itself. These latter embodiments give rise to out-of-band encryption management where such features as encryption algorithms, keys and SALT can be modified independent of the parts of the virtual communications kernel 210 that are actively processing packets.

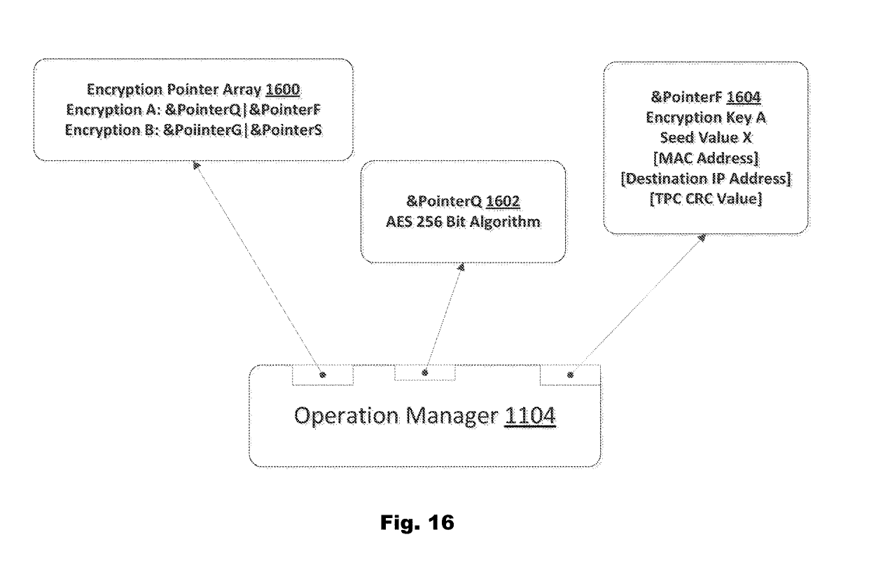

As one example, FIG. 16 shows a given embodiment that utilizes a static memory pointer to obtain an array of instructions for the algorithms to be used. FIG. 16 is provided for sake of explanation, but should not be interpreted as providing a limitation on the scope of the open encryption platform disclosed herein. In FIG. 16, the operation manager 1104 reads an encryption pointer array 1600 to obtain a list of available encryption options. In this case, each option has a pipe-delimited list of other pointers that point to a target encryption algorithm object location as well as to a text array to be passed into each encryption object. This simplified interface therefore takes in one generic text array with a variable number of entries. In the case of the first encryption option, Encryption A, the algorithm object is an AES 256 Bit Algorithm into which the text array found at the location designated by the pointer & PointerF 1604 is used. Within the text array retrieved from that location, for the purposes of this example, square brackets denote dynamic data that the operation manager 1104 needs to replace prior to passing that information into the algorithm found at the location designated by the pointer & PointerQ. In this case, the dynamic values are media access control (MAC) address of the device 202 as well as the destination TP address and TPC-level CRC of the individual packet

Certain embodiments may load the encryption pointer array 1600 at startup, while others load might load the array 1600 on demand, while still others might load the array 1600 on startup and then periodically check that array 1600 for updates. Similarly, the referenced algorithms can be loaded and/or updated at different times in various embodiments. In dynamic-loading embodiments, dual processes can be instantiated with the encryption options to be changed maintained in one instance and the new values in a second instance. In these cases, new packets are transferred to the new instance while the old instance is maintained for a specific period of time to manage packets that utilized the old values. A possible time period may be defined as the maximum TTL for any given packet. These techniques allow for an algorithm-agnostic approach that enables a dynamic open encryption platform. The open encryption platform can be thought of as supporting “pluggable encryption.” That is, as long as a given encryption option meets the interface requirements for a given embodiment, that encryption option can be added to the platform at any time without requiring major revisions to the overall virtual communications kernel 210

To protect against exploits such as cold boot or RAM or similar, attacks, certain embodiments of the present disclosure might require all encryption options to be signed using a known certificate or key. Other embodiments might, instead, require that the encryption objects or code be sent in an encrypted format to the device 202 and then decrypted and instantiated/compiled at runtime on the device 202. In these latter cases, the encryption may utilize a device 202 public key that can only be decrypted on the local device 202. This key may be a general key for the device 202 or the key might be a key generated just to transfer one or more encryption options to the device 202 such as in a blockchain environment. In a similar manner, other embodiments may require all data referenced through a pointer to be encrypted prior to being stored in memory. In these cases, the configuration manager 1102 can be used to carry out these encryption requirements. The encryption utilized might be one of the options made available to the operation manager 1104, with optional different input values, or a distinct encryption option might be used for either or both the encryption options and the other stack 1502 values or heap 1504 objects.

As noted above, another important aspect of a comprehensive communications security solution is the ability to control communications between devices. Unlike prior efforts such as IPsec, which only encrypt data between devices, the present disclosure also extends into authenticating and authorizing communications between devices 202 before any communications can even occur.

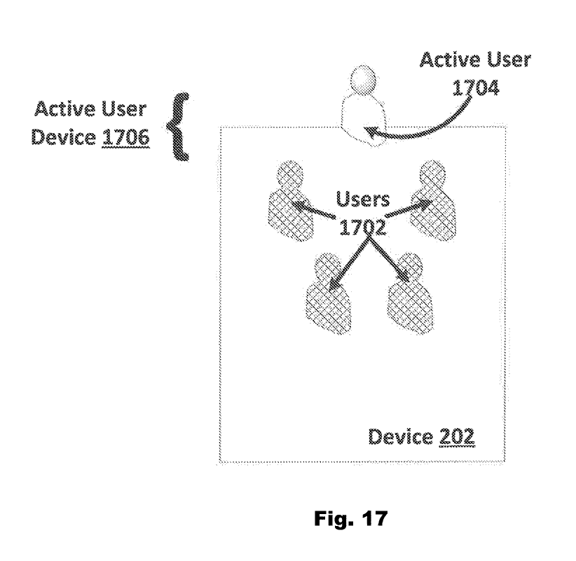

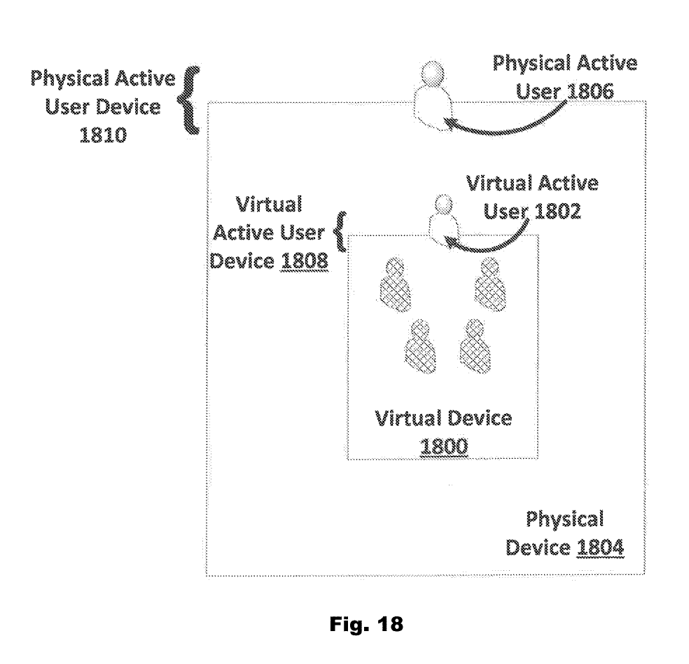

A central concept to the disclosed communications control embodiments is that of an active user device, which is at times also referred to as a user device. Turning to FIG. 17, a device 202 can have a variable number of users 1702 with access to that device 202 at any given time. In fact, especially in the case of backend services and processes, there can be a variable number of active users 1702 on a single device 202 at any period of time. However, for a specific communication stream, there can only ever be one active user 1704 on a given device 202. This single active user 1704 for a specific device 202 communication stream is referred to as an active user device 1706. A device 202 in this case can be a physical device 1804 or a virtual device 1800 as shown in FIG. 18. This gives rise to virtual active user devices 1802 and physical active user devices 1810 which may or may not interact, on even be nested as is the case for physical devices 1804 hosting one or more virtual devices 1800 or parts therein, depending on the embodiment.

As will be discussed, utilizing a variable first-class membership authentication system enables handling these virtual active user devices 1808 in a novel manner By elevating users and devices to the same first class member status, rules can be applied to virtual and non-virtual users 1702 and devices 202 and combinations therein by applying a different set of rules to different combinations. Thus a virtual machine, which is typically an application running on a device 202, can be assigned a range of authorization rules. As one example, a general rule might be conceptually “no Internet access”. Thus a virtual administrator running in the virtual machine—with complete access to that machine—would not be able to access the Internet due to the general communications control list 2600. Another, more interesting, rule might be a downgrade rule for an example such as classified documents. Within this example, a given device 202 might state that all users are restricted to a maximum of security clearance based on device location, network access and other such options. Thus a person with top secret clearance, using a desktop device with unrestricted access, utilizes a VPN to bypass a local network and can only obtain normal secret documents. By elevating applications to the same first-class level, these communication control rules can be extended even further. In these embodiments, applications such as an Internet browser might be preventing from writing to an operating system for certain users 1702 on particular devices 202.

As yet another example, assume the virtual active user device 1808 is granted super user access on a virtual device 1800 and the physical active user device 1810 is granted basic user access on the physical device 1804. For purposes of communication, there might exist a general communications control list 2600 preventing any off device access for virtual devices, which precludes the need to combine active user device definitions together, or there might be a policy that treats virtual users the same as physical users. Other embodiments might simply assume the physical active user device 1810 rights for all processes hosted within, which again precludes the need for combining rights. Other embodiments may combine rights where the resultant active user device is a logical combination that creates a virtual physical active user device 1808 and 1810. All of these options are possible, both across different embodiments and within a given embodiment, as different types of active user devices 1808, 1810 might require different approaches. To this latter point, working in a sandbox or isolated environment may permit more lax rules whereas working in a sensitive production area or highly-connected public environment might require a more stringent set of communication rules.

Combining the communication control list with the virtual communications kernel 210, enables unique protective features. In certain embodiments, as one example, virtual communications packets 302 can be tagged by the virtual communications kernel 210 to do denote a user access level and an origin. On the way into another physical device 1804, the virtual communications kernel 210 can read its active users' communication control list to determine where and how to route incoming communications packets 302. In some embodiments, a virtual communications packet 302 might have a single tag denoting that it was sent from a virtual device 1800 through a physical device 1804. The receiving physical device 1800 might remove the tag and the virtual device 1800 might reject any communications packets 302 with the tag present. In these embodiments, processor flaws enabling malicious attacks within a physical device 1804 across hosted virtual devices 1800 would be blocked due to the tagging of the communications packets 302. Other embodiments can leverage the virtual communications kernel 210 to reject any incoming communications packets 302 that do not have the correct tagging thus enforcing communications control lists 2600 for active user devices at the level of each incoming communications packet 302.

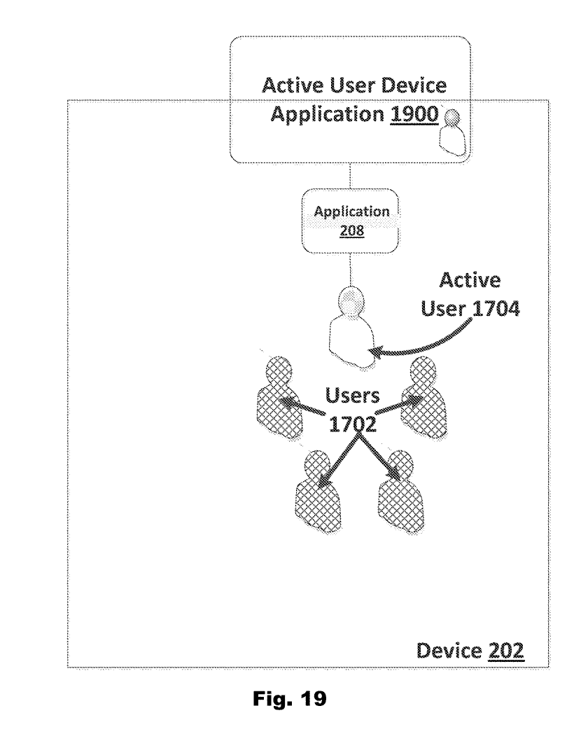

Turning to FIG. 19, there are typically two participants within a given device 202 for a specific communication—an active user 1704 and an application 208. The present disclosure also relates to the concept of an active user device application 1900, which further extends communications control to the application level. As has been discussed, this provides for a deeper level of control. However, for the sake of clarity the following largely focuses on the active user device level.

Most modern LDAP systems utilize a single first class member and then assign characteristics, otherwise referred to at times as metadata, attributes, tags, or some other similar term, to that first class member. For example, many modern LDAP systems provide users as a first class member and then assign a tag such as group membership to each user. Resource access rights are typically assigned to the tags, which provide a group-based security system. Other LDAP systems use devices as the first class member. The use of a single first class member creates security weaknesses, which are addressed by embodiments of the present disclosure.

As one example, assume an executive who accesses sensitive corporate documents from both a central, secure office building and also remotely from that executive's mobile device. When the executive accesses information from the central office, that active user device should likely have a different set of access rights than the active user device that stems from the executive's access from a remote location. Further, it may be desired to provide the executive with one set of rights when accessing the corporate network from a “friendly” location (e.g., where cyber-attacks are less likely) as opposed to an “unfriendly” location (e.g., where cyber-attacks are more likely) in the world. That is, geographic constraints may also influence the permissions afforded to a particular active user device. However, by only utilizing a single first class member, the authentication capabilities in modern LDAP systems are unable to assign such differential rights based on the interaction of a user and device much less by location.

In accordance with various embodiments, the implementation of active user devices 1706 provides an improved two-member authentication system where both users and devices are elevated to first class members. This approach enables a new type of interaction, the active user device 1706 rights, which can be directly utilized or managed through indirect interactions. Rights can be assigned to devices based on device group membership and users based on user group membership and then rules can be created to control combinations of those memberships. As one example, a rule for executives might be that only executives can read any document on the corporate secrets server. In this example, mobile devices might have a rule stating that they can only read documents up to general secret protection. Thus an executive on a mobile device might get a resultant rule stating that they can read any document on the private secrets server that has been marked as general secret or lower. These rules are generally provided in a communications control list 2600 which is similar to an access control list but focused on communications control instead of resource access control. Rules for collisions, similar to the rules used for group membership collisions in modern LDAP systems, can also be used to control user and device interactions. Examples of such rules are user wins, device wins, hierarchical determination, and so forth. Other interaction management options will be apparent from the disclosure herein.

By providing an active user device 1706 paradigm, options such as device location can be included as additional attributes either directly to the active user device 1706 construct, to a user, or to a device. This enables further refinement within the active user device to provide a differential set of access rights depending on dynamic information such as, for example, geographic location. All of these concepts, while discussed with respect to resource access up to this point, can be similarly applied directly to communications.

This concept of location-based authorization for active user devices 1706 can be further extended in some embodiments to include the concept of geographic intelligence. In this manner, a type of device might be provided with a set of restrictions based on changes in location. As one example, a desktop computer might not be allowed to travel more than 100 miles in an hour but a mobile device might not have this restriction. These restrictions introduce another communications access rights paradigm discussed more fully in the next section. In response to violating a location-based rule, a device 202 might be forced to re-authenticate, the virtual communications kernel 210 might be uninstalled or the entire user device 1706 communication capabilities blocked or redirected until a properly authenticated user unlocks the user device 202. This latter communications control might be contained within the one offending user device 1706 or, depending on the embodiment, all user devices 1706 for that device 202 or that user 1702 can be affected. Movement is not the only type of location-based rule as, for another example, there might be rules based on multiple logins by the same user 1702 or device 202 from different locations. These latter rules might range from not allowing multiple locations to allowing multiple locations within some defined distance variable on device type and so forth.

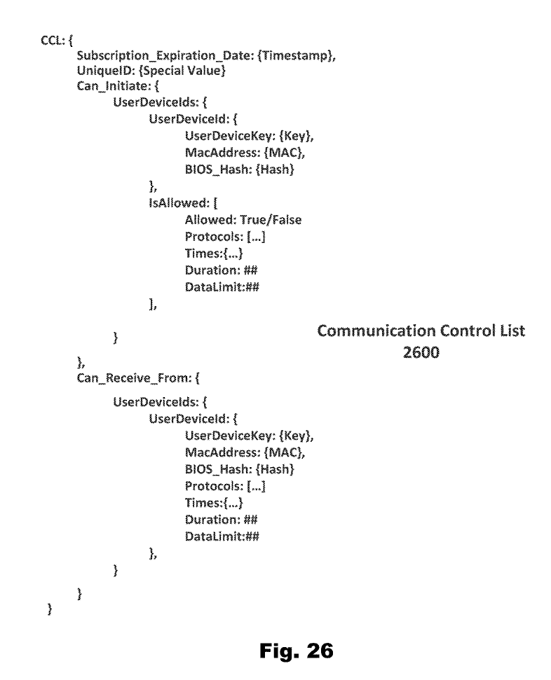

Communications access rights also provide the ability to restrict initial communications in a variety of ways. At the device level, types of devices (e.g., desktop, laptop, mobile, manufacturer, or operating system) can be directly managed. As one example, all mobile devices might be required to only use certain ports or be restricted from certain subnets within a network. Users might also be directly managed in terms of communication, for example all accounting personnel cannot initiate communications with TT personnel, or only an executive can initiate communications with an employee. Rights can also be applied on the receiving end; for example, billing personnel cannot accept any communications outside of a given protocol. Communications can be restricted or locked down by any characteristic of a communications effort including such options as network used, protocol, application, data type, time of day, duration, and amount of data. These options provide support for complex communications control options that may extend far beyond what is available in the prior art. As another example, consider a background service that obtains updates from a central server every day at 1 AM. As shown conceptually in FIG. 26, a communications control list 2600 entry for that service might only allow that service to provide any off device communications at 1 AM, only allow one request to be sent out, and only allow one response in, up to a finite amount of data over a specific protocol from a finite number of allowable active user devices. “Off device communications” can refer to data sent outside the physical boundaries of a device as opposed to internal device communications, which are typically communications within device boundaries, such as applications communicating across application domains or a given application requesting, for example, I/O access.

Some embodiments include communication characteristics such as protocol, network type, throughput, network hops and so forth, as additional attributes added to users and/or devices, where other embodiments create yet another first class member. This latter feature reveals the potential of a variable first class membership authentication scheme. In this latter set of embodiments, the communication control features are appended directly onto groups of communication types and those types may be defined by any characteristic of a communication effort. Thus given groups may be defined communication control characteristics, further including options such as port numbers, geographic locations, internal vs. external, subnets and so forth. Control can then be applied by other options such as type of data, amount of data, duration and time of day amongst other features. This first class member can then be combined with users and devices to enable a rich series of interactions that fully lock down communication access to whatever degree is required by a given network or enterprise. As one example, a first class insecure communication member might have a general restriction of not allowing any level of secret data. This first class member might be defined by broadband networking protocols. In this case, an executive authorized to access regular secret and general information on a laptop would lose access to secret information when the laptop transitions from a local wireless home network to the broadband connection from the café next door.

Returning to the use of applications as a first class member, there are a number of reasons for extending control down to this level. First, an administrator can group applications together using any semantic category, which are used throughout modern LDAP and would be an option for any first class member in that respect. As one example of semantic categorization, an administrator might create application groups such as personal, background, employee work, employee social and so forth. Administrators, and/or any appropriately authorized user, can generate a semantic definition as required and even overlap definitions for different enforcement reasons. Traditional definitions by business unit or corporate hierarchy might be used as well as trusted vs. untrusted people, number of years of employment, certifications obtained, behavioral testing results, and so forth. Each of these application groups can then be controlled in any manner desired in order to not only control the communication lines and protocols allowed by an application, but also with which other applications a given application can communicate or other application resources a given application can access. For example, a web browser might be designated in a high risk group with no access to employee resources on a computer or that group might not be allowed to save information if the total amount to be saved exceeds a certain size. Both of these restrictions aid in countering potential malware attacks from being downloaded and/or accessing data.

As will be discussed in more detail, prior authorization schemes rely on the first-class member authentication in order to determine authorization rules. These rules or configuration settings are most commonly referred to as Access Control Lists or ACLs. Since these systems only support one first class member, they are unable to provide interactions required for more detailed authorization requirements. As one possible example, a given file system might preferentially enable access to parts of its file system based on a user's security clearance. While an administrator might want to further define restrictions based on the device being used, in the current authorization implementations, this is not a possibility. In the variable first class membership authorization system described herein, the interaction of a distinct device first class member resolves this issue. Extending the current example, an administrator might enable full access to desktop devices but only allow non-secret access to mobile devices. Thus a person with top secret access would end up having differential access to a file system based on device type.

Taking this concept one step further, another first class member option can be communications, which can include both internal and external communications. One of the basic ways that malware spreads is through the use of scripting commands, such as PS Install, to automate the spread from one device to another. These commands are relied upon by allowed applications and operating systems and, as such, are not easily removed from a network. Further, many malware attacks will utilize these types of commands across a range of possible ports, sometimes referred to as port scanning, in order to determine an open port on a target device 202. In these cases, the communications control list 2600 can be leveraged along with the user device application construct to prevent these types of attacks. In the first instance, certain embodiments can prevent an application from transmitting packets unless the correct active user 1702 and device 202 are included in the communications. Therefore, applications attempting to transmit a command such as PS Install can be blocked at it source. In the latter case, a receiving device 202 can identify a port scan and block all communications from a suspect device until a signal from the correct active user device application is received.

Various embodiments of the present disclosure also provide the ability to monitor through existing techniques such as DTrace in order to maintain other rulesets. In this regard, one of the main challenges facing prior security is a weakness known as active scripting. Active scripting allows small programs to run within the context of a web browser in order to support more advanced user interactions. However, these nested applications often require resource access outside of domain of a standard application. Since there are no communications control options in prior LDAP systems, there is no way to lock down active scripting sessions, creating a vulnerability that is a source of attacks. For purposes of the present disclosure, communications also include data flowing within a device between application boundaries. One such boundary is that between a given application, such as a web browser, to device options such as a processor, file system, or memory.

This control enables the lockdown of a web browser, for example, such that it is only able to download a finite amount of data in a controlled space. On the external communications side, that web browser can be locked down such that the external IP address locations available to be accessed are controlled and can be optionally further refined by protocol. Thus, a given web browser might be allowed to use the FTP protocol for a finite set of IP addresses representing internal FTP servers, only the HTTP protocol for all other IP addresses, and no communications for IP addresses representing a given country. Any binary responses coming into the web browser can be locked down, for example using an option such as DTrace or the above-disclosed virtual communications kernel 210, such that the total amount of data allowed is fixed to be below a predetermined threshold. Utilizing the active user device application construct, these rules can be differentially applied such that a security admin might have more open access than an intern.

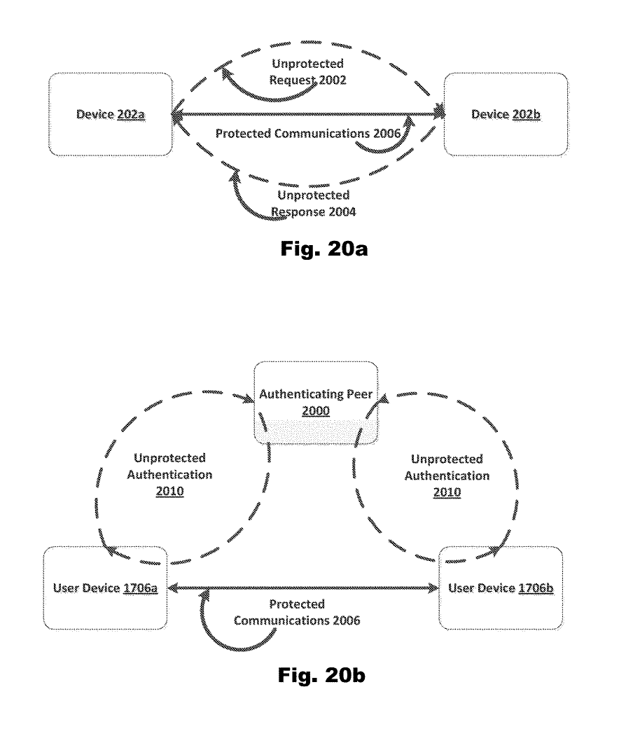

In order to support a variable set of first class members, in accordance with various embodiments of the present disclosure, a new type of authentication system is provided. Whereas some applications already provide identification techniques, the process of authenticating users 1702 and devices 202 is more difficult. In fact, many of the challenges facing modern communication security relate to how to establish secure communications. The restriction in these cases is that two devices 202, having not previously communicated, cannot exchange secure communications until a secret is shared between them. This secret is used for encryption, which is how current encryption operates, and the secret needs to be received by both devices 202. FIG. 20a shows one approach, public key exchange (PKI), which attempts to resolve this issue. These approaches are generally considered to be inline session initiation protocols since the session initiation occurs in the same path as subsequent communications will occur through. However, inline initiation approaches have been a point of weakness and source of exploitation for a number of years.

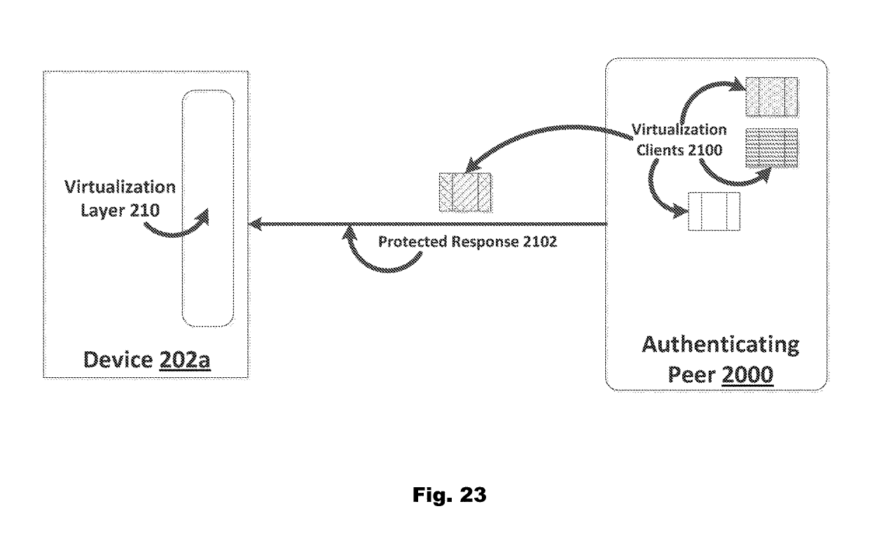

In accordance with various embodiments, FIG. 20b shows a system for out-of-band session initiation, which is an alternative to the inline initiation of FIG. 20a. The scope of the present disclosure should not be construed to be restricted to any particular architecture; rather, options such as client/server, peer-to-peer, mainframe, hybrid peer, and so forth are understood to be within the scope of this disclosure. While further disclosure may revolve around more traditional architectures, this is provided for the sake of clarity and brevity. For example, referring briefly to FIG. 23, the authenticating client 2300 could be a peer node within a peer-to-peer context that has access to an authentication client 2302. This access might be a static construct such as is found in traditional RADIUS/DIAMETER systems or it might be a dynamic construct based on a distributed mobile architecture and based on the active user device 1706 instead of static device placement. In this regard, the ability to authenticate both the device 202 and user 1702, as will be explained, removes many of the issues facing traditional authentication systems and the relative inability to secure remote connections without significant delays.

A given active user device 1706 can, as one example, include a separately authenticated active user device application 1900 that can act as an authentication client 2300. Depending on the embodiment, the authentication client 2300 might be comprised of more than one device 202 as will be described in a subsequent section.

Referring back to FIG. 20b, out-of-band initiation requires authentication of two would-be endpoints 202a and 202b of a communications stream with an authenticating peer 2000. This authentication process can then be leveraged to send each authenticated user device 1706 a secret enabling secure communications. This out-of-band approach provides an enhancement over the prior art in that no unprotected data ever travels over the same lines that need to be protected (i.e., for subsequent communication between the user devices 1706), but unprotected authentication 2010 itself can still be utilized. In fact by utilizing the previously described modulation charts, even first time requests can be protected between two user devices 1706 that have never communicated with each other before. The receiving user device 1706b, in these cases, would be able to use a modulation chart, an embedded static encryption approach, or some other previously presented option, to attempt to decrypt a first-time session initiation request. This concept is discussed in further detail below with respect to proactive network defenses.

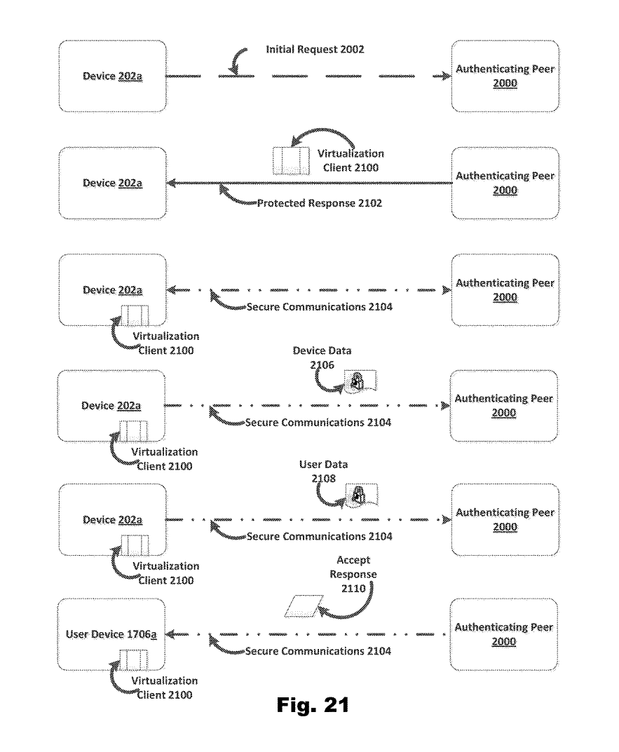

FIG. 21 shows the exchange of information in an authentication system in accordance with various embodiments. In FIG. 21, a device 202a sends an initial request 2002 to an authenticating peer 2000. The authenticating peer 2000 provides a protected response 2102 using an option such as SSL or TLS or, in embodiments using modulation charts as previously presented, the virtual communications kernel 210 might provide this protection. This response 2102 is labeled as protected since SSL/TLS both use inline session initiation and the protection would be considered secure if the virtual communications kernel 210 was involved in the communication. Once the protected response 2102 has been established, the authentication peer 2000 transmits a virtualization client 2100 to the device 202a. This client 2100 may take the form of any type of code that can be run on the device 202a. This includes such options as a precompiled application, an installer that either includes all of its code or pulls data from a remote location, or a script/program that can run in a web browser. The purpose of this virtualization client 2100 is to either install the disclosed virtual communications kernel 210 on the device 202a or provide the intermediary user and device information sufficient to complete authentication. The presence of the virtual communications kernel 210 does not define a user device 1706 nor is its functionality required to define a user device 1706. Likewise a virtual communications kernel 210 can run on any device 202 and does not require a user device 1706 on which to function.

A virtual communications kernel 210 can operate in a functional manner without any authentication or authorization and does not require such systems and processes as described herein. As one example, the virtual communications kernel 210 can run on devices 202 and encrypt all or a portion of the communications between those devices without any authentication. In this example, the authentication and authorization might take place in a standard LDAP system or through application-level processing. At the same time, the described authentication, authorization and accounting enhancements described herein need not incorporate a virtual communications kernel 210. While certain advantages may be realized by combining the disclosed virtual communications kernel with authentication and authorization processes, triple A Services may be supported by a range of options including applications 208 running in the upper level layers 204.

To this end, the present disclosure provides embodiments where the virtual communications kernel 210 is installed on the device 202a prior to authentication. These embodiments are exemplary and should not be considered as required. None of the functionality required for the disclosed authentication scheme requires the virtual communications kernel 210 although the virtual communications kernel may enhance speed by operating logically below the operating system and provides further security opportunities described in further detail below. That stated, some embodiments will not install the virtual communications kernel 210 until at least the device 202 or user 1702 have been authenticated and other embodiments will require full active user device 1706 authentication prior to installing the virtual communications kernel 210.

Further, the disclosure focuses on a single active user device 1706 authentication process and does not include cases where prior users 1702 have been authenticated on a device 202, nor does the disclosure distinguish between an end user authentication effort and a backend process or service authentication. In cases where the virtual communications kernel 210 already exists due to separate active user device 1706 authorization, the actual installation component might be an activation sequence for the current active user device 1706. Other embodiments might uninstall the virtual communications kernel 210 if authentication fails, or even each time a new authentication initiates (for end users only or varied by type of user 1702) for any user 1702 on a given device 202 and/or lock the current user 1702 out of the device/disable said service or process. Some active user device 1706 authentication processes will only enable one end user authentication per device 202 at any given time and handle pre-existing by preventing the current authentication or ending authentication for any current end user devices. Other embodiments might set a total number of active end user devices whereas others will either extend this limit to all active user devices 1706 or vary limits by active user device 1706 type. In these cases, deactivations might occur in a range of manners such as priority numbers, first in/last out/first in/first out, and so forth.

In some embodiments, the virtual communications kernel 210 includes information sufficient to establish secure communications and subsequent authentication can proceed. In other embodiments, however, the device 202a first needs to be authenticated itself If the device 202a is to be authenticated, the virtual communications kernel obtains sufficient information from the device 202a to uniquely identify the device 202a. Again the virtual communications kernel 210 is not required at this juncture as these operations can be completed by any sufficiently authorized process such as pre-existing services, downloaded code, application or scripts and so forth. Such information may include the media access control (MAC) address, any or all IP addresses and BIOS/UEFI (unified extensible firmware interface) information. This information 2106 is sufficient to identify the current device 202a and, once protected and sent back to the authenticated peer 2000, the device 202a can be authenticated.

In order to protect the device data 2016 going back to the authenticating peer 2000, some embodiments may generate a private/public key pair and then sign the device data 2106 with the private key pair. Sending the signed content and the public key will ensure that the authenticating peer 2000 can ensure the data came from the device 202a, at times referred to as digital signatures, but it does not protect the data 2106 from being intercepted. Other embodiments might thus utilize a public key sent from the authenticating peer 2000 to the device 202a in order to encrypt the device data 2106 prior to transmission. This ensures that only the authenticating client 2000 can decrypt the content. Some embodiments encrypt the signing hash, device public key, and content; others only encrypt the content; and yet others will not use a device public key and only use the authenticating peer 2000 key. Each of these keys can be privately-computed, third party-generated from a certificate authority, or themselves be certificates.

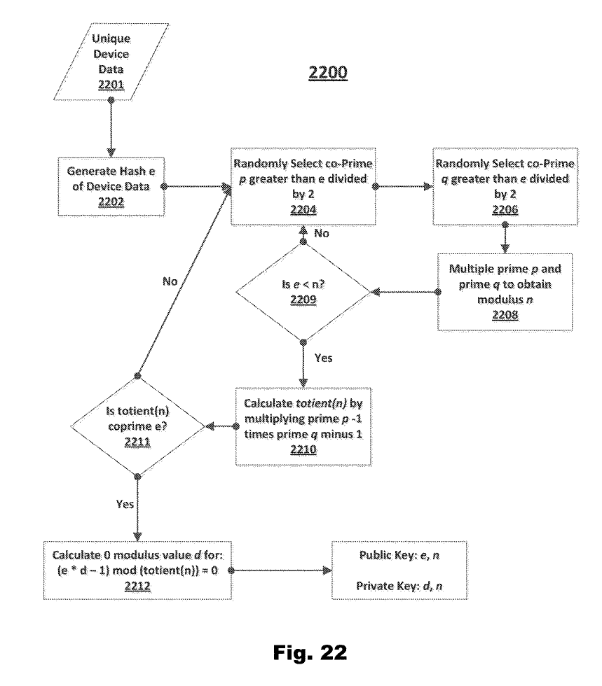

Further embodiments may require the ability to add in an additional layer of device 202 authentication by utilizing the exemplary process shown in FIG. 22. The main concept is to include as one of the values inputted into a key generation algorithm the values being utilized to uniquely identify a given device 202. In this manner the public key can be subsequently analyzed in order to verify device 202 authenticity. To understand this process more fully the following explanation of the key generation process is provided.

FIG. 22 shows a method 2200 in accordance with various embodiments. The method 2200 begins in block 2201 with receiving the various elements comprising the unique device data. The method 2200 continues in block 2202 where the unique device data elements are hashed using a hashing algorithm such as MD5, which results in a number, e. The method 2200 continues in blocks 2204 and 2206 with selecting co-primes p and q of e, respectively, that are each greater than half of e. The method 2200 then continues in block 2208 with multiplying p and q to obtain the modulus n, which needs to be greater than the original hash e as determined in block 2209. After ensuring this rule, the method 2200 continues in block 2210 with calculating the totient(n) by subtracting 1 from both prime values p and q, and multiplying those two results together. In block 2211, the method 2200 includes confirming whether the totient(n) and the original hash e are coprime. If the totient(n) and the original hash e are coprime, the method 2200 continues in block 2212 with calculating a 0 modulus value d for (e*d−1) mod (totient(n))=0, at which point a public and private key can be obtained in block 2214. The public key is then comprised of modulus n and e, which is the hash of the device data. This optional process therefore embeds that hash directly into the public key, thus ensuring that the public key came from that device. At any point in the future the device can be asked to re-generate the key pair in order to verify this hash.

It is noted that this is just one example to demonstrate the concept. Generating keys can also utilize SALT values and, indeed, alternative embodiments utilize this latter option in turn. Generally, a unique manner is provided in which a public private key can be generated with the public key being tied to physical attributes of the device 202a in some replicable manner Other options include using the physical attributes of the device as a modifier parameter or even utilizing a closest prime approach, where the two closest primes to the hash value e are used. In this later case, the totient(n) value would always exhibit a correlative relationship with the modulus n, which is commonly included as part of a public key. Further embodiments might also include unique user 1702 identification information, as is commonly found in LDAP systems, to create a key attributable to a user device 1706.

Referring back to FIG. 21, the authenticating peer 2000 then obtains the device data 2106 from the device 202a which has been optionally signed with a device private key and encrypted using the authenticating peer's 2000 public key. Additional information such as the device 202a public key may also be sent depending on the embodiment. At this point the authenticating server 2000 is able to authenticate the device 202a and the device 202b. In fact, given that the virtualization client 2100 can also be signed to ensure unaltered delivery, this approach closes the security gap in first time authentication efforts. Once the virtual communications kernel 210 is installed, the secure features of virtualized communications described above can be implemented and this, in turn, provides yet another avenue for secure communications as will be discussed further with respect to FIG. 23.

As will be discussed in a later section, communications can be secured using in-session keys. For the purposes of authentication, a newly activated virtual communications kernel 210 might obtain, or have embedded in it, a temporary session key. As shown in FIG. 23, an authenticating peer 2000 may store a variable number of virtualization clients 2100, each with its own unique session key. These keys might be embedded in the code, in a precompiled manner, included in a signed download as metadata, and sent as part of a longer communication data stream separate from the virtualization client 2100 itself. In some embodiments, these session keys might not be the actual session key but rather a unique identifier, such as a GUID, that is subsequently sent to the authenticating client 2000 in order to obtain a session key.

In all of these cases, the session key can then be used to establish virtualized communications upon the first response back from the device 202a when it transmits the unique device data 2200 to the authenticating client 2000. Some embodiments may allow the SSL/TLS connection to continue, while others may drop that connection altogether. Other embodiments further include a modulation chart, in a manner similar to the manner in which the session key is included, to provide additional flexibility. The modulation chart may also be provided in other manners. The modulation charts may wrap protocols and/or send communications out of nonobvious ports in an effort to better obscure communications. As one example, a common vulnerability in IPsec VPN implementations is the use of well-known ports. Since would-be intruders know ahead of time which ports to monitor, and because of current in-line initiation protocols, these intruders are able to sit and listen to certain ports and wait for an opportunity to infiltrate a given VPN connection. By utilizing other ports, a much greater effort is required to capture outgoing traffic. Even in environments where traffic flows over known ports, intruders also typically need to know the expected protocol in order to effect viable decryption operations. In embodiments of the present disclosure, where one protocol, such as HTTP, is nested inside another, such as SMTP, efforts required to obtain the base data become more difficult. This feature is discussed in further detail below. The use of this type of communications security approach does not obviate the encryption approaches provided for securing the device data. In fact, separate and distinct encryption beyond the communications encryption covered in the modulation charts/encryption approaches can be carried out for any data and even those options can be controlled using a modulation chart.

Once the virtual communications kernel 210 and the authenticating peer 2000 have exchanged device data 2200, the device can be authenticated. This authentication can occur through a range of options including complex lookups in logical data repositories, hashing and encryption techniques to reduce lookup complexities and so forth. Within this context, the authentication of a device is reduced to the general authentication processes for any first class member within this authentication system. In general terms, this process consists of utilizing uniquely identifying information of a first class member, either directly or through a remote system interface and the like to look for the presence of that first class member. If the member is found then that member's information can be retrieved and used in a variety of manners. Depending on the member and embodiments, that information might be used as part of a challenge response back to the user 1702 (challenges can be distinct as well from this information) or the data can be inspected to determine next authentication steps. If the member is not found then various rules based on any characteristic of the member can be implemented. As one example, a new mobile device might be allowed to be assigned to a user generically but needs to be dependent on a next authentication step. Conversely a known exploitation device might be rejected in turn prior to any further authentication efforts taking place.

In some embodiments, the deployment of the virtual communications kernel 210 may occur along with protected information from a deployment controller. Some examples include a deployment key pair, a secure hash table or a set of algorithms personalized to each deployment. The key pair could then be used such that the controller maintains the public key, the new device maintains the private key and thus a challenge-response can be uniquely protected between those two devices. A hash table is advantageous when a given device has very restricted resources and cannot maintain complex encryption processes. In these embodiments, a custom hash table is generated based on a range of options from sensor input matching to packet pointer value lookups to any other communication attribute available on the new device 202. In these embodiments, the unique hash table provides both protection and, since there is only one sending device 202, authentication of the source of a communication stream. The custom algorithms provide a sophisticated challenge-response paradigm wherein connecter patterns can be utilized to optionally connect input and outputs from synchronous algorithm sets. Therefore even if an initial challenge value is captured, the resultant response would not be able to be calculated outside of the two authenticating devices.

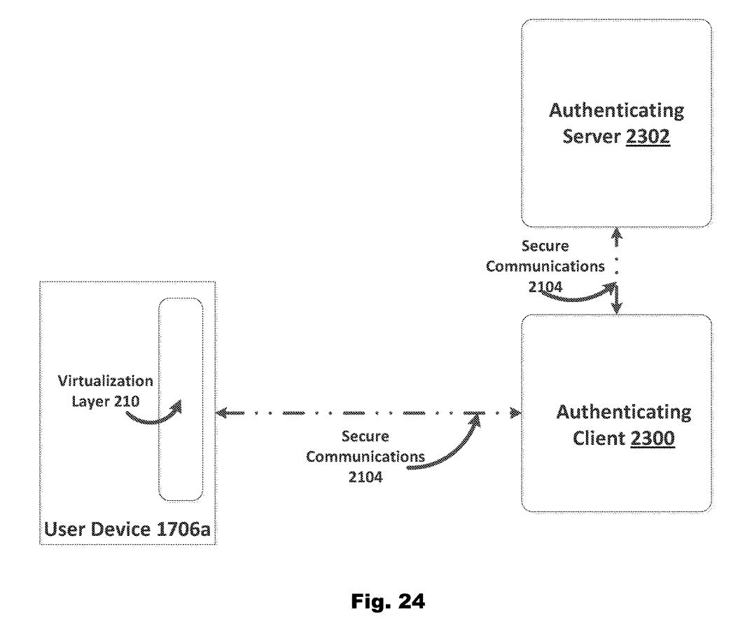

After device authentication is complete, the next step is to present to the user 1702 of the device the ability to provide user-level authentication information, which is detailed in FIGS. 21 and 24. In traditional RADIUS/DIAMETER terminology, an authenticating client 2300 is an endpoint on a network to which unknown users can make authentication requests. In these paradigms, an authenticating client 2300 queries the authenticating server 2302 and obtains a challenge from the authenticating server 2302, which is then passed to the device 202a. While the most common format of such a challenge is a username and password request, there are other options. Some systems rely on MAC addresses, some rely only on a password, where others require username, password and security questions. Some authenticating servers 2302 will utilize a range of challenge responses that may extend past the current device 202a. For example, many banks may require a second challenge be completed by texting a secret code to a user's mobile device. During this phase of authentication all of these options can be supported.

In order to support communications control, however, standard authentication is often insufficient because of a gap between where and with whom communications are occurring. Devices 202 are actually performing communications that support users 1702 who are typically exchanging data. By ignoring the device 202, differential communications options are not enable based on location and/or device characteristics. By failing to include users 1702, a given device can provide open access to all potential users on that device despite a need for isolated and/or varying levels of communications security.

While some embodiments require interaction with an authenticating server 2302 that handles communications control, others rely on a separate communications authentication step. This separate, but related, communications authentication step which might be subsumed in the authenticating server 2302 processing and may occur prior to user authentication. As one example, a given network might not allow any mobile devices and, once identified, a given device might be rejected before any user authentication can occur. In a situation where a user 1702 and/or device 202 fails authentication, the downloaded virtual communications kernel may be optionally disabled or automatically uninstall. In some embodiments, if a user device 1706 is active for more than a set amount of time without connecting to an identified network, the virtual communications kernel 210 might disable or uninstall itself. Once an accept response has been obtained from all systems responsible for authentication, the device 202a becomes a user device 1706a as shown in FIG. 21.

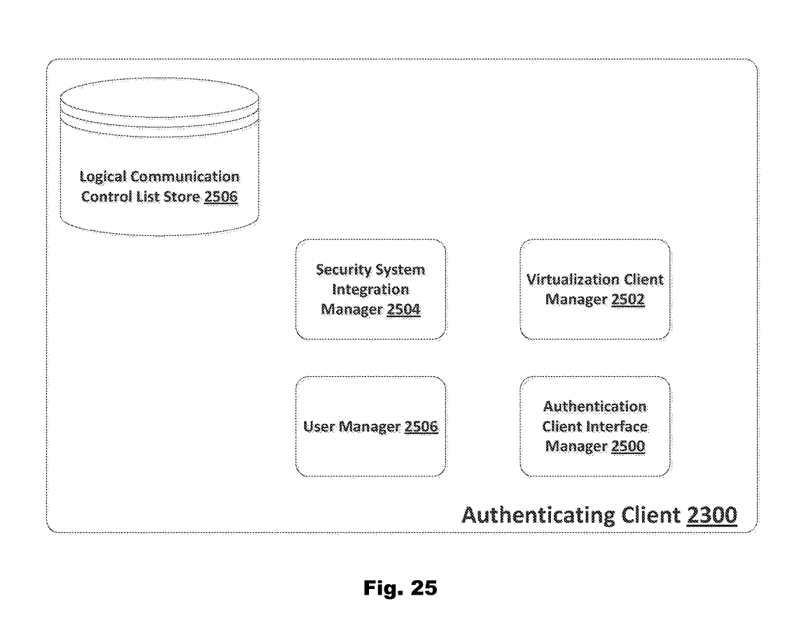

Referring now to FIG. 25, the authenticating client 2300 is an exemplary logical construct that can be implemented as one application on one device 202, as multiple services on one device, across numerous devices 202 as a variable set of services, and so forth. Additionally, the authenticating client 2300 may include a logical communication control list 2600 store 2506 (e.g., a SQL/NoSQL data store or as in memory cached set of values). An authentication client interface manager 2500 can handle user interactions, maintain state as needed and orchestrate the above-described authentication process as needed. A virtualization client manager 2502 may control the deployment and monitoring of virtualized clients 2100. The virtualized client manager 2502 may generate new virtualized clients 2100 in cases where the session key in embedded, or manage entries in a data store where sent GUID values result in subsequently transmitted session keys. The virtualized client manager 2502 may also load balance installer requests in cases where user demand overwhelms a single location or client 2300. A user manager 2506 can control the actual communications control list 2600 if one is sent separately for communications as shown in FIG. 26.

A communication control list 2600 can either be included as part of a general access control list or stored/managed separately. In those embodiments where the list 2600 is stored separately, it can be sent to the user device 1706 or it can be retained on the authenticating client 2100. In FIG. 26, an example is provided that shows how embodiments might separate initiation from responding based on device, protocols, times, and the like. General restrictions for an entire user device 1706 are not shown, although these may be either be stored locally or sent to the user device 1706. In cases where the control list 2600 is sent to the user device 1706, there is a speed advantage and a proactive (i.e. before the operating system is aware of an interaction) ability to stop unwanted communications. For embodiments that maintain these control options on the authenticating client 2300, a slower response time may result, but an increase in control access list 2600 security is present. In terms of security, in embodiments where the control list 2600 and/or the device control data is sent to the user device 1706, some embodiments will encrypt the content both in disk and in memory, while others will do one or the other, and yet others will provide no encryption and/or not store the list 2600 on the device.

The user manager 2502 also creates new user entries in either the logical communication control list store 2506 or through a security system integration manager 2504. In embodiments where the communication control list 2600 information is stored separately from the access control list data found in an LDAP system, the user manager 2502 creates entries, as needed, in the logical communications control list store 2506. The logical communications control list store 2506 may be a data repository existing in memory, on a disk, or some other storage variation. The store 2506 may be comprised of a local version and a remote version for distributed storage purposes. In other embodiments, a separate function or system handles all control list requests and processes create, read, update, and delete access control list 2600 requests based on a series of rules. These same types of rules may be included on a resident authenticating client 2300 and/or the user manager 2506, in the event that it is implemented as a separate process. Rules may include such things as total number of devices allowed per user, user type, or group. Other rules, applied at various levels, may include such things as type or types of devices allowed, location, operating systems, and even number of active devices per user.

Regardless of whether rules are stored in the main LDAP system or separately in the authenticating client 2300, these rules can be used to determine whether an authenticated device 202 belongs or can belong to a given user 1702. If a device 202 has already been registered to a different user, then the question of whether a given device 202 can be multi-tenanted can be addressed through attributes applied to either the device or a device group. User devices 1706 may have additional restrictions that enable or disable simultaneous active users 1704 on a given device 202. Such a rule, as one example, could lock down all communications by other active users on a device when a logged-in executive initiates a multimedia web conference. Thus these rules can be applied both to the authentication process of whether a given device 202 can be applied to a user 1704, the determination of behavior of the user device 1706, as well as the effect of that user device 1706 on other active users 1704. Other embodiments might act even further to isolate a given active user device 1706 for a range of reasons. As one example, a given active user device 1706 might attempt to initiate illicit communications and thus be identified as potentially hosting malware. In response, all other active user devices 1706 on the same network as the target active user device 1706 might either be logged off, prevented from communicating with the target active user device 1706, forced to use a separate subnet or distinct protocols, some combination of these options and so forth. Given the connected nature of user devices 1706 to authenticating clients 2300/peers 2000, the clients and peers might control this response. In other embodiments, a separate system such as an administrative channel might handle these responses or even embedded code, in response to different types of communications, might elicit this response both for the current device 202 as well as all other connected devices 202 or 1706.

The security system integration manager 2504 integrates access control information in embodiments where the access control data is not sent directly from the authenticating server 2302. Whereas typical access control protocols might base all authorization on responses from the authenticating server 2302 through the authenticating client 2300 to the user device 1706, communications authorization may not always be included in that path in certain embodiments. In these cases, the security system integration manager 2504 obtains the authentication and/or authorization responses from the authenticating server 2302 and uses that information to look up values for the active user 1704. These lookups may be based on the logical communication control list store 2506 or the queries might pull directly from the backend LDAP system. In these latter embodiments, the user manager 1704 may send CRUD requests for communication control list 2600 entries that the security system integration manager 2504 then processes. Processing may be performed within the authenticating client 2300, translated into backend LDAP requests, or some combination thereof.

At this point the device 202 has been authenticated, the user 1702 has been authenticated, and together they form the active user device 1706. This active user device 1706 has received from the authenticating client 2300 any local control lists required to operate and the user device 1706 is ready for subsequent communications with other active user devices 1706. The next step is to initiate a session. As a preliminary matter, it is noted that heartbeat processing may be utilized in some embodiments, which is described below.

For explanatory purposes, the present disclosure refers to three main types of data: device, dynamic, and security. Device data consists of all BIOS and other data sufficient to uniquely identify a given device such as manufacturing ID and unique hardware identifiers. Device data may be, for example, the BIOS serial number and device MAC address. Newer devices typically use EFI (Extensible Firmware Interface) instead of BIOS; however “BIOS” terminology is used as an encapsulating term. One challenge with the BIOS serial number is that duplicate values can occur, for example blank or sequential (i.e. 123456) values, and those values might be filtered out or ignored to ensure device uniqueness. Any values not easily filtered may be appended together for that device 202 in certain embodiments. The device data may also contain the type of device (mobile, desktop, tablet) and operating system. Further, during a setup or optional installation process, values may be calculated and placed in a secure location (such as a chips Secure Memory) and utilized as part of the device data. Finally, in certain embodiments, the BIOS data can be separately hashed on both the authenticating client 2300 and device 202 sides using a device timestamp as SALT, the resulting value of which can be referred to as a BIOS hash.

Dynamic data includes any data that can be used to identify the location of a device. For mobile devices, this data may be GPS data in addition, or instead of, an IP address. While dynamic data is mainly used for location-based rules and for enforcing communication authorization rules, the dynamic data may be used for other purposes as well. One such other purpose is that the device timestamp may be used for synchronizing packet communications between two devices. In these embodiments, after a session has been initiated, a first user device 1706a might send to a second user device 1706b its current timestamp. The second user device 1706b can look at this timestamp, along with the time the packet left the first user device 1706a, and then match those values to its own timestamp. Then the second user device 1706b can store the difference in timestamp values and use that variance to synchronize timestamp values in the packet headers for the two devices. This process can either be repeated or done as an option of the first user device 1706a over the second user device 1706b. Synchronized timestamps may be required for many types of security approaches including, as one example, time-series algorithms which often work in the picosecond range.

It should be noted that where a process, data exchange, communication, and so forth are described with respect to a specific user device 1706, those processes could be similarly applied for all constructs on a given device 202, for a given user 1706, or some other first class authentication member. In this regard, the approach of using groups can be utilized to mitigate processing requirements. As one example, two devices 202 exchanging timestamps can share timestamp differential values across user devices 1706. Depending on the embodiment, user devices 1706 might also use the same modulation charts or different groups of users might share modulation approaches. As one example, all virtual machine application users (virtual users 1802), might utilize the same modulation charts applied, as a semantic definition, to all virtual machines.

Security data includes data related to the generation and exchange of keys between devices 202 and authenticating clients 2300. In some embodiments, a unique network-level key is obtained for use by all of its authenticating clients 2300. Other embodiments might obtain a distinct network key for each authenticating client 2300. These network keys comprise security data and might be ties to a certificate authority such as Verisign or Thawte and used to sign data flowing to the device 202.

In addition, each time an active user device 1706 reconnects to an authenticating client 2300, the device 202 or user device 1706 may generate a new public/private key combination and, in some further embodiments, a unique timestamp is used in that key generation. In these embodiments, the active user device 1706 generates a new picosecond-level timestamp that may be optionally encrypted with the network public key and sent along with the new device 202, or user device 1706, public key. Additional embodiments might further encrypt the entire message with the network public key to better secure transmission. It should be noted that, as opposed to time synchronization efforts, this timestamp could be completely artificial and, in fact, used for increased security. In embodiments where every device 202 in a given system is running a virtual communications kernel 210, the timestamp used in the headers of packets can be completely artificial and, in fact, be any date at all. The benefit of using this technique is that operating system layers, such as network or transport layer, cannot generate these types of artificial timestamps. This approach therefore ensures that a given packet was sent from a virtual communications kernel 210 and, further, it gives rise to timestamp modulation control using modulation chart techniques described previously. To this latter point, some embodiments might generate artificial timestamps based on device information, communication characteristics and so forth and utilize the timestamp as another type of packet verification and/or signature option.

Referring to data grouping, dynamic data requires a connection between an authenticating client 2300 and the active user device 1706. The specific authenticating client 2300 might vary as a device changes location, or due to network loads, but the connection is still required for these embodiments. In these cases, a finite amount of time can be defined by which a given active user device 1706 needs to have sent an authenticating client 2300 an update of its dynamic data. In some embodiments, a message may need to be received by the active user device 1706 from the authenticating client 2300 on a regular basis in order to remain authenticated. Other embodiments may require updates to be received from the active user device 1706 on the authenticating client 2300 at some interval or the device 202 will have to go through re-authentication. In this latter case, the virtual communications kernel 210 initiates the re-authentication process and begins where a session key with the authenticating client 2300 is required. Maintaining the dynamic data is needed by the device 202 for session initiation as described for certain embodiments.

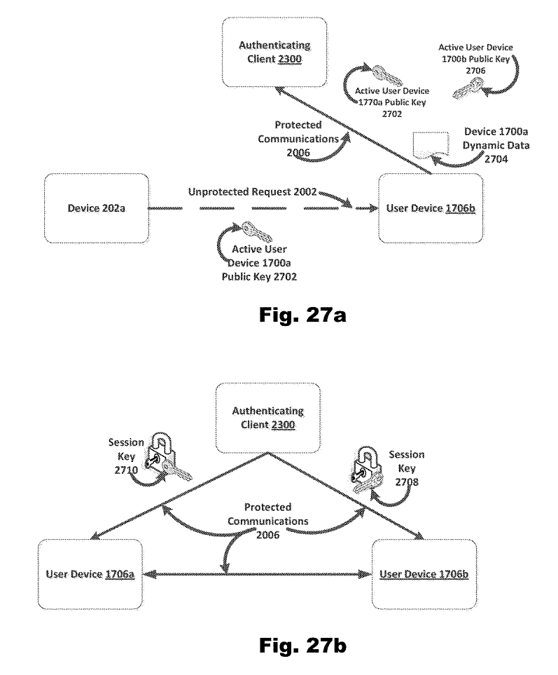

Turning now to FIGS. 27a and 27b, examples of out-of-band session initiation are shown in accordance with various embodiments. In these examples, two devices 202 are attempting to communicate with one another or a device 202a is attempting to communicate with a user device 1706b. Going one step further, both devices 202 could support user devices 1706 which has further advantages as explained later. For now, the only difference between session initiation between two devices 202 and two user devices 1706 is the required authentication process that has to occur between two devices 202 and an authentication client 2300 prior to session initiation.

In FIG. 27a, device 202a sends its public active user device key 2702 to user device 1706b. Depending on the optional utilization of modulation charts, this initial request might be encrypted in a manner known to user device 1706b even though this is a first time communication (device 202a would also need to be user device 1706a). This pre-known encryption might occur within a communications control list 2600 wherein different device types have different security feature sets. Depending on the embodiment, a device 202b might iterate through the various active users 1704b and look for an active user device 1706b that is allowed to communicate with the incoming device 202a. In the embodiments utilizing the communications control list 2600, the device 202b, in finding a match, will also know the type of device and be able to access any optional secondary challenge-responses for that type of device 202a.

In many embodiments, a further restriction is applied that only one active user device 1706b can be an end user, which represents an actual person. In these embodiments, the other active users 1704b may represent a range of processes and/or services but none might be allowed to accept user input, for example. When comparing active user devices 1704b, the sending device 202a (or user device 1706a) can optionally send a request for the type of interaction, specific application, or the incoming protocol/port can be utilized for such a determination. The device 202b may then iterate through potential matches based on the packet header values, internal payload encryption and so forth sent from device 202a, and can begin with the active user device 1706b that represents the end user. Certain embodiments might only allow matches on the end user and reject all others. Finally, some embodiments may prioritize active user devices 1706b to prevent a plurality of potential matches. In the cases where a device 202b performs local matching, the device 202b may then inspect its rules to determine if the incoming communication is allowed. If the rules are maintained on the authenticating client 2300, then these processes may occur based on communications between the authenticating client 2300 and the device 202b.

In the case where rules are enforced locally (i.e., at the device 202b or user device 1706b rather than the authenticating client 2300), when the user device 1706b approves a communication the user device 1706b sends the matching active user device's 1706b public key 1706. In cases where the rules are enforced in the authenticating client 2300, the device 202b can either send a range of possibly matching active user device keys 2706 or a single active user device key 2706 with which the authenticating client 2300 can perform a lookup to obtain all other active user device keys 2706 for that device 202b from an optionally independent data store, service, process, system or similar option. In these cases, the incoming active user device key 2702, and any dynamic data 2704 obtained from the device 202a are sent from device 202b to the authenticating client 2300. In terms of dynamic data 2704, the device 202a either does not send specific additional information beyond what is contained in its packets, or it sends over additional parameters such as GPS location or source IP address. This latter set of optional data may be transmitted in an encrypted format that is not readable by device 202b, but only in a format that can be decrypted by the authenticating server 2300. Further the entire request from device 202a may be optionally signed by the device 202a and even encrypted using a network key controlled by the authenticating client 2300 in cases where the rules are enforced at the authenticating client 2300 or even device 202b through modulation charts or similar option described previously. In this latter embodiment, nothing unencrypted passes between two devices 202 including a public key.

Once the authenticating client 2300 receives the device keys 2702 and 2706 and optionally decrypts and processes any rules, dynamic data 2704 can be used to validate the device 202a based on data accessible to the authenticating client 2300. Since the communication arrives on a secure transmission from device 202b, the identity of the user device 1706b is already confirmed. Assuming the device 202a is matched and communication is authorized, the authenticating client 2300 may then generate a session key 2710 using an option such as Kerberos or its own internal key generation option to be sent to both user devices 1706. This session key 2710 may then be copied and encrypted with the active user device public key 2702 to produce a secure session key 2710 for user device 1706a and the session key 2710 can be encrypted with the user device 1706b active user device key 2706 to create a secured session key 2708 for user device 1706b. The authenticating client 2300 may then optionally sign the keys and transmit those keys separately to each user device 1700. Both keys might, instead, be sent to either user device 1706a or 1700b and the receiving user device 1706 might then send the session key 2710 to the other user device 1706. In these latter embodiments, the authenticating client 2300 might not encrypt the session key 2710 twice, or at all, and the receiving device may or may not encrypt the session key with its own or the other device's key prior to transmitting the key to the other device. In the first embodiment, each user device 1706, in turn, decrypts the received session key 2710 using its private key and then the user device 1706a and 1700b may start securing communications based on a shared session key 2710. Throughout the process shown in FIGS. 27a and 27b, there is no mandatory exchange of any inline, unprotected, security information between devices 202 or user devices 1706.

Referring back to the location of the virtual communications kernel 210, the process of FIGS. 27a and 27b can occur without operating system interference. The logical location of the virtual communications kernel 210 is important when considering a TCP handshake and its use in distributed denial of service (DDoS) attacks. Specifically, a TCP handshake involves a SYN packet being sent from one device 202 to another; a SYN ACK packet being sent in response; and then an ACK packet being sent from the first to the second device. All of these packets are exchanged before any higher-level information is exchanged between two devices 202. These handshake packets themselves are not typically problematic, but attacks such as DDoS leverage this process multiplied many times over to overwhelm a specific series of devices or services. Since, in accordance with various embodiments disclosed herein, the virtual communications kernel 210 sits below the TCP layer and given the single package nature of session initiation, the virtual communications kernel 210 provides an option to avoid such an issue. In certain embodiments, the initial SYN packet can be routed to a secondary device 202 in a load balancing paradigm. Since the communications control kernel 210 can control all standard fields in a packet, the communication, or hop, from the initial device 202 to the load-balancing device 202 can remain invisible to outside users. Further the communication control kernel 210 can modify the outgoing communication packet 302 such that the communications packet 302 appears to be coming from the initial device 202. In this manner, load-balancing efforts do not result in new targets for a given DDoS attack.

When considering the TCP handshake communication deficiencies discussed above, it should be noted how the use of the virtual communications kernel 210 in out-of-band session initiation can improve network performance. Instead of a minimum of 16 packets being exchanged in an out-of-band initiation effort that utilizes a TCP handshake, by using the virtual communications kernel 210, only 4 packets at a minimum are required. By using the virtual communications kernel 210 and optional modulation charts, even the initial request from device 202a to device 202b can be protected. To this latter point, a modulation chart might establish one or more expected types of encryption approaches that device 202a needs to use prior to sending out a request. Device 202b, using the same modulation chart—and this modulation chart can optionally be fulfilled using a range of options such as configuration files, embedded code, and so forth—will attempt to reverse the encryption approach process and, failing to do so, will result in an automatic rejection. This operation could be as simple as looking for a certain header value or as complex as a BPEL-like series of decryption steps. Even a simple header value might be the result of a complex operation such as a time-series calculation. Once the virtual communications kernel 210 is added in a session initiation process, a layered secured initiation process in enabled

In some embodiments, for example, the virtual communications kernel 210 transparently redirects a flood of incoming requests to other devices, which will be explained in further detail below. For now, it is noted that the virtual communications kernel 210 can forward packets without a visible network hop, which may be the result of operating system restrictions, since it is unencumbered by such restrictions. Other embodiments establish rules that ignore a flood of incoming requests, for example where repetitive requests from an external device are ignored for a certain period of time. Since there is no handshake in the above-described session initiation process, any processing impact is nominal, and the traffic is significantly reduced and the number of devices required to impact a system are greatly increased.

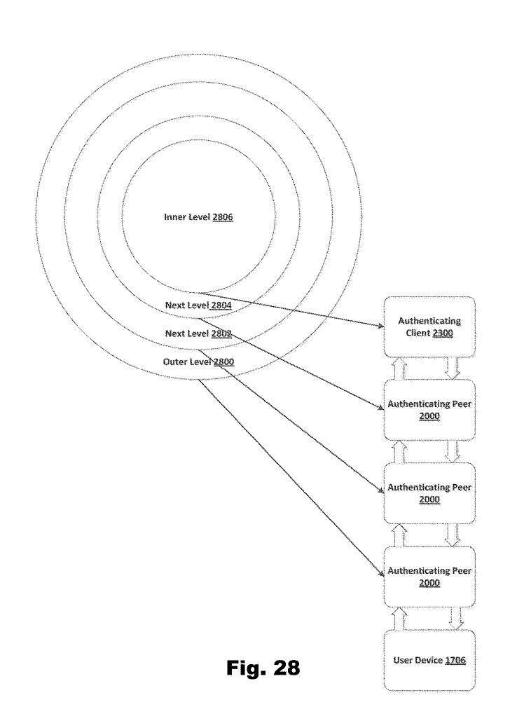

FIG. 28 illustrates a concept of a distributed authenticating client 2300, which leads to the ability to manage different levels of security using a distributed series of devices 202 and authenticating peers 2000. In the circles, which represent levels of security, the inner level 2806 secures the most sensitive information whereas the outer level 2800, sometimes referred to as the edge of a network 214, contains the least sensitive information and/or systems. These are logical constructs and not necessarily limited to a type of network 214, an active user device 1706 location, or other such features. While some embodiments might use such distinctions, the present disclosure relates to any delineation attributed to either a first class member or the interaction of two or more first class members. For example, an executive using a mobile device from a home network 214 might still be considered to be inner level 2806 for purposes of communications security, but an outer level 2800 device in terms of resource access.

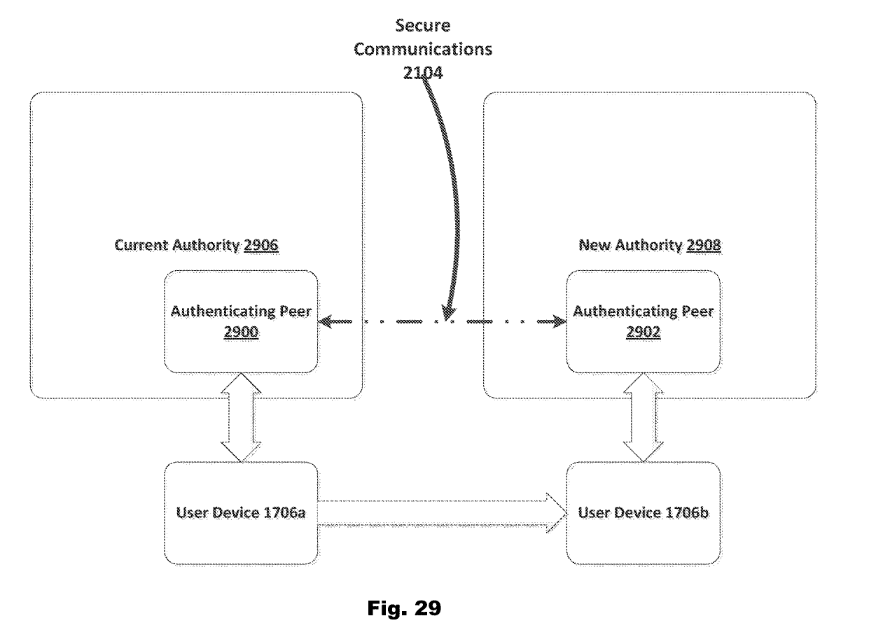

Utilizing the system in FIG. 28 can, in effect, restrict user device 1706 access to an outer level 2800 and push the required authentication to a lower level authenticating peer 2000. This latter component can then utilize an authenticating peer 2900 from the current authority 2906 connected to an authenticating peer 2902 located in the new authority 2908 as shown in FIG. 29. In this case, the two authenticating peers already have existing secure communications 2104 based on a session initiation with a trusted authenticating client 2300. Once connected, the two peers can readily hand authentication and authorization information off for devices crossing domain boundaries. For the user device 1706a, moving forward to or “becoming” 1700b as shown becomes a seamless transfer as all information is passed off proactively. These embodiments, where the appropriate authenticating peers 2000, 2900, 2902 transfer user device 1706 authentication and authorization information directly, are especially advantageous in mobile environments where longer connections to central networks 214 can result in latency issues.

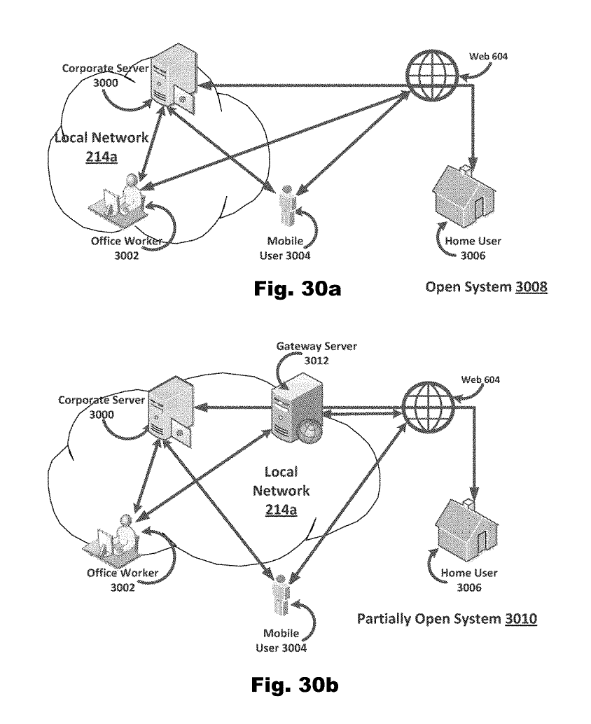

One of the largest security holes in modern networks 214 is the ability for users 1702 to access unprotected, unmonitored resources such as those located on the web 604. As shown in FIG. 30a, these systems are often referred to as open systems 3008 where a device has access to both secure resources, such as a corporate server 3000 and unsecured resources such as on the web 604. In these cases, the device 202 acts as a bridge that enables resources to be transferred between secure and unsecure locations and that bridge is often a conduit for malicious activity.

FIG. 30b shows a local network 214a, which demonstrates an attempt to counter some of these gaps in security by moving beyond the fully open systems 3008 into a partially open system 3010 that utilizes a gateway server 3012 to monitor traffic. Even supposing the gateway server 2012 is able to properly monitor traffic, however, there are two common use cases that break this type of system. First, as denoted by the mobile user 3004 example, many local networks 214a are supporting BYOD (bring your own device) implementations, where users can bring any device they desire into the local network 214a. Very often, users will connect via their phone carrier's signal and, even more concerning, there is little to no ability for modern LDAP to enforce any level of differential security on these devices. The second use case is that of a home user 3006 connecting through an option such as a virtual private network (VPN). This issue provides a twofold challenge with the first being that a user can run a VPN application while simultaneously running an unsecured application such as a web browser. Again, this deficiency results in a bridge through which intruders can gain remote access to a local network 214a. The second issue is that a user 1702 can turn off VPN protection. Thus, even if a VPN implementation somehow prevented other applications from running, the user can simply shut down the VPN, turn on an insecure application and possibly download malicious code. The next time the VPN is turned on, that code gains access to the secured local network 214a directly through the VPN.

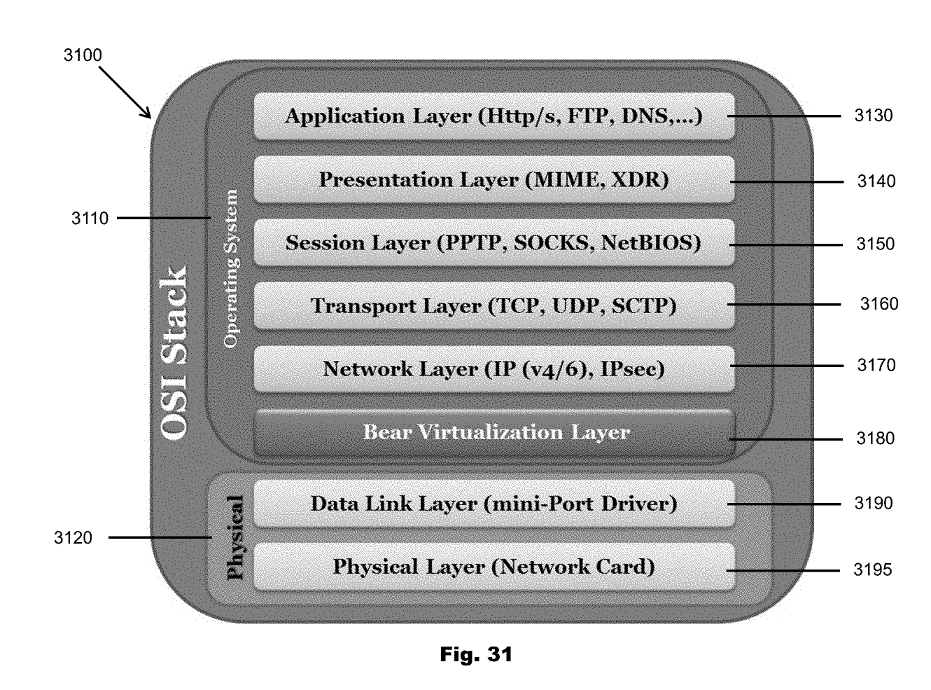

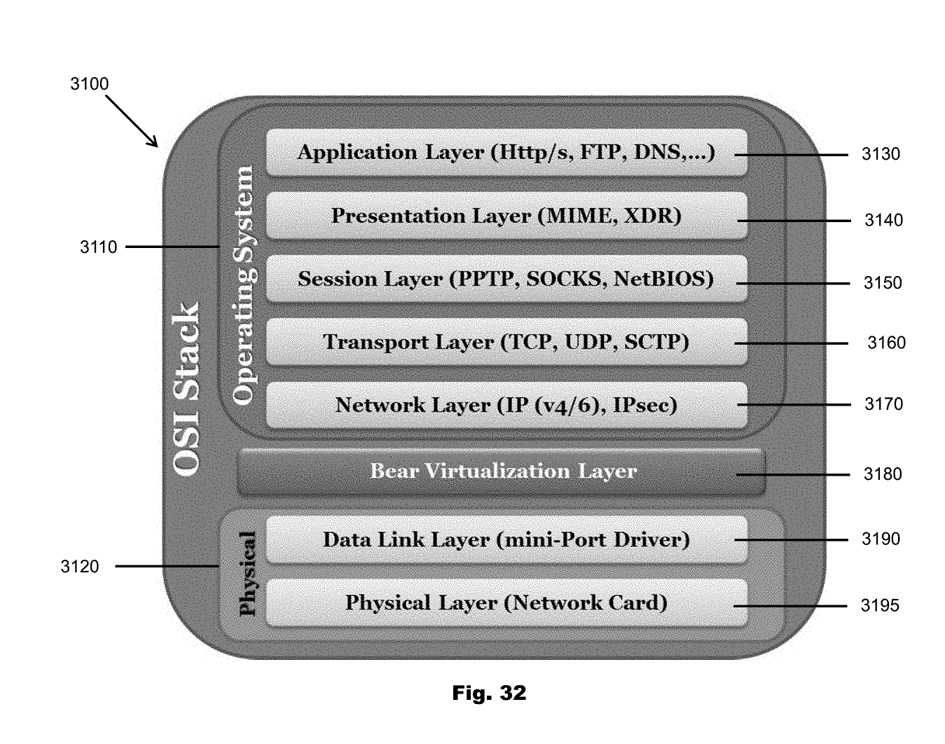

Referring now to FIGS. 31-40, embodiments for protecting and enhancing enterprise communications are illustrated. As shown in FIG. 31, enterprise communications may be enhanced and protected by incorporating a new layer, preferably between the operating system 3110 and the underlying network hardware 3120, which is referred to in embodiments as the virtualization layer 3180. The virtualization layer 3180 preferably resides below all other layers of the operating system 3110, including the Network or IP layer 3170, the Transport layer 3160, the Session layer 3150, the Presentation layer 3140 and the Application layer 3130. The stack 3100 in FIG. 31 also demonstrates a conceptualization of the virtualization layer 3180 in which the virtualization layer 3180 is initiated prior to the upper level layers 3130, 3140, 3150, 3160, 3170. These types of initializations are often found in pre-boot loading techniques, which will be understood by one skilled in the art. Once the virtualization layer 3180 is running, with its own resources separate and distinct from the upper level layers, the upper level layers may be launched. This enables the virtualization layer 3180 to act as a barrier between the upper level layers and the network. Referring to FIG. 32, virtualization layer 3180 may alternatively reside completely outside the operating system 3110, enabling operations such as OS checksum and enhanced configuration options.

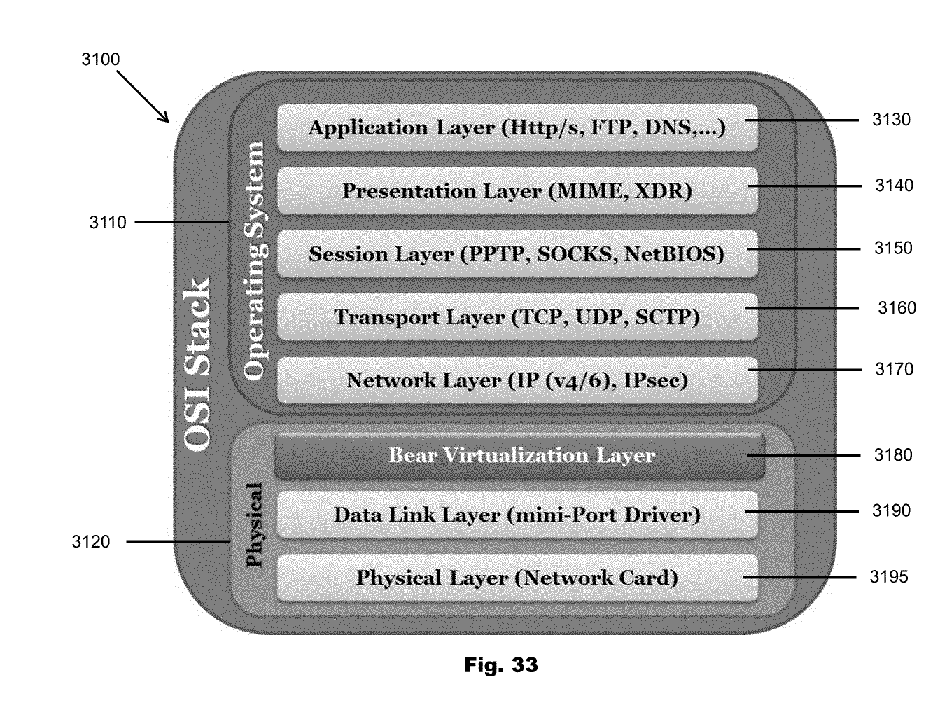

Referring now to FIG. 33, the virtualization layer 3180 may be part of the physical layer 3120. For example, the virtualization layer 3180 may reside on a circuit board or embedded in other hardware, which in turn allows for greater performance enhancement in regard to the operation of the virtualization layer 3180. In other embodiments, all external communications may be configured to pass through a virtualization gateway. This includes both communications intended for external locations, such as the web, and in some embodiments may further include all communications from devices not physically on the local network, but that attempt to access resources on that local network.

The flexibility of locating the virtualization layer 3180 provides several benefits. First, the variable location makes the virtualization layer 3180 completely transparent. Thus, the virtualization layer 3180 may handle communications independent from the operating system 3110, obscure encryption from host operating systems, and decrypt communications independent of the type of communication received. Second, locating the virtualization layer 3180 independent of the operating system 3110 makes it invisible the operating system 3110, networks associated with the system, and any administrative tools, which permits security protocols to run below all communication layers and irrespective of the version of IP associated with the system (e.g., IPv4, IPv6 and others). Third, the virtualization layer 3180 is isolated from applications, and further isolates those applications (and associated operating systems) from affiliated networks. Fourth, the virtualization layer 3180 may be configured to run on original ports, as does not require VPN ports or other specialized configuration in order to communicate with the system. And fifth, the applications and systems are unaware of the virtualization layer 3180, and are unimpeded by this additional barrier.

The variable location of the virtualization layer 3180 enables multiple technologies to be implemented, such as the packet-level encryption described above, without intruding on the operating system and related applications. Other technologies, such as transparent proxy usage and counter intrusion, may be applied as well. Further, the virtualization layer 3180 provides an open platform that may operate with a variety of different encryption protocols, giving users greater flexibility with respect to security options. As an independent layer from the operating system, the virtualization layer 3180 may be configured to always be running, unlike VPN and other models that a user can deactivate when using a device for personal use. The virtualization layer 3180 is preferably invisible to and cannot be disabled by a user, and may be configured to operate in conjunction with any operating system 3110.

According to embodiments, the systems and methods described herein may further comprise an optional communications control list (CCL), such as the type described above in relation to FIG. 26. In embodiments, the CCL organizes communications by device type or by each unique device within a local system. The CCL may further establish the different types of communications allowed (i.e., WiFi, Bluetooth, Ethernet, OTA and others) and serve to protect enterprise communications from malware, eavesdropping and breach of data protection policies.

In embodiments, the CCL may optionally comprise initiation rules for each device associated with the network, and may further dictate the specific encryption algorithm to apply in communications received or sent by a device. The CCL may also be configured to identify or provide the specific filters to apply, including by way of example but not limitation, the total amount of data allowed, the types or formats of data packets transmitted, timing, throughput, and other packet-level filters.

In a preferred embodiment, a local domain controller (LDC) maintains a registry of devices associated with a network, and may send updates to the CCL when a device is added or modified to maintain the integrity of the system. For example, device public keys maintained on the LDC registry may be periodically provided to the CCL or as events occur (such as a change to a device).

The systems and methods described herein preferably comprise an open encryption platform. This encryption platform may be configured to run triple DES and AES 256-bit encryption, including on the same communication channel, and without loss of speed or throughput. The encryption platform may be configured to run over wired, wireless, open Internet, Intranet or Extranet and over broadband-based communication platforms without sacrificing any of the features described above. For example, the encryption platform may be applied to multimedia applications, Skype-directed communications, Google Hangout sessions, as well as Facebook and other messaging services with complete transparency to the user of the application.

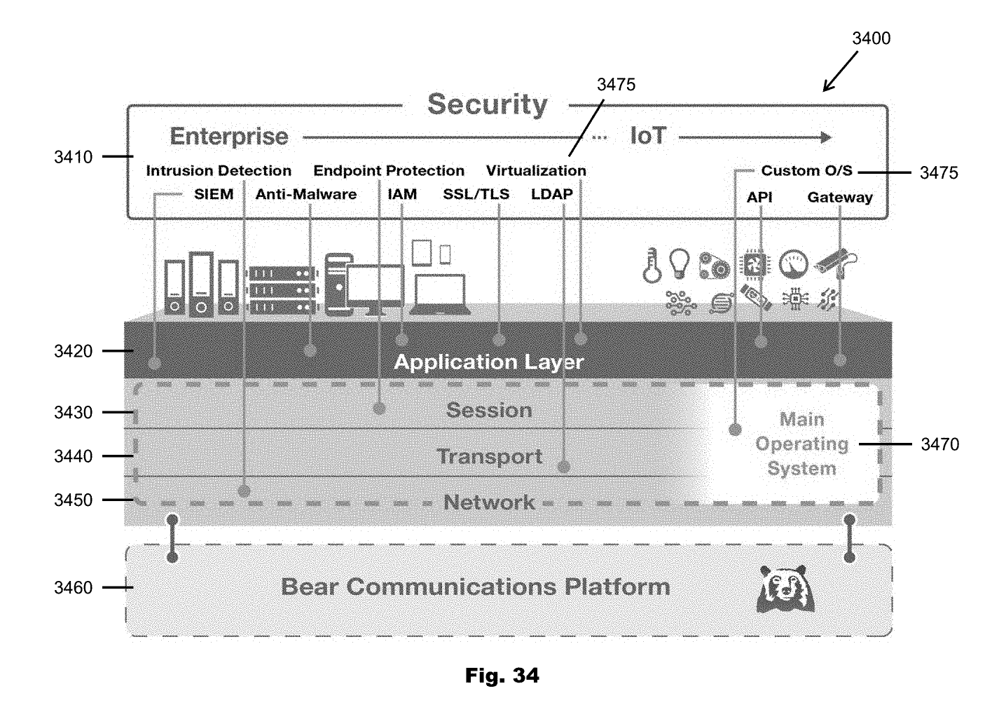

Referring now to FIG. 34, an enterprise-wide security platform 3400 and application layer 3420 according to an embodiment of the present disclosure is depicted. The platform 3400, in a preferred embodiment, extends across the enterprise 3410 and any devices that are associated therewith, including IoT devices. The platform preferably comprises an application layer 3420, which may comprise anti-malware, IAM, SSL/TLS, and STEM applications, as well as one or more APIs and gateways. The application layer 3420 may also comprise the virtualization layer 3180 described above in relation to FIGS. 31-33. The enterprise security platform 3400 may also host intrusion detection, endpoint protection and LDAP, as well as standard O/S 3470 or customized O/S 3475. Underlying the application 3420, session 3430, transport 3440 and network layers 3450 is a communications platform 3460 as shown in FIG. 34. This communications platform 3460 may further comprise the encryption platform described above.

In embodiments, the encryption platform may further comprise an Extensible Authentication Protocol (EAP) for accommodating remote and roaming mobile device uses. The EAP provides the core intra-network trust paradigm while the encryption platform provides the necessary encryption to account for remote authority access. The system may also comprise the ability to switch networks for more trusted communications. This switch may occur from the end user device, whereby the device is switched to the next strongest available network if the current network stops responding or falls below bandwidth parameters. In this scenario, only actual messages to or from the home authority would accept the foreign network as a trusted network. Alternatively, the switch may be initiated from the foreign network, where the destination IP address is used to lookup trusted partners by domain. If identified, the message request is sent to the device's home authority and services are negotiated with the foreign network as needed.

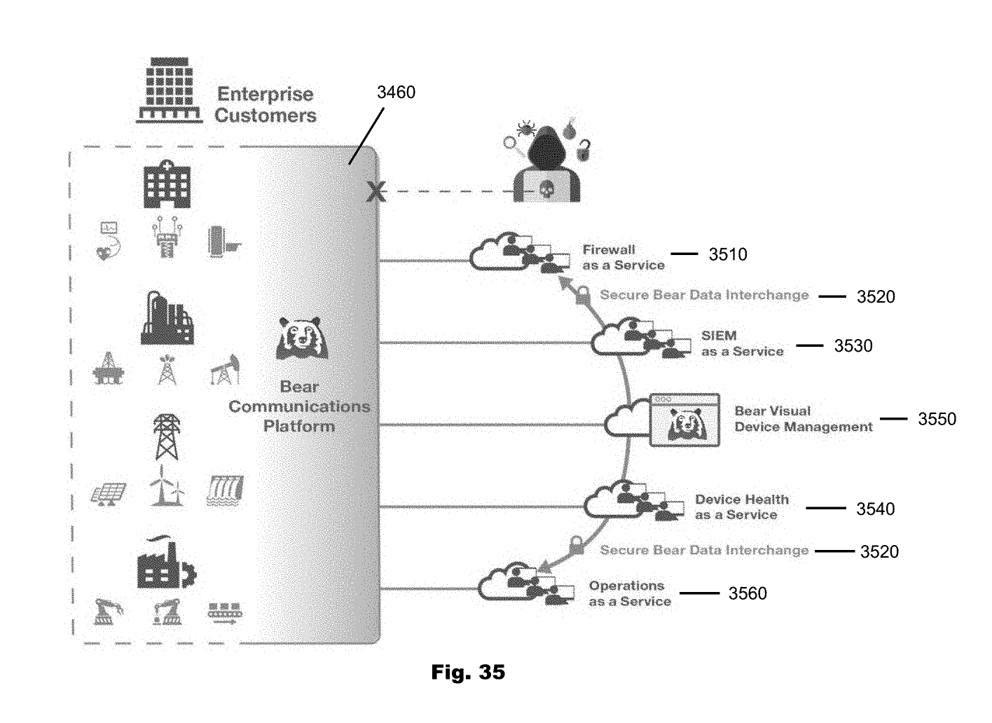

Referring now to FIG. 35, the communications and enterprise security platforms described in relation to FIG. 34 may be provided as a service. Here, the service preferably includes a Visual Device Management 3550 module to permit collaboration between security vendors of the enterprise, as well as specific security solutions employed directly by the enterprise. This collaboration is achieved in part by the implementation of a Secure Data Exchange 3520, which preferably extends to all vendor and non-vendor security services, including by way of example, firewall as a service 3510, STEM as a service 3530, device health as a service 3540 and operations as a service 3560. Using the Secure Data Exchange 3520, a STEM service 3530 provider may supply direct alerts to the Visual Device Management module 3550, which in turn may permit change requests and reconfigurations of the firewall services 3510. These and other types of collaborations may occur in real-time without business interruption.

By utilizing the Secure Data Exchange 3520, large enterprises and their providers may monitor and control security policies, and vendors, regardless of the policy or vendor in question. This in turn improves management and administration of the various security policies and frees up resources typically dedicated to integrating separate security practices across multiple vendors. In embodiments, vendors may further benefit from a distributed security workflow language built upon SDE and CSR to enable vendors to automate responses to known events and anomalies. In certain embodiments, the security platform 3400 may be transitioned to a cloud-based environment for greater data collection, evaluation and collaboration, or to facilitate enhanced analytics of enterprise data.

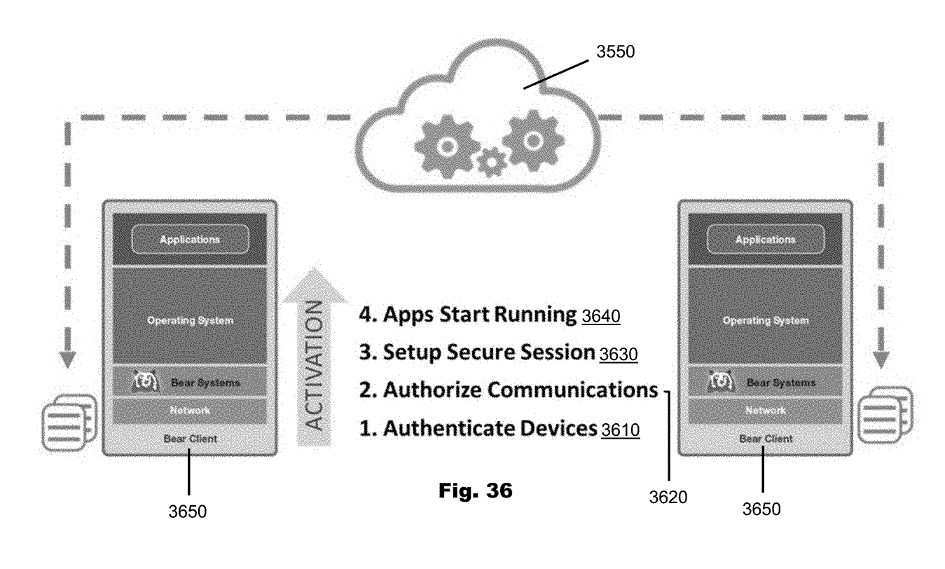

FIG. 36 depicts an activation sequence for applications according to an embodiment of the present disclosure. Here, the applications may reside on a construct based on the OSI stack described above in relation to any one of FIGS. 31-33. A layer of this construct logically resides between the operating system and the network, and may comprise a device identify, authentication, communication authorization, secure communication and configuration control modules, among other modules selected by the user. In a preferred embodiment, the security platform first authenticates devices on the network 3610. Next, the platform authorizes communications 3620 for any devices that have been authenticated. Then the platform may setup secure sessions 3630 for the authenticated devices authorized to communicate via the network. After each of these steps is performed, the applications on the devices may be scheduled to run 3640. Variations on the sequence of these steps is considered within the scope of the present disclosure.

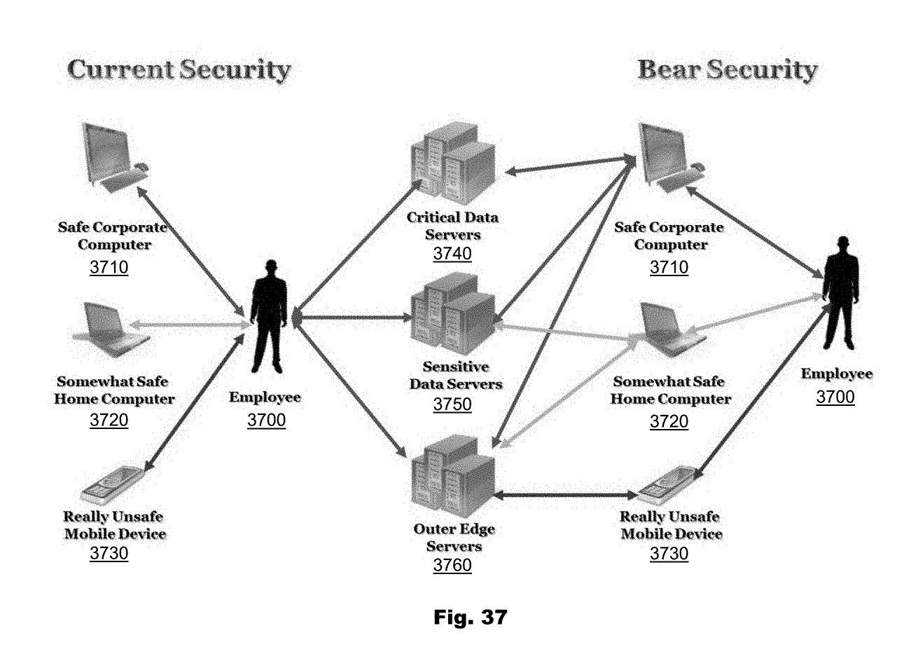

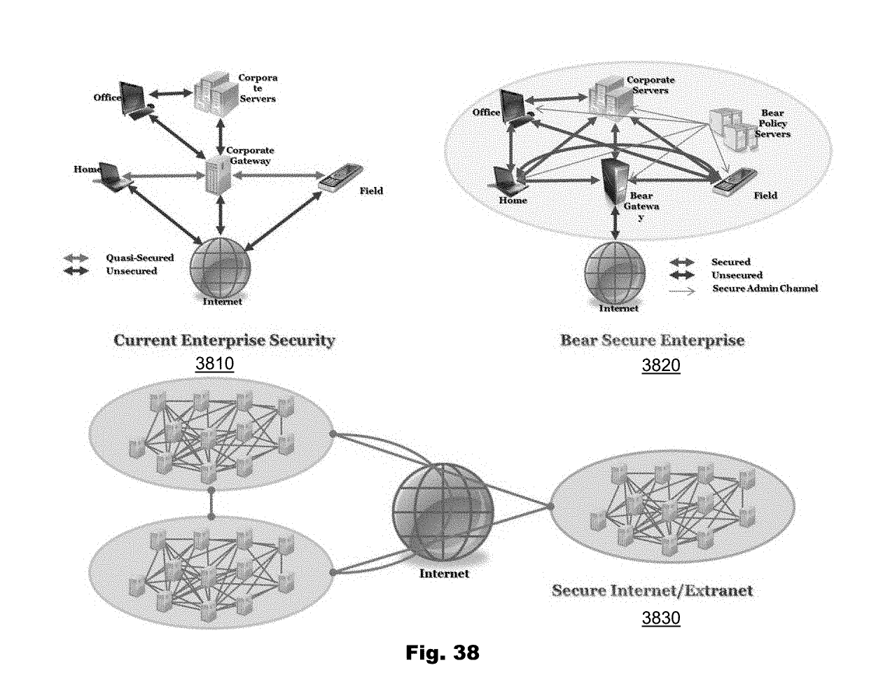

Compared to current security platforms, the platform of FIG. 34 is greatly enhanced. For example, as shown in FIG. 37, an employee or user associated with an enterprise 3700 may no longer be a conduit for unsecure devices (and applications residing thereon) and the enterprises' critical and/or sensitive data servers. In addition, all enforcement polices occur in a peer-based environment between any two devices, enabling the security platform to seamlessly scale as additional devices are associated with the enterprise and its employees. FIG. 38 is another diagram comparing current security platforms to the security platform described herein, further demonstrating the enhanced security between office and home devices and the enterprises' corporate servers.

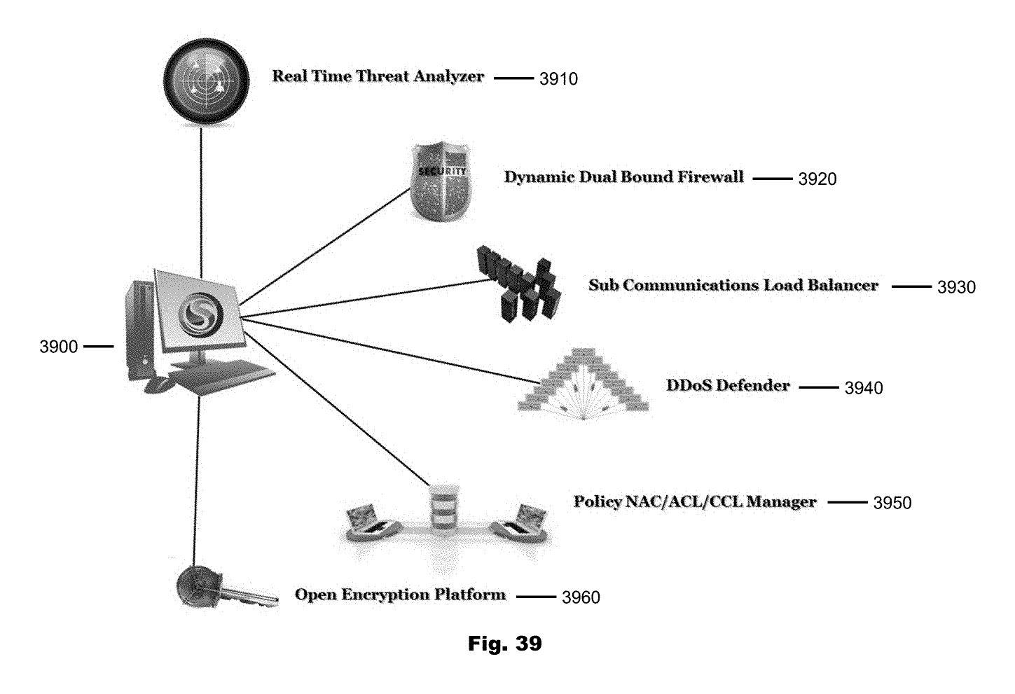

Various additions to the security platform may be provided, including those depicted in FIG. 39, such as a real-time threat analyzer 3910, dynamic firewall 3920, load balancer 3930, DDoS Defender 3940, Policy Manager 3950 and open encryption 3960 modules. Other optional modules may be incorporated without impacting the security platform's functionality.

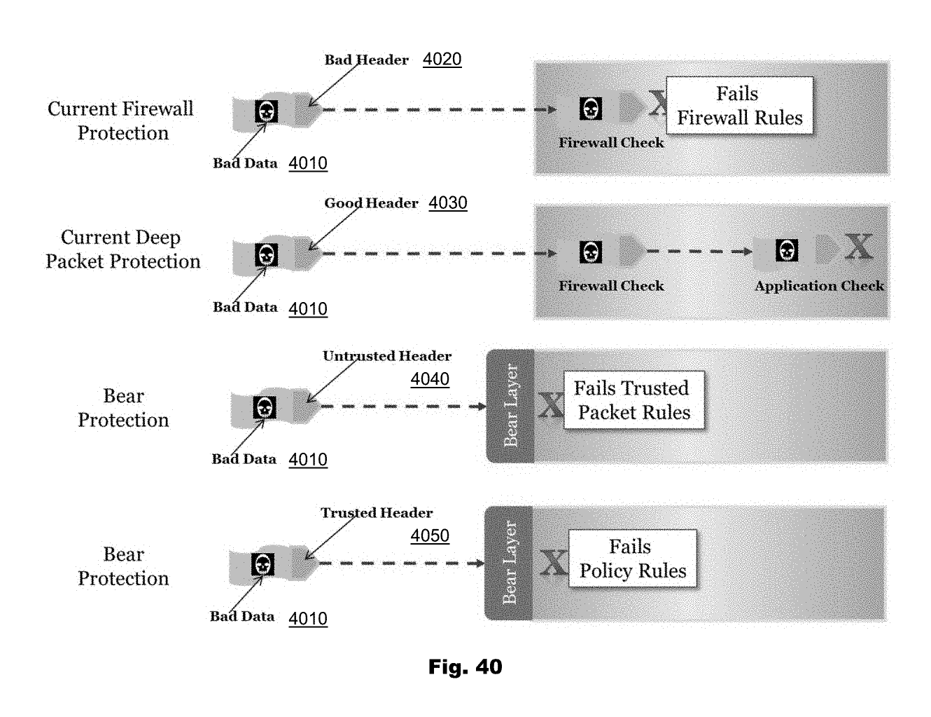

FIG. 40 demonstrates an additional benefit of the firewall and packet protection schema described herein. Under conventional firewall and packet protection schemes, bad data 4010 can still be allowed to pass the firewall if the header information 4030 is checked and confirmed to be good. Under the security platform described above, the bad data 4010 is blocked whether the header is trusted 4050 or untrusted 4040, due in part to the redundancy of applying trusted packet rules and independent policy rules for each data packet sent through the system.

While conventional enterprise communication platforms provide some degree of authentication and/or authorization, the systems and methods described herein may be configured to provide authentication, authorization and accounting (referred to herein as Triple A services). In addition, unlike common security protocols that rely on a combination of MD5 algorithms and IPSec, the present systems and methods may be distributed across device while permitting centralized authorization and accounting, while at the same time supporting any number of encryption protocols. The present disclosure therefore addresses the reality that users will log in and request authorization from a multitude of different devices, which are difficult to independently authenticate, and which may be circumvented by spoofing and other known malicious acts. The distributed nature of the present disclosure also addresses the distributed nature of enterprise data, and takes into account the use of multiple devices belonging to a single user.

The present disclosure achieves these objectives in part by maintaining parallel communications/data packets during active transmissions. The present systems and methods are configured to intercept and manipulate data at the packet level to enable accounting, including from both user-driven and service provider-driven accounting. The high level of distribution of these systems and methods is achieved through the use of a plurality of intermediate servers used for relaying accounting data during enterprise communications.

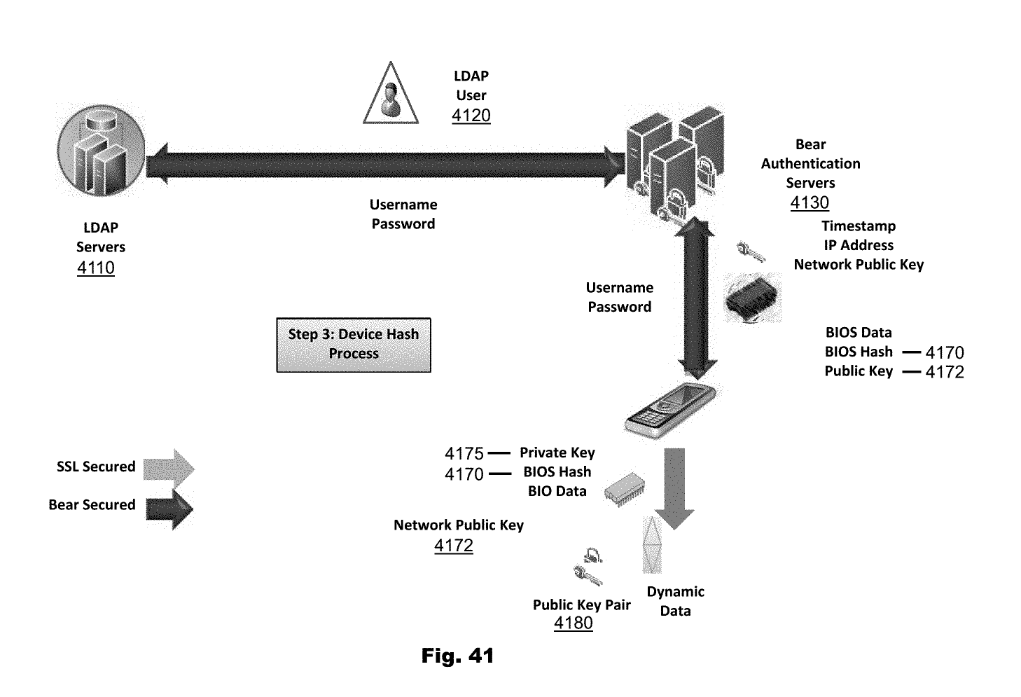

Referring now to FIG. 41, a diagram illustrates the various steps for authenticating a secure communication transmitted from a LDAP user 4120. Here, the LDAP user 4120 may access the system by providing a user name and password. This directs the LDAP user 4120 to one or more authentication servers 4130. The Authentication server(s) 4130 may then request a new device key 4160 to be generated based on this transmission, thereby initiating a key-based authentication approach of the type described generally above. In embodiments, the Authentication server(s) 4130 may utilize a network public key 4172 to creating a unique device key pair 4180 for a particular device. The Authentication server(s) 4130 preferably timestamp 4140 and record the IP address 4150, and may optionally create a device ID and a hash of the device ID 4170, which are then stored. The device ID may be encrypted using the unique device key 4180 described above. According to embodiments, the Authentication server(s) 4130 may authenticate the device by obtaining a private device key, decrypting a device ID string, recreating the device ID, then matching the values of the device ID. Then the network public key 4172 and private key may generate a key pair 4172 for the device, as shown in FIG. 41. Finally, in certain embodiments, BIOS data can be separately hashed using a device timestamp, the resulting value of which can be referred to as a BIOS hash 4170.

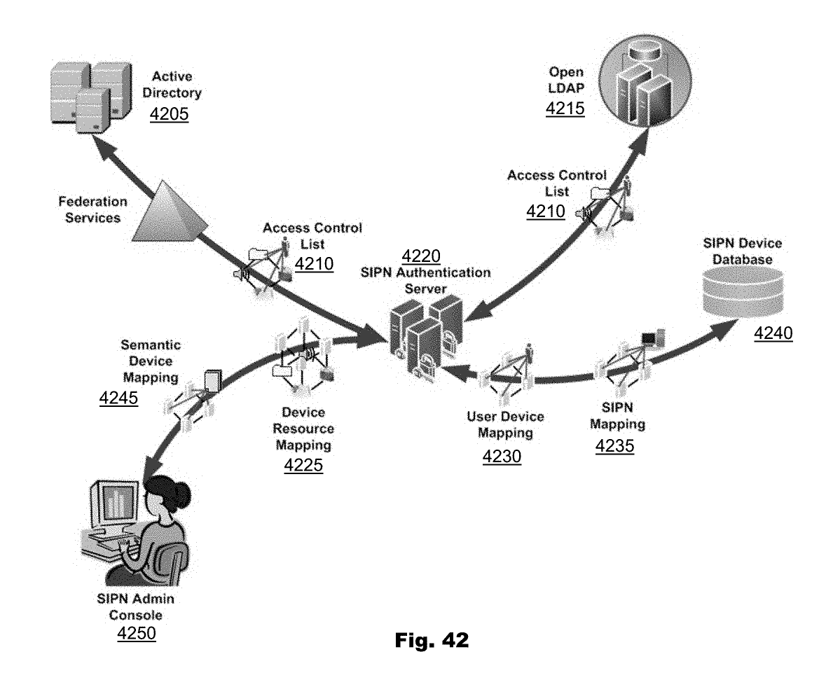

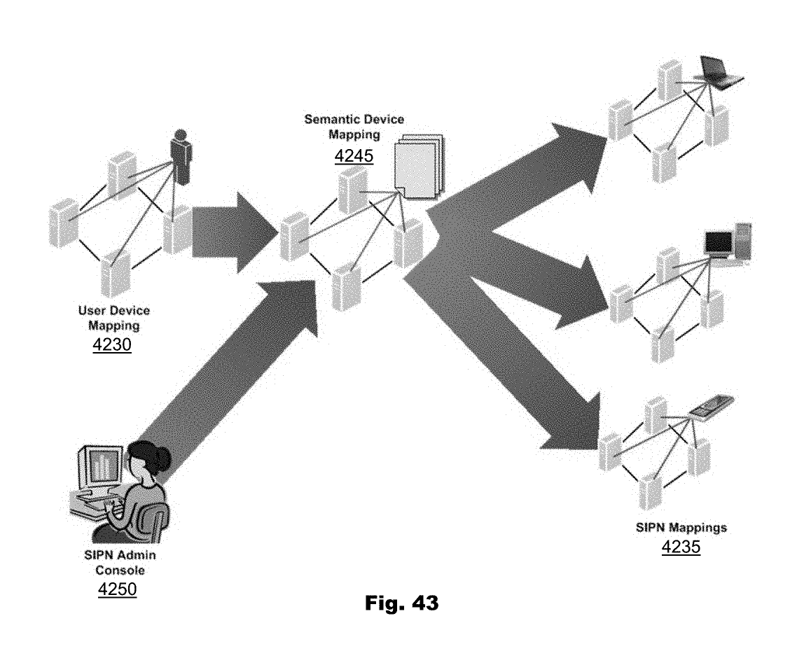

Referring now to FIG. 42, various mappings according to embodiments of the present disclosure are depicted. As also described in relation to FIG. 41, one or more LDAP servers 4215 may be mapped to the Authentication server(s) 4220, and may further comprise an access control list 4210. A device database 4240 may be mapped to the Authentication server(s) 4220 as well, and may comprise device mappings 4230. The system may also comprise a directory 4205 and administration console 4250, which may comprise the ability to semantically map devices 4245 by way of the Authentication server(s) 4220. Semantic device mappings 4245 may be relayed from user device mappings 4230 already established or newly created through the administration console 4250 to create new mappings 4235, as depicted in FIG. 43.

Utilizing the systems and methods described above, an administrator can divide and manage device by type, location, hierarchy or other device criteria. The system is preferably configured to translate those divisions into semantic definitions, which are then assigned according to security policies. In certain instances, the semantic definitions are additive, wherein other instances the semantic definitions may be afforded more or less weight. As one example, a specific desktop device may be configured to communicate with a particular server while a mobile device of the same type may not. Semantic definitions may also influence attributes, including both static attributes and dynamic attributes. Static attributes may include a user's position or the type of device of the user, which rarely change, while dynamic attributes may include IP address, endpoint network, NTP timestamp and other attributes that likely will change. Dynamic attributes may be configured to refresh out-of-band to prevent interruption of system resources.

The ability to utilize intermediary authenticating servers and/or peers in an authentication/authorization scheme enables an extremely robust and flexible security construct that addresses some issues that arise in RADIUS/DIAMETER solutions touched upon above. One issue faced in this regard is an inability for RADIUS systems to support remote authorities. Another issue relates to the challenges faced by DIAMETER with remote authorities, given its dependence on IPsec. In each of these cases, there is no viable cross-platform way to pass a given user device 1706 from authority to authority as said device 202 interconnects through different networks 214. Moreover, outside of providing restricted resource access, these systems do not provide a mechanism to lock down foreign user device 1706 communications.

Further, the systems and methods described herein do not rely on non-persistent data that is lost if the service providing the data crashes. Instead, the present systems and methods utilizes parallel streaming of data packets to persistent data clusters to ensure accounting is preserved in a persistent manner. This is enhanced by the fact that both endpoints participate in the distributed accounting process to ensure delivery.

The administrator(s) can set policies for restricting access to group applications or to individual users. For example, an administrator can restrict a user to only certain access (intranet only) or alternatively restrict which applications are permitted to communicate via a particular device. The Administrator(s) are also permitted to centrally manage communication security policies by controlling modulation charts, and by extending authentication, authorization and accounting to extend Triple A services. The Adminstrator(s) preferably are assigned a single channel, which may be a network-level out-of-band channel to control policies and devices, and which may be utilized to send updates, new modulation charts, encryption DLLs and other controls.

An administrator may also group applications together using any semantic category. As one example of semantic categorization, an administrator might create application groups such as personal, background, employee work, employee social, etc. Administrators, and/or any appropriately authorized user, may generate a semantic definition as required and even overlap definitions for different enforcement reasons. Traditional definitions by business unit or corporate hierarchy might be used as well as trusted vs. untrusted people, number of years of employment, certifications obtained, behavioral testing results, and so forth. Each of these application groups can then be controlled in any manner desired in order to not only control the communication lines and protocols allowed by an application, but also with which other applications a given application can communicate or other application resources a given application can access. For example, a web browser might be designated in a high risk group with no access to employee resources on a computer or that group might not be allowed to save information if the total amount to be saved exceeds a certain size. Both of these restrictions aid in countering potential malware attacks from being downloaded and/or accessing data. Other administrative functions defined above may also be included with the systems and methods described herein.

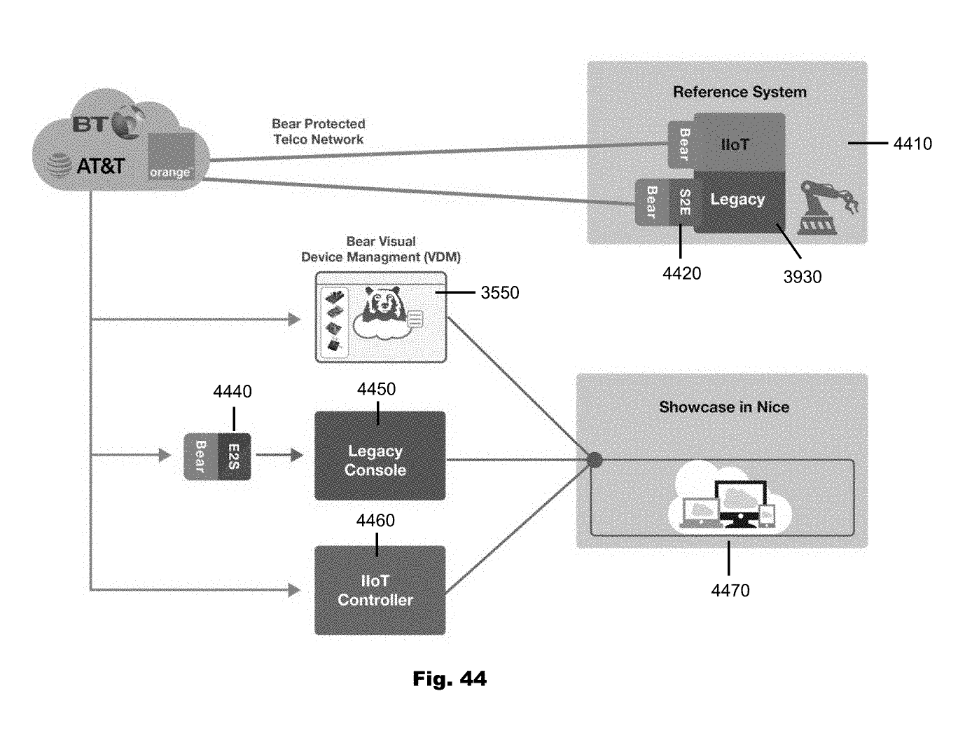

Referring now to FIGS. 44-45, the systems and methods described herein may also be configured to integrate with legacy systems and equipment. Across many enterprises, legacy systems dominate the landscape and are expensive to decommission and replace. By utilizing the Visual Device Management 3550 module described above, an administrator is able to view all their devices, where they are located and how they are configured. Furthermore, the Visual Device Management 3550 module allows changes to devices, including the security, configuration and connectivity, without interruption or unwanted delay. As one example, and turning to FIG. 44 in particular, a reference system 4410 may comprise means for converting from legacy communication protocols to Internet protocols and back again through the use of the S2E 4420 and E2S 4440 modules. This in turn permits communications to protected networks and the Visual Device Management 3550 module as shown in FIG. 44. An IoT controller 4460 and device tag may reside on the system, as well as a legacy console 4450, without interrupting or delaying network communications. The conversion of communications back to legacy protocols allows any legacy applications to display information 4470 to the user.

Referring to FIG. 45, legacy consoles 4450 may also be configured to communicate with applications running on the cloud. In this embodiment, the cloud applications may comprise the S2E 4420 and E2S 4440 modules described in relation to FIG. 44 and convert the communications received from the legacy console 4450 prior to routing the data to the customer 4540, 4545. This configuration permits security and encryption platforms to be provided seamlessly to the customer 4540, 4545, despite the existence of legacy communications. In turn, the cloud applications 4510 may provide serial, SCADA or other legacy data to the legacy console 4450 as necessary.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method for facilitating data transmission utilizing a communication protocol between first and second nodes, the method comprising:
intercepting, by a packet level program executed by the first node and at a layer immediately prior to or subsequent to a physical layer, outbound and inbound data transmissions, respectively, wherein the transmissions are intercepted at a smallest division of data supported by the communication protocol used to transmit the data;
altering, by the packet level program executed by the first node and at the layer immediately prior to or subsequent to the physical layer, both the intercepted outbound data and the intercepted inbound data, wherein altering comprises modifying the intercepted data such that an integrity check value requires recomputation and, as a result, re-computing the integrity check value;
transmitting, by the packet level program, the altered outbound data to the second node; and
transmitting, by the packet level program, the altered inbound data to an application executed by the first node.

2. The method according to claim 1, wherein the communication protocol is packet based and the data is intercepted at a packet level.

3. The method according to claim 1, wherein the communication protocol is based on pulses of light and the data is intercepted at a light pulse level.

4. The method according to claim 1, wherein the altering the intercepted outbound data comprises at least one of compressing the intercepted data, encrypting the intercepted data, obfuscating the intercepted data, inserting new data in the intercepted data and splitting the intercepted data.

5. The method according to claim 2, further comprising:
synchronizing sequence numbers of packets sent from the at least one of the two logical nodes with sequence numbers of packets sent to the at least one of the two logical nodes.

6. The method according to claim 1, wherein the intercepting the outbound and inbound data between the two logical nodes and the altering the intercepted outbound and inbound data utilize resources in at least two different modes of an operating system.

7. The method according to claim 6, further comprising:
at least one of accessing and storing shared data in a shared memory by a process executed in a first mode of the at least two different modes of the operating system;
accessing the shared data in the shared memory by the process executed in a second mode of the at least two different modes of the operating system.

8. The method according to claim 1, further comprising:
obtaining node data from one or more logical source nodes;
altering the intercepted outbound data based on the obtained node data; and
sending the altered outbound data to the at least one of the two logical nodes through at least one of the logical source nodes for which the node data is obtained.

9. The method according to claim 8, further comprising:
monitoring a behavior of the at least one of the logical source nodes through which the altered data is sent; and
sending the altered outbound data to the at least one of the two logical nodes through another of the logical source nodes for which the node data is obtained based on the monitored behavior.

10. The method according to claim 8, wherein the node data is obtained for source nodes in a selected geographic location.

11. The method according to claim 8, wherein the node data obtained from the one more logical source nodes is encrypted by a layered encryption including at least one of a plurality of types of encryption, and the method further comprises decrypting the node data.

12. The method according to claim 1, further comprising:
applying a plain view encryption process based on a unique user encryption data set to the intercepted outbound data before altering the intercepted outbound data;
sending the altered and encrypted outbound data to the at least one of the two logical nodes through at least one cryption node.

13. The method according to claim 1, further comprising:
applying a plain view encryption process based on a unique user encryption data set to the intercepted outbound data before altering the intercepted outbound data;
sending the altered and encrypted data directly to the at least one of the two logical nodes.

14. The method according to claim 12, further comprising:
decrypting the altered and encrypted outbound data at the cryption node;
sending the altered outbound data to the at least one of the two logical nodes through at least one intermediate node.

15. The method according to claim 12, further comprising:
decrypting the altered and encrypted outbound data at the cryption node;
sending the altered outbound data to the at least one of the two logical nodes directly from the cryption node.

16. The method according to claim 1, further comprising:
receiving encrypted data encrypted by a plain view encryption process based on a unique user encryption data set at a cryption node;
decrypting the encrypted data at the cryption node;
sending the decrypted data to the at least one of the two logical nodes.

17. The method according to claim 2, further comprising:
encrypting at least a portion of a packet intercepted between the two logical nodes.

18. The method according to claim 1, wherein the application is a virtualized application.

19. A method for facilitating data transmission between first and second nodes, the method
comprising:
intercepting, by a packet level program executed by the first node and at a layer immediately prior to or subsequent to a physical layer, outbound and inbound data transmissions, respectively, including first data transmitted using a first communication protocol, wherein the first data is intercepted at a smallest division of data supported by the first communication protocol;
storing the intercepted first data;
intercepting, by the packet level program, outbound and inbound data transmissions, including second data transmitted using a second communication protocol, wherein the second data is intercepted at a smallest division of data supported by the second communication protocol;
comparing the intercepted first data to the intercepted second data;
sending a result of the comparison to at least one of the nodes; and
altering, by the packet level program executed by the first node and at the layer immediately prior to or subsequent to the physical layer, one of the intercepted first or second data, wherein altering comprises modifying the intercepted data such that a cyclic redundancy check (CRC) value requires re-computation and, as a result, re-computing the CRC value.

20. A system for facilitating data transmission utilizing a communication protocol, the system comprising:
a first node comprising:
a network interface card; and
a processor coupled to the network interface card and to execute a packet level program at a layer immediately prior to or subsequent to a physical layer to:
intercept outbound and inbound data transmissions, wherein the transmissions are intercepted at a smallest division of data supported by the communication protocol used to transmit the data;
alter the intercepted data by modifying the intercepted data such that a cyclic redundancy check (CRC) value requires re-computation and, as a result, re-computing the CRC value;
transmit the altered outbound data to a second node; and
transmit the altered inbound data to an application other than the packet level program executed by the processor.
